(19) United States
(12) Patent Application Publication
(10) Pub. No.: US 2006/0257543 A1
(43) Pub. Date: Nov. 16, 2006

(54) Molecules comprising linked organic moieties as flavor modifiers for comestible compositions

(76) Inventors: Catherine Tachdjian, San Diego, CA (US); Andrew P. Patron, San Marcos, CA (US); Marketa Lebl-Rinnova, San Diego, CA (US); Xiao-Qing Tang, San Diego, CA (US); Vincent Darmohusodo, San Diego, CA (US); Chad Priest, Encinitas, CA (US)

Correspondence Address: NEEDLE & ROSENBERG, P.C., SUITE 1000, 999 PEACHTREE STREET, ATLANTA, GA, 30309-3915, US

(21) Appl. No.: 11/349,041

(22) Filed: Feb. 6, 2006

Related U.S. Application Data
(60) Provisional application No. 60/650,012, filed on Feb. 4, 2005.

(51) Int. Cl. A23L 1/22

(52) U.S. Cl. 426/534

(57) ABSTRACT

The inventions disclosed herein relate to genuses of non-naturally occurring small molecule compounds which comprise two or optionally three organic moieties of limited size “linked” by certain structurally related “linker” functional groups. Suitable linker groups include ester, amine, ether, keto, imino, thioamide, thioether, sulfonamide, sulfonate ester, sulfone, guanidine, and thiourea groups. The compounds are capable, when contacted with comestible food or drinks or pharmaceutical compositions, at concentrations preferably on the order of about 100 ppm or lower, of serving as savory (“umami”) or sweet taste modifiers, savory or sweet flavoring agents and savory or sweet flavor enhancers, for use in foods, beverages, and other comestible or orally administered medicinal products or compositions, optionally in the presence of or in mixtures with conventional flavoring agents such as monosodium glutamate or known natural or artificial sweeteners.

### RELATED APPLICATIONS

This application claims the priority of U.S. provisional patent application Ser. No. 60/650,012 filed on Feb. 4, 2005, the entire disclosure of which is hereby incorporated herein by this reference, for all purposes.

### FIELD OF THE INVENTION

The present invention relates to the discovery of flavor or taste modifiers, such as a flavoring or flavoring agents and flavor or taste enhancers, more particularly, savory (“umami”) or sweet taste modifiers, savory or sweet flavoring agents and savory or sweet flavor enhancers, for foods, beverages, and other comestible or orally administered medicinal products or compositions.

### BACKGROUND OF THE INVENTION

For centuries, various natural and unnatural compositions and/or compounds have been added to comestible (edible) foods, beverages, and/or orally administered medicinal compositions to improve their taste. Although it has long been known that there are only a few basic types of “tastes,” the biological and biochemical basis of taste perception was poorly understood, and most taste improving or taste modifying agents have been discovered largely by simple trial and error processes.

There has been significant recent progress in identifying useful natural flavoring agents, such as for example sweeteners such as sucrose, fructose, glucose, erythritol, isomalt, lactitol, mannitol, sorbitol, xylitol, certain known natural terpenoids, flavonoids, or protein sweeteners. See for example a recent article entitled “Noncariogenic Intense Natural Sweeteners” by Kinghorn, et al. (Med Res Rev 18 (5) 347-360, 1998), which discussed recently discovered natural materials that are much more intensely sweet than common natural sweeteners such as sucrose, fructose, and the like. Similarly, there has been recent progress in identifying and commercializing new artificial sweeteners, such as aspartame, saccharin, acesulfame-K, cyclamate, sucralose, and alitame, etc., see a recent article by Ager, et al. (Angew Chem Int. Ed. 1998, 37, 1802-1817). The entire disclosure of the two references identified above are hereby incorporated herein by reference, for the purpose of describing at least in part the knowledge of those of ordinary skill in the art regarding known sweetening agents.

However, there remains in the art a need for new and improved flavoring agents. For example, one of the five known basic tastes is the “savory” or “umami” flavor of monosodium glutamate (“MSG”). MSG is known to produce adverse reactions in some people, but very little progress has been made in identifying artificial substitutes for MSG. It is known that a few naturally occurring materials can increase or enhance the effectiveness of MSG as a savory flavoring agent, so that less MSG would be needed for a given flavoring application. For example the naturally occurring nucleotide compounds inosine monophosphate (IMP) or guanosine monophosphate (GMP) are known to have a multiplier effect on the savory taste of MSG, but IMP and GMP are very difficult and expensive to isolate and purify from natural sources, or synthesize, and hence have only limited practical application to most commercial needs in food or medicinal compositions. New tastant compounds that would provide the savory flavor of MSG itself, so as to substitute for MSG as a savory tastant, or new compounds that enhance the effectiveness of MSG so as to substitute for IMP or GMP as MSG enhancers, could be of very high value.

Similarly, discovery of compounds that are either new “High Intensity” sweeteners (i.e. they are many times sweeter than sucrose) would be of value, or any compounds that significantly increase the sweetness of known natural or artificial sweeteners, so that less of those caloric or non-caloric sweeteners would be required, could be of very high utility and value.

In recent years substantial progress has been made in biotechnology in general, and in better understanding the underlying biological and biochemical phenomena of taste perception. For example, taste receptor proteins have been recently identified in mammals which are involved in taste perception. Particularly, two different families of G protein coupled receptors believed to be involved in taste perception, T2Rs and T1Rs, have been identified. (See, e.g., Nelson, et al., Cell (2001) 106(3):381-390; Adler, et al., Cell (2000) 100(6):693-702; Chandrashekar, et al., Cell (2000) 100:703-711; Matsunami, et al., Number (2000) 404:601-604; Li, et al., Proc. Natl. Acad. Sci. USA (2002) 99:4962-4966; Montmayeur, et al., Nature Neuroscience (2001) 4(S):492-498: U.S. Pat. No. 6,462,148; and PCT publications WO 02/06254, WO 00/63166 art, WO 02/064631, and WO 03/001876, and U.S. Patent Publication US-2003-0232407 A1). The entire disclosures of the articles, patent applications, and issued patents cited immediately above are hereby incorporated herein by reference, for all purposes, including their disclosures of the identities and structures of T2Rs and T1Rs mammalian taste receptor proteins and methods for artificially expressing those receptors in cell lines and using the resulting cell lines for screening compounds as potential “savory” or “sweet” flavoring agents.

Very recently, certain U.S. and international patent applications have been filed by some of the current Applicants that disclosed the use of certain amide compounds as umami and/or sweet tastants, and/or synergistic enhancers of the savory “umami” taste of MSG, and/or the sweet taste of a variety of natural and artificial sweeteners. See, for example, U.S. Provisional Patent Application Ser. No. 60/494,071 filed Aug. 6, 2003, U.S. Provisional Patent Application Ser. No. 60/552,064 filed Mar. 9, 2004, U.S. Utility patent application Ser. No. 10/913,303, filed Aug. 6, 2004 and published as U.S. Patent Publication Serial No. US-2005 0084506-A1 on Apr. 21, 2005; and PCT Patent Application Serial No. PCT/US04/25419 filed Aug. 6, 2004 and published as PCT Publication WO 2005/041684 on May 12, 2005. On Aug. 6, 2004, Applicants also filed PCT Patent Application Serial No. PCT/US04/25459, subsequently published as PCT Patent Publication WO 2005/015158 on Feb. 17, 2005. The entire disclosures of the patent applications cited immediately above are hereby incorporated herein by this reference, for all purposes, including their disclosures of the identities and structures of amide compounds that can serve as potential “savory” or sweet flavoring agents or enhancers. Nevertheless, there is a continuing need for new and improved taste enhancing compounds.

Whereas the T2R family includes a family of over 25 genes that are involved in bitter taste perception, the T1Rs only includes three members, T1R1, T1R2 and T1R3. (See Li, et al., Proc. Natl. Acad. Sci. USA (2002) 99:4962-4966.) Recently it was disclosed in WO 02/064631 and/or WO 03/001876 that certain T1R members, when co-expressed in suitable mammalian cell lines, assemble to form functional taste receptors. Particularly it was found that co-expression of T1R1 and T1R3 in a suitable host cell results in a functional T1R1/T1R3 savory (“umami”) taste receptor that responds to savory taste stimuli, including monosodium glutamate. Similarly, it was found that co-expression of T1R2 and T1R3 in a suitable host cell results in a functional T1R2/T1R3 “sweet” taste receptor that responds to different taste stimuli including naturally occurring and artificial sweeteners. (See Li, et al. (Id.)). The references cited above also disclosed assays and/or high throughput screens that measure T1R1/T1R3 or T1R2/T1R3 receptor activity by fluorometric imaging in the presence of the target compounds. We employed the above-described assays and/or high throughput screening methods to identify initial “lead” compounds that modulate the activity of T1R1/T1R3 “savory” taste receptors, or T1R2/T1R3 “sweet” taste receptors, then embarked on a long, complex and iterative process of investigation, evaluation, and optimization, so as to arrive at the various inventions and/or embodiments described below.

### SUMMARY OF THE INVENTION

The inventions have many aspects, all of which relate to methods of using or preparing compositions containing certain non-naturally occurring “tastant” compounds and/or derivative compounds having the related structures shown below in Formula (I): 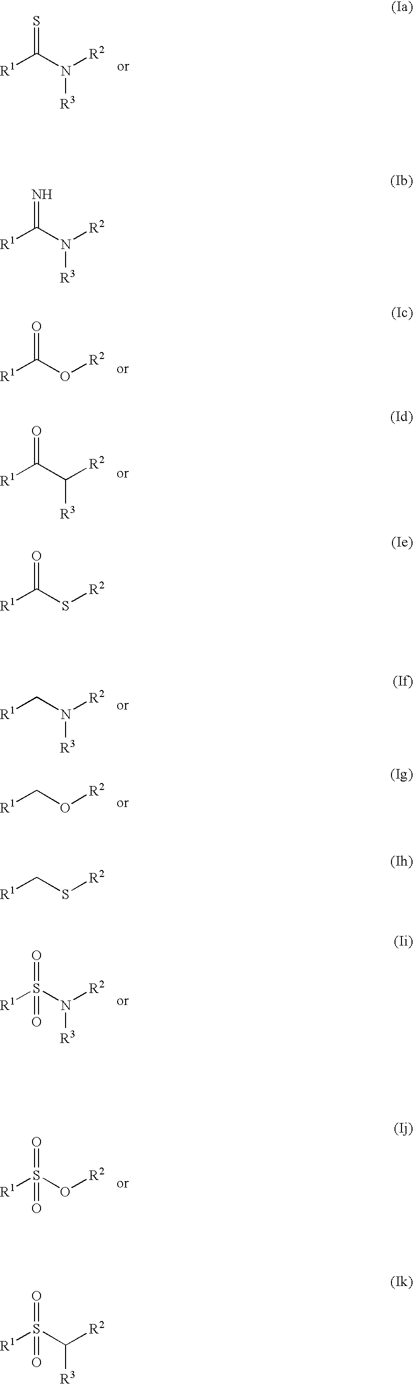
wherein R¹, R² and R³ can be and are independently further defined in various ways, as is further detailed below.

The R¹, R², and/or R³ groups of the compounds of Formulas (Ia-k) are “linked” together at a suitable distance and in suitable geometrical relationship by a “linker” functional group. The compounds (Ia-k) shown above exemplify and illustrate a number of suitable “linker” functional groups, and linker groups which otherwise can be readily synthesized from many readily available synthetic building block precursors by one of ordinary skill in the art of chemical synthesis, so as to enable in-vitro and/or in-vivo testing for tastant activity, with a reasonable expectation that at least in many cases the structurally and chemically related compounds will have at least similar biological activities.

The tastant compounds of Formula (Ia-k) shown above are sometimes referenced generically herein as the compounds of Formula (I), or the “tastant” compounds of the invention. The tastant compound of the present invention do not however comprise any “amide” compounds having the structure shown below

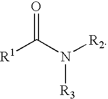

The “amide” compounds excluded from the scope of the present invention include certain sub-genera of amide derivative compounds such as ureas, oxalamides, acrylamides, and the like.

In the tastant compounds of Formula (I), the R¹ group is present in any of the compounds of Formula (I) and is typically an organic residue comprising at least three carbon atoms, with a variety of additional but alternative limits on the size and/or chemical characteristics of the R¹ group, as will be further described below. Similarly, the R² group is always present in the compounds of Formula (I), and is an organic residue comprising at least three carbon atoms, with a variety of additional but alternative limits on the size and/or chemical characteristics of the R² group, as is further described below.

If the R³ substitutent group is present, (see for example the thioamide derivatives of Formula (Ia), the amidine derivatives of Formula (Ib), the keto derivatives of Formula (Id), the amino derivatives of Formula (If), and the sulfonamide derivatives of Formula (Ii), and the sulfone derivatives of Formula (Ik)), the R³ group can be hydrogen or an organic residue preferably comprising at least three carbon atoms, with a variety of additional but alternative limits on the size and/or chemical characteristics of the R³ group, as is further discussed below.

The R³ group is not however present in some embodiments of the tastant compounds of Formula (I). See for example the carboxylic acid ester derivatives of Formula (Ic), the thioester derivatives of Formula (Ie), the ether derivatives of Formula (Ig), the thioether derivatives of Formula (Ih), and the sulfate ester derivatives of Formula (Ij).

In some embodiments of the tastant compounds of Formula (I), R² and R³, together with the atom to which they are commonly bonded can together form a residue that can be carbocyclic or heterocyclic ring, as will be further disclosed below.

Some of the tastant compounds of generic Formula (I) and/or its subgenera may have been previously synthesized by methods known in the prior art for various reasons believed unrelated to the current invention. Nevertheless, many of the tastant compounds of Formula (I) disclosed herein are novel an/or unobvious compounds that have not been previously synthesized at all. Nevertheless, to the knowledge of the inventors it has not been previously recognized that most or all of the compounds of Formula (I) and their various subgenera can be utilized at very low concentrations in comestible compositions as savory or sweet flavoring agents, or savory or sweet taste enhancers.

We have discovered that the genera, subgenera, and/or species of the tastant compounds of Formula (I) bind to and/or activate one or both of the T1R1/T1R3 “savory” (“umami”) or T1R2/T1R3 sweet receptors in-vitro, at unexpectedly low concentrations on the order of micromolar or lower concentrations. The tastant compounds of Formula (I) are also believed to capable of similarly interacting with savory or sweet flavor receptors of animals or humans in vivo, to modulate, induce, or enhance human or animal sweet or savory taste perception.

Accordingly, most or all of the subgenera and species of the tastant compounds of Formula (I) further described hereinbelow, can, at useful and surprisingly low concentrations, be used in comestible compositions as savory or sweet flavoring agents, or savory or sweet agent enhancers. Accordingly, in some embodiments, the invention relates to methods for modulating the sweet or savory taste of a comestible or medicinal product comprising:
a) providing at least one comestible or medicinal product, or one or more precursors thereof, and
b) combining the comestible or medicinal product or one or more precursors thereof with at least a savory flavor modulating amount or a sweet flavor modulating amount of one or more non-naturally occurring tastant compounds of Formula (I) and its subgenera, or a mixture thereof, or a comestibly acceptable salt thereof, so as to form a taste modified comestible or medicinal product;
wherein the one or more tastant compounds is within the scope of any of the compounds of Formula (I) as shown above, or any of its various subgenera of compounds or species compounds as are further described below:

The invention also relates to the taste modified comestible or medicinal products produced by the methods and/or processes mentioned immediatlely above, and to comestible or medicinal products containing the compounds of Formula (I) produced by other processes for producing comestible or medicinal products that are well known to those of ordinary skill in the art. Accordingly, in some embodiments the invention relates to comestible or medicinal products or compositions, or one or more of their precursors, that contain effective amounts of one or more of the tastant compounds of Formula (I), regardless of the process used to produce the comestible or medicinal composition, which include but are not necessarily limited to food, drink, medicinal products and compositions intended for oral administration, and one or more of the precursors thereof.

It is hereby specifically contemplated that any of the subgenera and/or species of the tastant compounds of Formula (I) described herein can, either in their specified form or as a comestibly acceptable salt, be combined in an effective amount with a comestible or medicinal product or one or more precursors thereof by the processes and/or methods described elsewhere herein, or by any such other processes as would be apparent to those of ordinary skill in preparing comestible or medicinal products or precursor thereof, to form a savory and/or sweet flavor modified comestible or medicinal product, or a precursor thereof.

In many embodiments, one or more of the tastant compounds of Formula (I) further identified, described, and/or claimed herein, or a comestibly acceptable salt thereof, can be used in mixtures or in combination with other known savory or sweet compounds, or used as flavor enhancers in comestible food, beverage and medicinal compositions, for human or animal consumption.

Many of the tastant compounds of Formula (I) and/or its various subgenera of tastant compounds, when used alone or together with MSG, IMP, and/or GMP, increase or modulate savory taste perception in humans, at unexpectedly low concentrations. Many of the tastant compounds of the invention are T1R1/T1R3 savory receptor agonists and accordingly can, at surprisingly low concentrations on the order of micromolar concentrations or less, induce savory taste perception in humans, independently of the presence or absence of MSG in a comestible composition, or other known savory flavor enhancers, such as IMP or GMP. Moreover, the tastant compounds of Formula (I) can enhance, potentiate, modulate or induce savory flavoring agents that naturally occur in many comestible compositions, such as MSG, for example. In many cases, the tastant compounds of Formula (I) can, when added to comestible compositions at very low concentrations of about micromolar or less, substitute for or very significantly reduce the need to add MSG, IMP, or GMP to comestible compositions to achieve the desired levels of savory taste in those comestible compositions.

In related embodiments of the compounds of Formula (I) and their uses, many of the tastant compounds of Formula (I) are potent T1R2/T1R3 sweet receptor agonists at concentrations of micromolar or less. Interestingly, the compounds of Formula (I) may or may not induce sweet taste perception in humans at relevant concentrations in the absence of other sweeteners. In other words, some of the tastant compounds of Formula (I) are not perceived by human beings as being sweet tastants at relevant concentrations in the absence of other known sweeteners. Nevertheless and very unexpectedly, many of these same tastant compounds of Formula (I) can significantly enhance, potentiate, modulate or induce the perception in humans of increases in the sweet taste of other natural, semi-synthetic, or synthetic sweet flavoring agents, such as for example sucrose, fructose, glucose, erythritol, isomalt, lactitol, mannitol, sorbitol, xylitol, certain known natural terpenoids, flavonoids, or protein sweeteners, aspartame, saccharin, acesulfame-K, cyclamate, sucralose, and alitame, and the like, or a mixture thereof. Accordingly, the compounds of Formula (I) can often be added to comestible or medicinal compositions to “multiply” the sweetness of other sweeteners, so as to allow substantial and desirable reductions in the usage of the other sweeteners, such as for example sucrose, sucrose/fructose, and the like. This “enhancement” effect on the sweetness of other known sweeteners, especially natural saccharide sweeteners, can enable the use of lower concentrations of those known sweeteners, and the well known benefits to human health that result from lower consumption of such sweeteners.

The inventions described herein also relate to the flavor-modified comestible or medicinal products that contain sweet or savory flavor modulating amounts of one or more of the tastant compounds disclosed herein.

In some embodiments, the invention relates to novel compounds, flavoring agents, flavor enhancers, flavor modifying compounds, and/or compositions containing the compounds of Formula (I), and its various subgenera and species compounds.

In some embodiments, the invention relates to comestible or medicinal compositions suitable for human or animal consumption, or precursors thereof, containing at least one compound of Formula (I), or a comestibly or pharmaceutically acceptable salt thereof. These compositions will preferably include comestible products such as foods or beverages, medicinal products or compositions intended for oral administration, and oral hygiene products and additives, which when added to these products modulate the flavor or taste thereof, particularly by enhancing (increasing) the savory and/or sweet taste thereof.

The present invention also relates to novel genera and species of tastant compounds within the scope of the compounds of Formula (I), and derivatives, flavoring agents, comestible or medicinal products or compositions, including savory or sweet flavoring agents and flavor enhancers containing the same.

The foregoing discussion merely summarizes certain aspects of the inventions and is not intended, nor should it be construed, as limiting the invention in any way.

### DETAILED DESCRIPTION OF THE INVENTION

The present invention can be understood more readily by reference to the following detailed description of various embodiments of the invention and the Examples included therein and to the chemical drawings and Tables and their previous and following description. Before the present compounds, compositions, and/or methods are disclosed and described, it is to be understood that unless otherwise specifically indicated by the claims, the invention is not limited to specific foods or food preparation methods, specific comestibles or pharmaceutical carriers or formulations, or to particular modes of formulating the compounds of the invention into comestible or medicinal products or compositions intended for oral administration, because as one of ordinary skill in relevant arts is well aware, such things can of course, vary. It is also to be understood that the terminology used herein is for the purpose of describing particular embodiments only and is not intended to be limiting.

### Definitions

As used herein, the term “medicinal product” includes both solids and liquid compositions which are ingestible non-toxic materials which have medicinal value or comprise medicinally active agents such as cough syrups, cough drops, aspirin and chewable medicinal tablets.

An oral hygiene product includes solids and liquids such as toothpaste or mouthwash.

A “comestibly, biologically or medicinally acceptable carrier or excipient” is a solid or liquid medium and/or composition that is used to prepare a desired dosage form of the inventive compound, in order to administer the inventive compound in a dispersed/diluted form, so that the biological effectiveness of the inventive compound is maximized. A comestibly, biologically or medicinally acceptable carrier includes many common food ingredients, such as water at neutral, acidic, or basic pH, fruit or vegetable juices, vinegar, marinades, beer, wine, natural water/fat emulsions such as milk or condensed milk, edible oils and shortenings, fatty acids, low molecular weight oligomers of propylene glycol, glyceryl esters of fatty acids, and dispersions or emulsions of such hydrophobic substances in aqueous media, salts such as sodium chloride, wheat flours, solvents such as ethanol, solid edible diluents such as vegetable powders or flours, or other liquid vehicles; dispersion or suspension aids; surface active agents; isotonic agents; thickening or emulsifying agents, preservatives; solid binders; lubricants and the like.

A “flavor” herein refers to the perception of taste and/or smell in a subject, which include sweet, sour, salty, bitter, umami, and others. The subject may be a human or an animal.

A “flavoring agent” herein refers to a compound or a biologically acceptable salt thereof that induces a flavor or taste in an animal or a human.

A “flavor modifier” herein refers to a compound or biologically acceptable salt thereof that modulates, including enhancing or potentiating, and inducing, the tastes and/or smell of a natural or synthetic flavoring agent in an animal or a human.

A “flavor enhancer” herein refers to a compound or biologically acceptable salt thereof that enhances the tastes or smell of a natural or synthetic flavoring agent.

“Savory flavor” herein refers to the savory “umami” taste typically induced by MSG (mono sodium glutamate) in an animal or a human.

“Savory flavoring agent,” “savory compound” or “savory receptor activating compound” herein refers to a compound or biologically acceptable salt thereof that elicits a detectable savory flavor in a subject, e.g., MSG (mono sodium glutamate) or a compound that activates a T1R1/T1R3 receptor in vitro. The subject may be a human or an animal.

“Sweet flavoring agent,” “sweet compound” or “sweet receptor activating compound” herein refers to a compound or biologically acceptable salt thereof that elicits a detectable sweet flavor in a subject, e.g, sucrose, fructose, glucose, and other known natural saccharide-based sweeteners, or known artificial sweeteners such as saccharine, cyclamate, aspartame, and the like as is further discussed herein, or a compound that activates a T1R2/T1R3 receptor in vitro. The subject may be a human or an animal.

A “savory flavor modifier” herein refers to a compound or biologically acceptable salt thereof that modulates, including enhancing or potentiating, inducing, and blocking, the savory taste of a natural or synthetic savory flavoring agents, e.g., monosodium glutamate (MSG) in an animal or a human.

A “sweet flavor modifier” herein refers to a compound or biologically acceptable salt thereof that modulates, including enhancing or potentiating, inducing, and blocking, the sweet taste of a natural or synthetic sweet flavoring agents, e.g., sucrose, fructose, glucose, and other known natural saccharide-based sweeteners, or known artificial sweeteners such as saccharine, cyclamate, aspartame, and the like, in a animal or a human.

A “savory flavor enhancer” herein refers to a compound or biologically acceptable salt thereof that enhances or potentiates the savory taste of a natural or synthetic savory flavoring agents, e.g., monosodium glutamate (MSG) in an animal or a human.

A “sweet flavor enhancer” herein refers to a compound or biologically acceptable salt thereof that enhances or potentiates the sweet taste of a natural or synthetic sweet flavoring agents, e.g., sucrose, fructose, glucose, and other known natural saccharide-based sweeteners, or known artificial sweeteners such as saccharine, cyclamate, aspartame, and the like as is further discussed herein in an animal or a human.

An “umami receptor activating compound” herein refers to a compound that activates an umami receptor, such as a T1R1/T1R3 receptor.

A “sweet receptor activating compound” herein refers to a compound that activates a sweet receptor, such as a T1R2/T1R3 receptor.

An “umami receptor modulating compound” herein refers to a compound that modulates (activates, enhances or blocks) an umami receptor.

A “sweet receptor modulating compound” herein refers to a compound that modulates (activates, enhances or blocks) a sweet receptor.

An “umami receptor enhancing compound” herein refers to a compound that enhances or potentiates the effect of a natural or synthetic umami receptor activating compound, e.g., monosodium glutamate (MSG).

A “sweet receptor enhancing compound” herein refers to a compound that enhances or potentiates the effect of a natural or synthetic sweet receptor activating compound, e.g., sucrose, fructose, glucose, and other known natural saccharide-based sweeteners, or known artificial sweeteners such as saccharine, cyclamate, aspartame, and the like as is further discussed herein.

A “savory flavoring agent amount” herein refers to an amount of a compound (including the compounds of Formula (I), as well as known savory flavoring agents such as MSG) that is sufficient to induce savory taste in a comestible or medicinal product or composition, or a precursor thereof. A fairly broad range of a savory flavoring agent amount for the compounds of Formula (I) can be from about 0.001 ppm to 100 ppm, or a narrow range from about 0.1 ppm to about 10 ppm. Alternative ranges of savory flavoring agent amounts can be from about 0.01 ppm to about 30 ppm, from about 0.05 ppm to about 15 ppm, from about 0.1 ppm to about 5 ppm, or from about 0.1 ppm to about 3 ppm.

A “sweet flavoring agent amount” herein refers to an amount of a compound (including the compounds of Formula (I), as well as known sweeteners) that is sufficient to induce sweet taste in a comestible or medicinal product or composition, or a precursor thereof. A fairly broad range of a sweet flavoring agent amount for the compounds of Formula (I) can be from about 0.001 ppm to 100 ppm, or a narrow range from about 0.1 ppm to about 10 ppm. Alternative ranges of sweet flavoring agent amounts can be from about 0.01 ppm to about 30 ppm, from about 0.05 ppm to about 15 ppm, from about 0.1 ppm to about 5 ppm, or from about 0.1 ppm to about 3 ppm.

A “savory flavor modulating amount” herein refers to an amount of a compound of Formula (I) that is sufficient to alter (either increase or decrease) savory taste in a comestible or medicinal product or composition, or a precursor thereof, sufficiently to be perceived by a human subject. A fairly broad range of a savory flavor modulating amount can be from about 0.001 ppm to 100 ppm, or a narrow range from about 0.1 ppm to about 10 ppm. Alternative ranges of savory flavor modulating amounts can be from about 0.01 ppm to about 30 ppm, from about 0.05 ppm to about 15 ppm, from about 0.1 ppm to about 5 ppm, or from about 0.1 ppm to about 3 ppm.

A “sweet flavor modulating amount” herein refers to an amount of a compound of Formula (I) that is sufficient to alter (either increase or decrease) sweet taste in a comestible or medicinal product or composition, or a precursor thereof, sufficiently to be perceived by a human subject. A fairly broad range of a sweet flavor modulating amount can be from about 0.001 ppm to 100 ppm, or a narrow range from about 0.1 ppm to about 10 ppm. Alternative ranges of sweet flavor modulating amounts can be from about 0.01 ppm to about 30 ppm, from about 0.05 ppm to about 15 ppm, from about 0.1 ppm to about 5 ppm, or from about 0.1 ppm to about 3 ppm.

A “savory flavor enhancing amount” herein refers to an amount of a compound for Formula (I) that is sufficient to enhance the taste of a natural or synthetic flavoring agents, e.g., monosodium glutamate (MSG) when they are both present in a comestible or medicinal product or composition. A fairly broad range of a savory flavor enhancing amount can be from about 0.001 ppm to 100 ppm, or a narrow range from about 0.1 ppm to about 10 ppm. Alternative ranges of savory flavor enhancing amounts can be from about 0.01 ppm to about 30 ppm, from about 0.05 ppm to about 15 ppm, from about 0.1 ppm to about 5 ppm, or from about 0.1 ppm to about 3 ppm.

A “sweet flavor enhancing amount” herein refers to an amount of a compound of Formula (I) that is sufficient to enhance the taste of a natural or synthetic flavoring agents, e.g., sucrose, fructose, glucose, and other known natural saccharide-based sweeteners, or known artificial sweeteners such as saccharine, cyclamate, aspartame, and the like as is further discussed herein) in a comestible or medicinal product or composition. A fairly broad range of a sweet flavor enhancing amount can be from about 0.001 ppm to 100 ppm, or a narrow range from about 0.1 ppm to about 10 ppm. Alternative ranges of sweet flavor enhancing amounts can be from about 0.01 ppm to about 30 ppm, from about 0.05 ppm to about 15 ppm, from about 0.1 ppm to about 5 ppm, or from about 0.1 ppm to about 3 ppm.

An “umami receptor modulating amount” herein refers to an amount of a compound that is sufficient to modulate (activate, enhance or block) an umami receptor. A preferable range of an umami receptor modulating amount is 1 pM to 100 mM and most preferably 1 nM to 100 μM and most preferably 1 nM to 30 μM. A fairly broad range of a umami flavor enhancing amount can be from about 0.001 ppm to 100 ppm, or a narrow range from about 0.1 ppm to about 10 ppm. Alternative ranges of umami flavor enhancing amounts can be from about 0.01 ppm to about 30 ppm, from about 0.05 ppm to about 15 ppm, from about 0.1 ppm to about 5 ppm, or from about 0.1 ppm to about 3 ppm.

A “T1R1/T1R3 receptor modulating or activating amount” is an amount of compound that is sufficient to modulate or activate a T1R1/T1R3 receptor. These amounts are preferably the same as the umami receptor modulating amounts.

An “umami receptor” is a taste receptor that can be modulated by a savory compound. Preferably an umami receptor is a G protein coupled receptor, and more preferably the umami receptor is a T1R1/T1R3 receptor.

Compounds of the invention modulate an umami receptor and preferably are agonists of the T1R1/T1R3 receptor. An agonist of this receptor has the effect of activating the G protein signaling cascade. In many cases, this agonist effect of the compound on the receptor also produces a perceived savory flavor in a taste test. It is desirable, therefore, that such inventive compounds serve as a replacement for MSG, which is not tolerated by some in, for example, comestible products.

In addition, this agonist effect also is responsible for the synergistic savory taste effect, which occurs when a compound of the invention is combined with another savory flavoring agent such as MSG. The nucleotides, IMP or GMP, are conventionally added to MSG, to intensify the savory flavor of MSG, so that relatively less MSG is needed to provide the same savory flavor in comparison to MSG alone. Therefore, it is desirable that combining compounds of the invention with another savory flavoring agent such as MSG advantageously eliminates the need to add expensive nucleotides, such as IMP, as a flavor enhancer, while concomitantly reducing or eliminating the amount of a savory compound such as MSG needed to provide the same savory flavor in comparison to the savory compound or MSG alone.

A “sweet receptor modulating amount” herein refers to an amount of a compound that is sufficient to modulate (activate, enhance or block) a sweet receptor. A preferable range of a sweet receptor modulating amount is 1 pM to 100 mM and most preferably 1 nM to 100 μM and most preferably 1 nM to 30 μM.

A “T1R2/T1R3 receptor modulating or activating amount” is an amount of compound that is sufficient to modulate or activate a T1R2/T1R3 receptor. These amounts are preferably the same as the sweet receptor modulating amounts.

A “sweet receptor” is a taste receptor that can be modulated by a sweet compound. Preferably a sweet receptor is a G protein coupled receptor, and more preferably the sweet receptor is a T1R2/T1R3 receptor.

Many compounds of Formula (I) can modulate a sweet receptor and preferably are agonists of the T1R2/T1R3 receptor. An agonist of this receptor has the effect of activating the G protein signaling cascade. In many cases, this agonist effect of the compound on the receptor also produces a perceived sweet flavor in a taste test. It is desirable, therefore, that such inventive compounds serve as a replacement for sucrose, fructose, glucose, and other known natural saccharide-based sweeteners, or known artificial sweeteners such as saccharine, cyclamate, aspartame, and the like, or mixtures thereof as is further discussed herein.

A “synergistic effect” relates to the enhanced savory and/or sweet flavor of a combination of savory and/or or sweet compounds or receptor activating compounds, in comparison to the sum of the taste effects or flavor associated effects associated with each individual compound. In the case of savory enhancer compounds, a synergistic effect on the effectiveness of MSG may be indicated for a compound of Formula (I) having an EC50 ratio (defined hereinbelow) of 2.0 or more, or preferably 5.0 or more, or 10.0 or more, or 15.0 or more. An EC50 assay for sweet enhancement has not yet been developed, but in the case of both savory and sweet enhancer compounds, a synergistic effect can be confirmed by human taste tests, as described elsewhere herein.

When the compounds described here include one or more chiral centers, the stereochemistry of such chiral centers can independently be in the R or S configuration, or a mixture of the two. The chiral centers can be further designated as R or S or R,S or d,D, l,L or d,l, D,L. Correspondingly, the tastant compounds of the invention, if they can be present in optically active form, can actually be present in the form of a racemic mixture of enantiomers, or in the form of either of the separate enantiomers in substantially isolated and purified form, or as a mixture comprising any relative proportions of the enantiomers.

Regarding the compounds described herein, the suffix “ene” added to any of the described terms means that the substituent is connected to two other parts in the compound. For example, “alkylene” is (CH₂)ₙ, “alkenylene” is such a moiety that contains a double bond and “alkynylene” is such a moiety that contains a triple bond.

As used herein, “hydrocarbon residue” refers to a chemical sub-group or radical within a larger chemical compound which contains only carbon and hydrogen atoms. The hydrocarbon residue may be aliphatic or aromatic, straight-chain, cyclic, branched, saturated or unsaturated. In many embodiments the hydrocarbon residues are of limited dimensional size and molecular weight, and may comprise 1 to 18 carbon atoms, 1 to 16 carbon atoms, 1 to 12 carbon atoms, 1 to 10 carbon atoms, 1 to 8 carbon atoms, 1 to 6 carbon atoms, or 1 to 4 carbon atoms.

The hydrocarbon residue, when described as “substituted”, contains or is substituted with one or more independently selected heteroatoms such as O, S, N, P, or the halogens (fluorine, chlorine, bromine, and iodine), or one or more substituent groups containing heteroatoms (OH, NH₂, NO₂, SO₃H, and the like) over and above the carbon and hydrogen atoms of the substituent residue. Substituted hydrocarbon residues may also contain carbonyl groups, amino groups, hydroxyl groups and the like, or contain heteroatoms inserted into the “backbone” of the hydrocarbon residue.

As used herein, “inorganic” group or residue refers to a neutral, cationic, or anionic radical substituents on the organic molecules disclosed or claimed herein that have from one to 16 atoms that do not include carbon, but do contain other heteroatoms from the periodic table that preferably include one or more atoms independently selected from the group consisting of H, O, N, S, one or more halogens, or alkali metal or alkaline earth metal ions. Examples of inorganic radicals include, but are not limited to H, Na+, Ca++ and K+, halogens which include fluorine, chlorine, bromine, and iodine, OH, SH, SO₃H, SO₃⁻, PO₃H, PO₃⁻, NO, NO₂ or NH₂, and the like.

As used herein, the term “alkyl,” “alkenyl” and “alkynyl” include straight- and branched-chain and cyclic monovalent substituents that respectively are saturated, unsaturated with at least one double bond, and unsaturated with at least one triple bond.

“Alkyl” refers to a hydrocarbon group that can be conceptually formed from an alkane by removing hydrogen from the structure of a non-cyclic hydrocarbon compound having straight or branched carbon chains, and replacing the hydrogen atom with another atom or organic or inorganic substitutent group. In some embodiments of the invention, the alkyl groups are “C1 to C6 alkyl” such as methyl, ethyl, propyl, isopropyl, n-butyl, iso-butyl, sec-butyl, tert-butyl, amyl, tert-amyl, hexyl and the like. Many embodiments of the invention comprise “C1 to C4 alkyl” groups (alternatively termed “lower alkyl” groups) that include methyl, ethyl, propyl, iso-propyl n-butyl, iso-butyl, sec-butyl, and t-butyl groups. Some of the preferred alkyl groups of the invention have three or more carbon atoms preferably 3 to 16 carbon atoms, 4 to 14 carbon atoms, or 6 to 12 carbon atoms.

The term “alkenyl” denotes a hydrocarbon group or residue that comprises at least one carbon-carbon double bond. In some embodiments, alkenyl groups are “C₂ to C₇ alkenyls” which are exemplified by vinyl, allyl, 2-butenyl, 3-butenyl, 2-pentenyl, 3-pentenyl, 4-pentenyl, 2-hexenyl, 3-hexenyl, 4-hexenyl, 5-hexenyl, 2-heptenyl, 3-heptenyl, 4-heptenyl, 5-heptenyl, 6-heptenyl, as well as dienes and trienes of straight and branched chains. In other embodiments, alkenyls are limited to two to four carbon atoms.

The term “alkynyl” denotes a hydrocarbon residue that comprises at least one carbon-carbon triple bond. Preferred alkynyl groups are “C2 to C7 alkynyl” such as ethynyl, propynyl, 2-butynyl, 2-pentynyl, 3-pentynyl, 2-hexynyl, 3-hexynyl, 4-hexynyl, 2-heptynyl, 3-heptynyl, 4-heptynyl, 5-heptynyl as well as di- and tri-ynes of straight and branched chains including ene-ynes.

The terms “substituted alkyl,” “substituted alkenyl,” “substituted alkynyl,” and “substituted alkylene” denote that the alkyl, alkenyl, alkynyl and alkylene groups or radicals as described above have had one or more hydrogen atoms substituted by one or more, and preferably one or two organic or inorganic substituent groups or radicals, that can include halogen, hydroxy, C₁ to C₇ alkoxy, alkoxy-alkyl, oxo, C₃ to C₇ cycloalkyl, naphthyl, amino, (monosubstituted)amino, (disubstituted)amino, guanidino, heterocycle, substituted heterocycle, imidazolyl, indolyl, pyrrolidinyl, C₁ to C₇ acyl, C₁ to C₇ acyloxy, nitro, carboxy, carbamoyl, carboxamide, N-(C₁ to C₆ alkyl)carboxamide, N,N-di(C₁ to C₆ alkyl)carboxamide, cyano, methylsulfonylamino, thiol, C₁ to C₄ alkylthio or C₁ to C₄ alkylsulfonyl groups. The substituted alkyl groups may be substituted once or more, and preferably once or twice, with the same or with different substituents. In many embodiments of the invention, a preferred group of substituent groups include hydroxy, fluoro, chloro, NH₂, NHCH₃, N(CH₃)₂, CO₂CH₃, SEt, SCH₃, methyl, ethyl, isopropyl, vinyl, trifluoromethyl, methoxy, ethoxy, isopropoxy, and trifluoromethoxy groups. In many embodiments of the invention that comprise the above lists of substituent groups, an even more preferred group of substituent groups include hydroxy, SEt, SCH₃, methyl, ethyl, isopropyl, trifluromethyl, methoxy, ethoxy, and trifluoromethoxy groups.

Examples of the above substituted alkyl groups include the 2-oxo-prop-1-yl, 3-oxo-but-1-yl, cyanomethyl, nitromethyl, chloromethyl, trifluoromethyl, hydroxymethyl, tetrahydropyranyloxymethyl, trityloxymethyl, propionyloxymethyl, aminomethyl, carboxymethyl, allyloxycarbonylmethyl, allyloxycarbonylaminomethyl, methoxymethyl, ethoxymethyl, t-butoxymethyl, acetoxymethyl, chloromethyl, trifluoromethyl, 6-hydroxyhexyl, 2,4-dichloro(n-butyl), 2-aminopropyl, 1-chloroethyl, 2-chloroethyl, 1-bromoethyl, 2-chloroethyl, 1-fluoroethyl, 2-fluoroethyl, 1-iodoethyl, 2-iodoethyl, 1-chloropropyl, 2-chloropropyl, 3-chloropropyl, 1-bromopropyl, 2-bromopropyl, 3-bromopropyl, 1-fluoropropyl, 2-fluoropropyl, 3-fluoropropyl, 2-aminoethyl, 1-aminoethyl, N-benzoyl-2-aminoethyl, N-acetyl-2-aminoethyl, N-benzoyl-1-aminoethyl, N-acetyl-1-aminoethyl and the like.

Examples of substituted alkenyl groups include styrenyl, 3-chloro-propen-1-yl, 3-chloro-buten-1-yl, 3-methoxy-propen-2-yl, 3-phenyl-buten-2-yl, 1-cyano-buten-3-yl and the like. The geometrical isomerism is not critical, and all geometrical isomers for a given substituted double bond can be included.

Examples of substituted alkynyl groups include phenylacetylen-1-yl, 1-phenyl-2-propyn-1-yl and the like.

Haloalkyls are substituted alkyl groups or residues wherein one or more hydrogens of the corresponding alkyl group has been replaced with a halogen atom (fluorine, chlorine, bromine, and iodine). Preferred haloalkyls can have one to four carbon atoms. Examples of preferred haloalkyl groups include trifluoromethyl and pentafluoroethyl groups.

Haloalkoxy groups alkoxy groups or residues wherein one or more hydrogens from the R group of the alkoxy group are a halogen atom (fluorine, chlorine, bromine, and iodine). Preferred haloalkoxy groups can have one to four carbon atoms. Examples of preferred haloalkoxy groups include trifluoromethyoxy and pentafluoroethoxy groups.

The term “oxo” denotes a carbon atom bonded to two additional carbon atoms substituted with an oxygen atom doubly bonded to the carbon atom, thereby forming a ketone radical or residue.

“Alkoxy” or “alkoxyl” refers to an —OR radical or group, wherein R is an alkyl radical. In some embodiments the alkoxy groups can be C₁ to C₈, and in other embodiments can be C₁ to C₄ alkoxy groups wherein R is a lower alkyl, such as a methoxy, ethoxy, n-propoxy, isopropoxy, n-butoxy, t-butoxy and like alkoxy groups. The term “substituted alkoxy” means that the R group is a substituted alkyl group or residue. Examples of substituted alkoxy groups include trifluoromethoxy, hydroxymethyl, hydroxyethyl, hydroxypropyl, and alkoxyalkyl groups such as methoxymethyl, methoxyethyl, polyoxoethylene, polyoxopropylene, and similar groups.

“Alkoxyalkyl” refers to an —R—O—R′ group or radical, wherein R and R′ are alkyl groups. In some embodiments the alkoxyalkyl groups can be C₁ to C₈, and in other embodiments can be C₁ to C₄. In many embodiments, both R and R′ are a lower alkyl, such as a methoxy, ethoxy, n-propoxy, isopropoxy, n-butoxy, t-butoxy and like alkoxy groups. Examples of alkoxyalkyl groups include, methoxymethyl, ethoxyethyl, methoxypropyl, and methoxybutyl and similar groups.

“Hydroxyalkyl” refers to an —R—OH group or radical, wherein R is an alkyl group. In some embodiments the hydoxyalkyl groups can be C₁ to C₈, and in other embodiments can be C₁ to C₄. In many embodiments, R is a lower alkyl. Examples of alkoxyalkyl groups include, hydroxymethyl, 1-hydroxyethyl, 2-hydroxyethyl 3-hydroxypropyl, and similar groups.

“Acyloxy” refers to an RCO₂— ester group where R is an alkyl, cycloalkyl, aryl, heteroaryl, substituted alkyl, substituted cycloalkyl, substituted aryl, or substituted heteraryl group or radical wherein the R radical comprises one to seven or one to four carbon atoms. In many embodiments, R is an alkyl radical, and such acyloxy radicals are exemplified by formyloxy, acetoxy, propionyloxy, butyryloxy, pivaloyloxy, pentanoyloxy, hexanoyloxy, heptanoyloxy and the like. In other embodiments the R groups are C₁-C₄ alkyls.

As used herein, “acyl” encompasses the definitions of alkyl, alkenyl, alkynyl and the related hetero-forms which are coupled to an additional organic residue through a carbonyl group to form a ketone radical or group. Preferred acyl groups are “C₁ to C₇ acyl” such as formyl, acetyl, propionyl, butyryl, pentanoyl, pivaloyl, hexanoyl, heptanoyl, benzoyl and the like. More preferred acyl groups are acetyl and benzoyl.

The term “substituted acyl” denotes an acyl group wherein the R group substituted by one or more, and preferably one or two, halogen, hydroxy, oxo, alkyl, cycloalkyl, naphthyl, amino, (monosubstituted)amino, (disubstituted)amino, guanidino, heterocyclic ring, substituted heterocyclic ring, imidazolyl, indolyl, pyrrolidinyl, C₁ to C₇ alkoxy, alkoxy-alkyl, C₁ to C₇ acyl, C1 to C7 acyloxy, nitro, C₁ to C₆ alkyl ester, carboxy, alkoxycarbonyl, carbamoyl, carboxamide, N-(C₁ to C₆ alkyl)carboxamide, N,N-di(C₁ to C₆ alkyl)carboxamide, cyano, methylsulfonylamino, thiol, C₁ to C₄ alkylthio or C₁ to C₄ alkylsulfonyl groups. The substituted acyl groups may be substituted once or more, and preferably once or twice, with the same or with different substituents.

Examples of C₁ to C₇ substituted acyl groups include 4-phenylbutyroyl, 3-phenylbutyroyl, 3 phenylpropanoyl, 2-cyclohexanylacetyl, cyclohexanecarbonyl, 2-furanoyl and 3 dimethylaminobenzoyl.

Cycloalkyl residues or groups are structurally related to cyclic monocylic or bicyclic hydrocarbon compounds wherein one or more hydrogen atoms have been replaced with an organic or inorganic substituent group. The cycloalkyls of the current inventions comprise at least 3 up to 12, or more preferably 3 to 8 ring carbon atoms, or more preferably 4 to 6 ring carbon atoms. Examples of such cyclalkyl residues include cyclopropyl, cyclobutyl, cyclopentyl, cyclohexyl, cycloheptyl, cyclooctyl rings, and saturated bicyclic or fused polycyclic cycloalkanes such as decalin groups, polycyclic norbornyl or adamantly groups, and the like.

Preferred cycloalkyl groups include “C3 to C7 cycloalkyl” such as cyclopropyl, cyclobutyl, cyclopentyl, cyclohexyl or cycloheptyl rings. Similarly, the term “C5 to C7 cycloalkyl” includes cyclopentyl, cyclohexyl or cycloheptyl rings.

“Substituted cycloalkyl” denote a cycloalkyl rings as defined above, substituted by 1 to four, or preferably one or two substituents independently selected from a halogen, hydroxy, C₁ to C₄ alkylthio, C₁ to C₄ alkylsulfoxide, C₁ to C₄ alkylsulfonyl, C₁ to C₄ substituted alkylthio, C₁ to C₄ substituted alkylsulfoxide, C₁ to C₄ substituted alkylsulfonyl, C₁ to C₄ alkyl, C₁ to C₄ alkoxy, C₁ to C₆ substituted alkyl, C₁ to C₄ alkoxy-alkyl, oxo (monosubstituted)amino, (disubstituted)amino, trifluoromethyl, carboxy, phenyl, substituted phenyl, phenylthio, phenylsulfoxide, phenylsulfonyl, amino. In many embodiments of substituted cycloalkyl groups, the substituted cycloalkyl group will have 1, 2, 3, or 4 substituent groups independently selected from hydroxy, fluoro, chloro, NH₂, NHCH₃, N(CH₃)₂, CO₂CH₃, SEt, SCH₃, methyl, ethyl, isopropyl, vinyl, trifluoromethyl, methoxy, ethoxy, isopropoxy, and trifluoromethoxy groups.

The term “cycloalkylene” means a cycloalkyl, as defined above, where the cycloalkyl radical is bonded at two positions connecting together two separate additional groups. Similarly, the term “substituted cycloalkylene” means a cycloalkylene where the cycloalkyl radical is bonded at two positions connecting together two separate additional groups and further bearing at least one additional substituent.

The term “cycloalkenyl” indicates preferably a 1,2, or 3-cyclopentenyl ring, a 1,2,3 or 4-cyclohexenyl ring or a 1,2,3,4 or 5-cycloheptenyl ring, while the term “substituted cycloalkenyl” denotes the above cycloalkenyl rings substituted with a substituent, preferably by a C₁ to C₆ alkyl, halogen, hydroxy, C₁ to C₇ alkoxy, alkoxy-alkyl, trifluoromethyl, carboxy, alkoxycarbonyl oxo, (monosubstituted)amino, (disubstituted)amino, phenyl, substituted phenyl, amino, or protected amino.

The term “cycloalkenylene” is a cycloalkenyl ring, as defined above, where the cycloalkenyl radical is bonded at two positions connecting together two separate additional groups. Similarly, the term “substituted cycloalkenylene” means a cycloalkenylene further substituted preferably by halogen, hydroxy, C₁ to C₄ alkylthio, C₁ to C₄ alkylsulfoxide, C, to C₄ alkylsulfonyl, C₁ to C₄ substituted alkylthio, C₁ to C₄ substituted alkylsulfoxide, C₁ to C₄ substituted alkylsulfonyl, C₁ to C₆ alkyl, C₁ to C₇ alkoxy, C₁ to C₆ substituted alkyl, C₁ to C₇ alkoxy-alkyl, oxo, (monosubstituted)amino, (disubstituted)amino, trifluoromethyl, carboxy, alkoxycarbonyl, phenyl, substituted phenyl, phenylthio, phenylsulfoxide, phenylsulfonyl, amino, or substituted amino group.

The term “heterocycle” or “heterocyclic ring” denotes optionally substituted 3 to 8-membered rings having one or more carbon atoms connected in a ring that also comprise 1 to 5 ring heteroatoms, such as oxygen, sulfur and/or nitrogen inserted into the ring. These heterocyclic rings can be saturated, unsaturated or partially unsaturated, but are preferably saturated. An “amino-substituted heterocyclic ring” means any one of the above-described heterocyclic rings is substituted with at least one amino group. Preferred unsaturated heterocyclic rings include furanyl, thiofuranyl, pyrrolyl, pyridyl, pyrimidyl, pyrazinyl, benzoxazole, benzthiazole, quinolinlyl, and like heteroaromatic rings. Preferred saturated heterocyclic rings include piperidyl, aziridinyl, piperidinyl, piperazinyl, tetrahydrofurano, pyrrolyl, and tetrahydrothiophen-yl.rings.

The term “substituted heterocycle” or “substituted heterocyclic ring” means the above-described heterocyclic ring is substituted with, for example, one or more, and preferably one or two, substituents which are the same or different which substituents preferably can be halogen, hydroxy, thio, alkylthio, cyano, nitro, C₁ to C₄ alkyl, C₁ to C₄ alkoxy, C₁ to C₄ substituted alkoxy, alkoxy-alkyl, C₁ to C₄ acyl, C₁ to C₄ acyloxy, carboxy, alkoxycarbonyl, carboxymethyl, hydroxymethyl, alkoxy-alkyl amino, monosubstituted)amino, (disubstituted)amino carboxamide, N-(C₁ to C₆ alkyl)carboxamide, N,N-di(C₁ to C₆ alkyl)carboxamide, trifluoromethyl, N-((C₁ to C₆ alkyl)sulfonyl)amino, N-(phenylsulfonyl)amino groups, or substituted with a fused ring, such as benzo-ring. In many embodiments of substituted heterocyclic groups, the substituted cycloalkyl group will have 1, 2, 3, or 4 substituent groups independently selected from hydroxy, fluoro, chloro, NH₂, NHCH₃, N(CH₃)₂, CO₂CH₃, SEt, SCH₃, methyl, ethyl, isopropyl, vinyl, trifluoromethyl, methoxy, ethoxy, isopropoxy, and trifluoromethoxy groups.

An “aryl” groups refers to a monocyclic, linked bicyclic or fused bicyclic radical or group comprising at least one six membered aromatic “benzene” ring. Aryl groups preferably comprise between 6 and 12 ring carbon atoms, and are exemplified by phenyl, biphenyl, naphthyl indanyl, and tetrahydronapthyl groups. Aryl groups can be optionally substituted with various organic and/or inorganic substitutent groups, wherein the substituted aryl group in combination with all its substituents comprise between 6 and 18, or preferably 6 and 16 total carbon atoms. Preferred optional substituent groups include 1, 2, 3, or 4 substituent groups independently selected from hydroxy, fluoro, chloro, NH₂, NHCH₃, N(CH₃)₂, CO₂CH₃, SEt, SCH₃, methyl, ethyl, isopropyl, vinyl, trifluoromethyl, methoxy, ethoxy, isopropoxy, and trifluoromethoxy groups.

The term “heteroaryl” means a heterocyclic aryl derivative which preferably contains a five-membered or six-membered conjugated and aromatic ring system having from 1 to 4 heteroatoms independently selected from oxygen, sulfur and/or nitrogen, inserted into the unsaturated and conjugated heterocyclic ring. Heteroaryl groups include monocyclic heteroaromatic, linked bicyclic heteroaromatic or fused bicyclic heteroaromatic moieties. Examples of heteroaryls include pyridinyl, pyrimidinyl, and pyrazinyl, pyridazinyl, pyrrolyl, furanyl, thiofuranyl, oxazoloyl, isoxazolyl, phthalimido, thiazolyl, quinolinyl, isoquinolinyl, indolyl, or a furan or thiofuran directly bonded to a phenyl, pyridyl, or pyrrolyl ring and like unsaturated and conjugated heteroaromatic rings. Any monocyclic, linked bicyclic, or fused bicyclic heteroaryl ring system which has the characteristics of aromaticity in terms of electron distribution throughout the ring system is included in this definition. Typically, the heteroaromatic ring systems contain 3-12 ring carbon atoms and 1 to 5 ring heteroatoms independently selected from oxygen, nitrogen, and sulfur atoms.

The term “substituted heteroaryl” means the above-described heteroaryl is substituted with, for example, one or more, and preferably one or two, substituents which are the same or different which substituents preferably can be halogen, hydroxy, protected hydroxy, thio, alkylthio, cyano, nitro, C₁ to C₆ alkyl, C₁ to C₇ substituted alkyl, C₁ to C₇ alkoxy, C₁ to C₇ substituted alkoxy, alkoxy-alkyl, C₁ to C₇ acyl, C₁ to C₇ substituted acyl, C₁ to C₇ acyloxy, carboxy, alkoxycarbonyl, carboxymethyl, hydroxymethyl, amino, (monosubstituted)amino, (disubstituted)amino, carboxamide, N-(C1 to C6 alkyl)carboxamide, N,N-di(C1 to C6 alkyl)carboxamide, trifluoromethyl, N-((C1 to C6 alkyl)sulfonyl)amino or N-(phenylsulfonyl)amino groups. In many embodiments of substituted heteroaryl groups, the substituted cycloalkyl group will have 1, 2, 3, or 4 substituent groups independently selected from hydroxy, fluoro, chloro, NH₂, NHCH₃, N(CH₃)₂, CO₂CH₃, SEt, SCH₃, methyl, ethyl, isopropyl, vinyl, trifluoromethyl, methoxy, ethoxy, isopropoxy, and trifluoromethoxy groups.

Similarly, “arylalkyl” and “heteroarylalkyl” refer to aromatic and heteroaromatic systems which are coupled to another residue through a carbon chain, including substituted or unsubstituted, saturated or unsaturated, carbon chains, typically of 1-6C. These carbon chains may also include a carbonyl group, thus making them able to provide substituents as an acyl moiety. Preferably, arylalkyl or heteroarylalkyl is an alkyl group substituted at any position by an aryl group, substituted aryl, heteroaryl or substituted heteroaryl. Preferred groups also include benzyl, 2-phenylethyl, 3-phenyl-propyl, 4-phenyl-n-butyl, 3-phenyl-n-amyl, 3-phenyl-2-butyl, 2-pyridinylmethyl, 2-(2-pyridinyl)ethyl, and the like.

The term “substituted arylalkyl” denotes an arylalkyl group substituted on the alkyl portion with one or more, and preferably one or two, groups preferably chosen from halogen, hydroxy, oxo, amino, (monosubstituted)amino, (disubstituted)amino, guanidino, heterocyclic ring, substituted heterocyclic ring, C₁ to C₆ alkyl, C₁ to C₆ substituted alkyl, C₁ to C₇ alkoxy, C₁ to C₇ substituted alkoxy, alkoxy-alkyl, C₁ to C₇ acyl, C₁ to C₇ substituted acyl, C₁ to C₇ acyloxy, nitro, carboxy, alkoxycarbonyl, carbamoyl, carboxamide, N-(C₁ to C₆ alkyl)carboxamide, N,N-(C₁ to C₆ dialkyl)carboxamide, cyano, N-(C₁ to C₆ alkylsulfonyl)amino, thiol, C₁ to C₄ alkylthio, C₁ to C₄ alkylsulfonyl groups; and/or the phenyl group may be substituted with one or more, and preferably one or two, substituents preferably chosen from halogen, hydroxy, protected hydroxy, thio, alkylthio, cyano, nitro, C₁ to C₆ alkyl, C₁ to C₆ substituted alkyl, C₁ to C₇ alkoxy, C₁ to C₇ substituted alkoxy, alkoxy-alkyl, C₁ to C₇ acyl, C₁ to C₇ substituted acyl, C₁ to C₇ acyloxy, carboxy, alkoxycarbonyl, carboxymethyl, hydroxymethyl, amino, (monosubstituted)amino, (disubstituted)amino, carboxamide, N-(C₁ to C₆ alkyl) carboxamide, N,N-di(C₁ to C₆ alkyl)carboxamide, trifluoromethyl, N-((C1 to C6 alkyl)sulfonyl)amino, N-(phenylsulfonyl)amino, cyclic C₂ to C₇ alkylene or a phenyl group, substituted or unsubstituted, for a resulting biphenyl group. The substituted alkyl or phenyl groups may be substituted with one or more, and preferably one or two, substituents which can be the same or different.

Examples of the term “substituted arylalkyl” include groups such as 2-phenyl-1-chloro ethyl, 2-(4-methoxyphenyl)ethyl, 4-(2,6-dihydroxy phenyl)-n-hexyl, 2-(5-cyano-3-methoxyphenyl)-n-pentyl, 3-(2,6-dimethylphenyl)propyl, 4-chloro-3-aminobenzyl, 6-(4-methoxyphenyl)-3-carboxy-n-hexyl, 5-(4-aminomethylphenyl)-3-(aminomethyl)-n-pentyl, 5-phenyl-3-oxo-n-pent-1-yl and the like.

The term “arylalkylene” specifies an arylalkyl, as defined above, where the arylalkyl radical is bonded at two positions connecting together two separate additional groups. The definition includes groups of the formula: -phenyl-alkyl- and alkyl-phenyl-alkyl-. Substitutions on the phenyl ring can be 1,2, 1,3 or 1,4. The term “substituted arylalkylene” is an arylalkylene as defined above that is further substituted preferably by halogen, hydroxy, protected hydroxy, C₁ to C₄ alkylthio, C₁ to C₄ alkylsulfoxide, C₁ to C₄ alkylsulfonyl, C₁ to C₄ substituted alkylthio, C₁ to C₄ substituted alkylsulfoxide, C₁ to C₄ substituted alkylsulfonyl, C₁ to C₆ alkyl, C₁ to C₇ alkoxy, C₁ to C₆ substituted alkyl, C₁ to C₇ alkoxy-alkyl, oxo, (monosubstituted)amino, (disubstituted)amino, trifluoromethyl, carboxy, alkoxycarbonyl, phenyl, substituted phenyl, phenylthio, phenylsulfoxide, phenylsulfonyl, amino, or protected amino group on the phenyl ring or on the alkyl group.

The term “substituted phenyl” specifies a phenyl group substituted with one or more, and preferably one or two, moieties preferably chosen from the groups consisting of halogen, hydroxy, protected hydroxy, thio, alkylthio, cyano, nitro, C₁ to C₆ alkyl, C₁ to C₆ substituted alkyl, C₁ to C₇ alkoxy, C₁ to C₇ substituted alkoxy, alkoxy-alkyl, C₁ to C₇ acyl, C₁ to C₇ substituted acyl, C₁ to C₇ acyloxy, carboxy, alkoxycarbonyl, carboxymethyl, hydroxymethyl, amino, (monosubstituted)amino, (disubstituted)amino, carboxamide, N-(C₁ to C₆ alkyl)carboxamide, N,N-di(C₁ to C₆ alkyl)carboxamide, trifluoromethyl, N-((C₁ to C₆ alkyl)sulfonyl)amino, N-(phenylsulfonyl)amino or phenyl, wherein the phenyl is substituted or unsubstituted, such that, for example, a biphenyl results. In many embodiments of substituted phenyl groups, the substituted cycloalkyl group will have 1, 2, 3, or 4 substituent groups independently selected from hydroxy, fluoro, chloro, NH₂, NHCH₃, N(CH₃)₂, CO₂CH₃, SEt, SCH₃, methyl, ethyl, isopropyl, vinyl, trifluoromethyl, methoxy, ethoxy, isopropoxy, and trifluoromethoxy groups.

The term “phenoxy” denotes a phenyl bonded to an oxygen atom. The term “substituted phenoxy” specifies a phenoxy group substituted with one or more, and preferably one or two, moieties preferably chosen from the groups consisting of halogen, hydroxy, protected hydroxy, thio, alkylthio, cyano, nitro, C₁ to C₆ alkyl, C₁ to C₇ alkoxy, C, to C₇ substituted alkoxy, alkoxy-alkyl, C₁ to C₇ acyl, C₁ to C₇ acyloxy, carboxy, alkoxycarbonyl, carboxymethyl, hydroxymethyl, amino, (monosubstituted)amino, (disubstituted)amino, carboxamide, N-(C₁ to C₆ alkyl)carboxamide, N,N-di(C1 to C6 alkyl)carboxamide, trifluoromethyl, N-((C1 to C6 alkyl)sulfonyl)amino and N-phenylsulfonyl)amino.

The term “substituted phenylalkoxy” denotes a phenylalkoxy group wherein the alkyl portion is substituted with one or more, and preferably one or two, groups preferably selected from halogen, hydroxy, protected hydroxy, oxo, amino, (monosubstituted)amino, (disubstituted)amino, guanidino, heterocyclic ring, substituted heterocyclic ring, C₁ to C₇ alkoxy, alkoxy-alkyl, C₁ to C₇ acyl, C₁ to C₇ acyloxy, nitro, carboxy, alkoxycarbonyl, carbamoyl, carboxamide, N-(C₁ to C₆ alkyl)carboxamide, N,N-(C₁ to C₆ dialkyl)carboxamide, cyano, N-(C₁ to C₆ alkylsulfonyl)amino, thiol, C₁ to C₄ alkylthio, C₁ to C₄ alkylsulfonyl groups; and/or the phenyl group can be substituted with one or more, and preferably one or two, substituents preferably chosen from halogen, hydroxy, protected hydroxy, thio, alkylthio, cyano, nitro, C₁ to C₆ alkyl, C₁ to C₇ alkoxy, alkoxy-alkyl, C₁ to C₇ acyl, C₁ to C₇ acyloxy, carboxy, alkoxycarbonyl carboxymethyl, hydroxymethyl, amino, (monosubstituted)amino, (disubstituted)amino, carboxamide, N-(C₁ to C₆ alkyl) carboxamide, N,N-di(C₁ to C₆ alkyl)carboxamide, trifluoromethyl, N((C₁ to C₆ alkyl)sulfonyl)amino, N-(phenylsulfonyl)amino or a phenyl group, substituted or unsubstituted, for a resulting biphenyl group. The substituted alkyl or phenyl groups may be substituted with one or more, and preferably one or two, substituents which can be the same or different.

The term “substituted naphthyl” specifies a naphthyl group substituted with one or more, and preferably one or two, moieties either on the same ring or on different rings chosen from the groups consisting of halogen, hydroxy, protected hydroxy, thio, alkylthio, cyano, nitro, C₁ to C₆ alkyl, C₁ to C₇ alkoxy, alkoxy-alkyl, C₁ to C₇ acyl, C₁ to C₇ acyloxy, carboxy, alkoxycarbonyl, carboxymethyl, hydroxymethyl, amino, (monosubstituted)amino, (disubstituted)amino, carboxamide, N-(C₁ to C₆ alkyl)carboxamide, N,N-di(C₁ to C₆ alkyl)carboxamide, trifluoromethyl, N-((C₁ to C₆ alkyl)sulfonyl)amino or N (phenylsulfonyl)amino.

The terms “halo” and “halogen” refer to the fluoro, chloro, bromo or iodo atoms. There can be one or more halogen, which are the same or different. Preferred halogens are chloro and fluoro. Although many of the compounds of the invention having halogen atoms as substituents are highly effective in binding to the relevant taste receptors, such halogenated organic compounds can in some cases have undesirable toxicological properties when administered to an animal in vivo. Therefore, in many embodiments of the compounds of Formula (I), if a halogen atom (including a fluoro or chloro atom) is listed as a possible substitutent, an alternative and preferred group of substitutents expressly contemplated hereby would NOT include the halogen groups.

The term “(monosubstituted)amino” refers to an amino (NHR) group wherein the R group is chosen from the group consisting of phenyl, C₆-C₁₀ substituted phenyl, C₁ to C₆ alkyl, C₁ to C₆ substituted alkyl, C₁ to C₇ acyl, C₁ to C₇ substituted acyl, C₂ to C₇ alkenyl, C₂ to C₇ substituted alkenyl, C₂ to C₇ alkynyl, C₂ to C₇ substituted alkynyl, C₇ to C₁₂ phenylalkyl, C₇ to C₁₂ substituted phenylalkyl and heterocyclic ring. The (monosubstituted)amino can additionally have an amino-protecting group as encompassed by the term “protected (monosubstituted)amino.”

The term “(disubstituted)amino” refers to an amino group (NR2) with two substituents independently chosen from the group consisting of phenyl, C₆-C₁₀ substituted phenyl, C₁ to C₆ alkyl, C₁ to C₆ substituted alkyl, C₁ to C₇ acyl, C₂ to C₇ alkenyl, C₂ to C₇ alkynyl, C₇ to C₁₂ phenylalkyl, and C₇ to C₁₂ substituted phenylalkyl. The two substituents can be the same or different.

The term “amino-protecting group” as used herein refers to substituents of the amino group commonly employed to block or protect the amino functionality while reacting other functional groups of the molecule. The term “protected (monosubstituted)amino” means there is an amino-protecting group on the monosubstituted amino nitrogen atom. In addition, the term “protected carboxamide” means there is an amino-protecting group on the carboxamide nitrogen. Similarly, the term “protected N-(C₁ to C₆ alkyl)carboxamide” means there is an amino-protecting group on the carboxamide nitrogen.

The term “alkylthio” refers to —SR groups wherein R is an optionally substituted C₁-C₇ or C₁-C₄organic group, preferably an alkyl, cycloalkyl, aryl, or heterocyclic group, such as methylthio, ethylthio, n-propylthio, isopropylthio, n-butylthio, t-butylthio and like groups.

The term “alkylsulfoxide” indicates —SO₂R groups wherein R is an optionally substituted C₁-C₇ or C₁-C₄organic group, preferably an alkyl, cycloalkyl, aryl, or heterocyclic group, such as methylthio, ethylthio, n-propylthio, isopropylthio, n-butylthio, t-butylthio and like groups, such as methylsulfoxide, ethylsulfoxide, n-propylsulfoxide, isopropylsulfoxide, n-butylsulfoxide, sec-butylsulfoxide and the like.

The term “alkylsulfonyl” indicates —S(O)R groups wherein R is an optionally substituted C₁-C₇ or C₁-C₄ organic group, which include for example groups such as methylsulfonyl, ethylsulfonyl, n-propylsulfonyl, isopropylsulfonyl, n-butylsulfonyl, t-butylsulfonyl and the like.

The terms “phenylthio,” “phenylsulfoxide,” and “phenylsulfonyl” specify a sulfoxide (—S(O)—R), or sulfone (—SO₂R) wherein the R group is a phenyl group. The terms “substituted phenylthio,” “substituted phenylsulfoxide,” and “substituted phenylsulfonyl” means that the phenyl of these groups can be substituted as described above in relation to “substituted phenyl.”

The term “alkoxycarbonyl” means an “alkoxy” group attached to a carobonyl group, (—C(O)—OR, wherein R is an alkyl group, preferably a C₁-C₄ alkyl group. The term “substituted alkoxycarbonyl” denotes a substituted alkoxy bonded to the carbonyl group, which alkoxy may be substituted as described above in relation to substituted alkyl.

The term “phenylene” means a phenyl group where the phenyl radical is bonded at two positions connecting together two separate additional groups. Examples of “phenylene” includes 1,2-phenylene, 1,3-phenylene, and 1,4-phenylene.

The term “substituted alkylene” means an alkyl group where the alkyl radical is bonded at two positions connecting together two separate additional groups and further bearing an additional substituent. Examples of “substituted alkylene” includes aminomethylene, 1-(amino)-1,2-ethyl, 2-(amino)-1,2-ethyl, 1-(acetamido)-1,2-ethyl, 2-(acetamido)-1,2-ethyl, 2-hydroxy-1,1-ethyl, 1-(amino)-1,3-propyl.

The term “substituted phenylene” means a phenyl group where the phenyl radical is bonded at two positions connecting together two separate additional groups, wherein the phenyl is substituted as described above in relation to “substituted phenyl.”

The terms “cyclic alkylene,” “substituted cyclic alkylene,” “cyclic heteroalkylene,” and “substituted cyclic heteroalkylene,” defines such a cyclic group or radical pbonded (“fused”) to a phenyl radical, resulting in a fused bicyclic ring group or radical. The non-fused members of the cyclic alkylene or heteralkylene ring may contain one or two double bonds, or often are saturated. Furthermore, the non-fused members of the cyclic alkylene or heteralkylene ring, can have one or two methylene or methine groups replaced by one or two oxygen, nitrogen or sulfur atoms, or NH, NR, S(O) or SO2 groups, where R is a lower alkyl group.

The cyclic alkylene or heteroalkylene group may be substituted once or twice by the same or different substituents preferably selected from the group consisting of the following moieties: hydroxy, protected hydroxy, carboxy, protected carboxy, oxo, protected oxo, C₁ to C₄ acyloxy, formyl, C₁ to C₇ acyl, C₁ to C₆ alkyl, C₁ to C₇ alkoxy, C₁ to C₄ alkylthio, C₁ to C₄ alkylsulfoxide, C₁ to C₄ alkylsulfonyl, halo, amino, protected amino, (monosubstituted)amino, protected (monosubstituted)amino, (disubstituted)amino, hydroxymethyl or a protected hydroxymethyl. The cyclic alkylene or heteroalkylene group fused onto the benzene radical can contain two to ten ring members, but it preferably contains three to six members. Examples of saturated cyclic alkylene groups are 2,3-dihydro-indanyl and a tetralin ring systems. When the cyclic groups are unsaturated, examples include a naphthyl ring or indolyl group or radical. Examples of fused cyclic groups which each contain one nitrogen atom and one or more double bond, preferably one or two double bonds, are when the benzene radical is fused to a pyridyl, pyranyl, pyrrolyl, pyridinyl, dihydropyrolyl, or dihydropyridinyl groups or radicals. Examples of fused cyclic groups which each contain one oxygen atom and one or two double bonds are illustrated by a benzene radical ring fused to a furnanyl, pyranyl, dihydrofuranyl, or dihydropyranyl ring. Examples of fused cyclic groups which each have one sulfur atom and contain one or two double bonds are when the benzene radical is fused to a thienyl, thiopyranyl, dihydrothienyl or dihydrothiopyranyl ring. Examples of cyclic groups which contain two heteroatoms selected from sulfur and nitrogen and one or two double bonds are when the benzene radical ring is fused to a thiazolyl, isothiazolyl, dihydrothiazolyl or dihydroisothiazolyl ring. Examples of cyclic groups which contain two heteroatoms selected from oxygen and nitrogen and one or two double bonds are when the benzene ring is fused to an oxazolyl, isoxazolyl, dihydrooxazolyl or dihydroisoxazolyl ring. Examples of cyclic groups which contain two nitrogen heteroatoms and one or two double bonds occur when the benzene ring is fused to a pyrazolyl, imidazolyl, dihydropyrazolyl or dihydroimidazolyl ring or pyrazinyl.

The term “carbamoyl” refers to a carbamate group or radical, which often derived from the reaction of an organic isocyanate compound R₁—NCO with an alcohol R₂—OH, to yield a carbamate compound having the structure R₁—NH—C(O)—OR₂ wherein the nature of the R₁ and R₂ radicals are further defined by the circumstances.

One or more of the compounds of the invention, may be present as a salt. The term “salt” encompasses those salts that form with the carboxylate anions and amine nitrogens and include salts formed with the organic and inorganic anions and cations discussed below. Furthermore, the term includes salts that form by standard acid-base reactions with basic groups (such as nitrogen containing heterocycles or amino groups) and organic or inorganic acids. Such acids include hydrochloric, hydrofluoric, trifluoroacetic, sulfuric, phosphoric, acetic, succinic, citric, lactic, maleic, fumaric, palmitic, cholic, pamoic, mucic, D-glutamic, D-camphoric, glutaric, phthalic, tartaric, lauric, stearic, salicyclic, methanesulfonic, benzenesulfonic, sorbic, picric, benzoic, cinnamic, and like acids.

The term “organic or inorganic cation” refers to positively charged counter-ions for the carboxylate anion of a carboxylate salt. Inorganic positively charged counter-ions include but are not limited to the alkali and alkaline earth metals, (such as lithium, sodium, potassium, calcium, magnesium, etc.) and other divalent and trivalent metallic cations such as barium, aluminum and the like, and ammonium (NH₄)⁺ cations. Organic cations include ammonium cations derived from acid treatment or alkylation of primary-, secondary, or tertiary amines such as trimethylamine, cyclohexylamine; and the organic cations, such as dibenzylammonium, benzylammonium, 2-hydroxyethylammonium, bis(2-hydroxyethyl)ammonium, phenylethylbenzylammonium, dibenzylethylenediammonium, and like cations. See, for example, “Pharmaceutical Salts,” Berge, et al., J. Pharm. Sci. (1977) 66:1-19, which is incorporated herein by reference. Other cations encompassed by the above term include the protonated form of procaine, quinine and N-methylglucosamine, and the protonated forms of basic amino acids such as glycine, ornithine, histidine, phenylglycine, lysine and arginine. Furthermore, any zwitterionic form of the instant compounds formed by a carboxylic acid and an amino group is referred to by this term. For example, a cation for a carboxylate anion will exist when R² or R³ is substituted with a (quaternary ammonium)methyl group. A preferred cation for the carboxylate anion is the sodium cation.

The compounds of the invention can also exist as solvates and hydrates. Thus, these compounds may crystallize with, for example, waters of hydration, or one, a number of, or any fraction thereof of molecules of the mother liquor solvent. The solvates and hydrates of such compounds are included within the scope of this invention.

The term “amino acid” includes any one of the twenty naturally-occurring amino acids or the D-form of any one of the naturally-occurring amino acids. In addition, the term “amino acid” also includes other non-naturally occurring amino acids besides the D-amino acids, which are functional equivalents of the naturally-occurring amino acids. Such non-naturally-occurring amino acids include, for example, norleucine (“Nle”), norvaline (“Nva”), L- or D-naphthalanine, ornithine (“Orn”), homoarginine (homoArg) and others well known in the peptide art, such as those described in M. Bodanzsky, “Principles of Peptide Synthesis,” 1st and 2nd revised ed., Springer-Verlag, New York, N.Y., 1984 and 1993, and Stewart and Young, “Solid Phase Peptide Synthesis,” 2nd ed., Pierce Chemical Co., Rockford, Ill., 1984, both of which are incorporated herein by reference. Amino acids and amino acid analogs can be purchased commercially (Sigma Chemical Co.; Advanced Chemtech) or synthesized using methods known in the art.

“Amino acid side chain” refers to any side chain from the above-described “amino acids.”

“Substituted” herein refers to a substituted moiety, such as a hydrocarbon, e.g., substituted alkyl or benzyl wherein at least one element or radical, e.g., hydrogen, is replaced by another, e.g., a hydrogen is replaced by a halogen as in chlorobenzyl.

A residue of a chemical species, as used in the specification and concluding claims, refers to a structural fragment, or a moiety that is the resulting product of the chemical species in a particular reaction scheme or subsequent formulation or chemical product, regardless of whether the structural fragment or moiety is actually obtained from the chemical species. Thus, an ethylene glycol residue in a polyester refers to one or more —OCH₂CH₂O— repeat units in the polyester, regardless of whether ethylene glycol is used to prepare the polyester.

The term “organic residue” or “organic group” or “organic radical” defines a carbon containing residue or group, i.e. a residue comprising at least one carbon atom. Organic residues can contain various heteroatoms, or be bonded to another molecule through a heteroatom, including oxygen, nitrogen, sulfur, phosphorus, or the like. Examples of organic residues include but are not limited alkyl or substituted alkyls, alkoxy or substituted alkoxy, hydroxyalkyls and alkoxyalkyls, mono or di-substituted amino, amide groups, CN, CO₂H, CHO, COR⁶, CO₂R⁶, SR⁶, S(O)R⁶, S(O)₂R6, alkenyl, cycloalkyl, cycloalkenyl, aryl, and heteroaryl: wherein R is an alkyl. More specific examples of species of organic groups or residues include but are not limited to NHCH₃, N(CH₃)₂, CO₂CH₃, SEt, SCH₃, S(O)CH₃, S(O)₂CH₃, methyl, ethyl, isopropyl, n-butyl, i-butyl, 1-methyl-propyl, t-butyl, vinyl, trifluoromethyl, methoxy, ethoxy, isopropoxy, trifluoromethoxy, CH₂OCH₃, CH₂OH, CH₂NH₂, CH₂NHCH₃, or CH₂N(CH₃)₂ groups or residues. Organic resides can comprise 1 to 18 carbon atoms, 1 to 15, carbon atoms, 1 to 12 carbon atoms, 1 to 8 carbon atoms, 1 to 6 carbon atoms, or in many embodiments 1 to 4 carbon atoms.

By the term “effective amount” of a compound as provided herein is meant a sufficient amount of one or more compounds in a composition that is sufficient to provide the desired regulation of a desired biological function, such as gene expression, protein function, or more particularly the induction of either of Umami or sweet taste perception in an animal or a human. As will be pointed out below, the exact amount required will vary from subject to subject, depending on the species, age, general condition of the subject, specific identity and formulation of the comestible composition, etc. Thus, it is not possible to specify an exact “effective amount.” However, an appropriate effective amount can be determined by one of ordinary skill in the art using only routine experimentation.

It must be noted that, as used in the specification and the appended claims, the singular forms “a,” “an” and “the” include plural referents unless the context clearly dictates otherwise. Thus, for example, reference to “an aromatic compound” includes mixtures of aromatic compounds.

Often, ranges are expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not. For example, the phrase “optionally substituted lower alkyl” means that the lower alkyl group may or may not be substituted and that the description includes both unsubstituted lower alkyl and lower alkyls where there is substitution.

The Tastant Compounds of the Invention

The compounds of the invention will be hereinafter referred to as the “tastant” compounds of the invention, have one of Formulas (Ia-k) shown below:

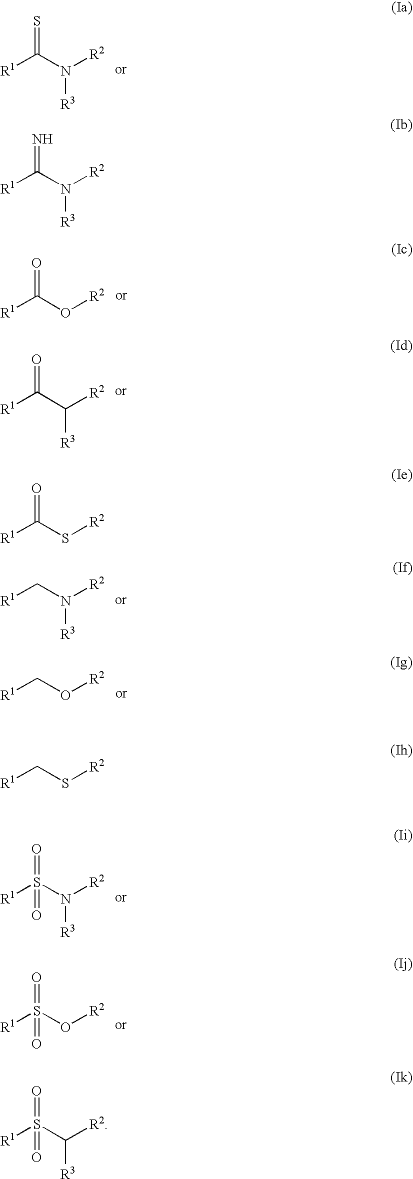

The tastant compounds of Formula (Ia-k) are all organic (carbon containing) compounds, because the R¹ and R² groups, and optionally the R³ group, are organic (carbon-containing) groups or residues that comprise at least three carbon atoms. R¹, R² and R³ can be and are independently further defined and inter-related in various ways, as is further detailed below.

Without wishing to be bound by theory, it is believed that the ability of the compounds of Formulas (Ia-k) to serve as agonists of the appropriate biological taste receptor target proteins is, at least as a working approximation, primarily determined by the chemical nature, size, shape, and polarity of the R¹, R², and/or R³ groups. Nevertheless, in order to strongly and selectively interact with the desired savory and/or sweet taste receptors, a given combination of the R¹, R², and/or R³ groups should be connected together at a suitable distance and in suitable geometrical relationship by a suitable “linker” functional group. The linker functional group also preferably provides at least some degree of polarity and/or water solubility.

Again, while not wishing to be bound by any theory, it is believed that MSG binds to the T1R1 subunit of T1R1/T1R3 “savory” taste receptors, and that several known sweeteners bind to the T1R2 subunit of T1R2/T1R3 sweet receptors. It may be however that at least some of the tastant compounds of Formula (I) bind to the T1R3 protein subunit that is shared by the savory T1R1/T1R3 and/or sweet T1R2/T1R3 receptors. Accordingly, our unexpected discovery that the tastant compounds of Formula (I) can share many overlapping physical and chemical features, and that one compound can sometimes bind to both of the savory and sweet receptors, is perhaps in retrospect rationalizable from a chemical/biochemical/biological point of view.

Without wishing to be bound by theory, it is believed that when a suitable combination of R¹, R², and/or R³ groups is found to have good tastant activity, that it is normally found that compounds linked with chemically and/or structurally similar linker groups will also produce related classes of compounds that will also have similar desired tastant activities, as measurable by in-vitro and/or in-vivo testing of the new classes of compounds for tastant activity.

Nevertheless, despite the structural, physical, and chemical similarities, compounds comprising the various linker groups shown in Formulas (Ia-k) can also have some differences in chemical structure and stability, polarity, acid/base properties, pathways for biological degradation and/or toxicity, and the differences may depend on the selection of the R¹, R², and R³ groups. Accordingly, it is hereby specifically contemplated that any of the subgenera of compounds constituting Formulas (Ia-k) can be considered together, or constitute separate embodiments of the inventions further described herein.

For example, in some embodiments of the inventions, the comestible compositions of the invention can comprise at least a savory flavor modulating amount or a sweet flavor modulating amount of one or more non-naturally occurring “thiourea” tastant compounds having the Formula:

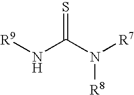

wherein:
a) R⁹ and R⁷ are independently selected from organic radicals comprising from three to sixteen carbon atoms optionally contain one or more heteroatoms, and optionally 1 to 10 heteroatoms independently selected from oxygen, nitrogen, sulfur, halogens, or phosphorus; and
b) R⁸ is hydrogen or an organic radical comprising from three to sixteen carbon atoms, and optionally 1 to 10 heteroatoms independently selected from oxygen, nitrogen, halogens, or phosphorus; and
c) wherein the tastant compound has a molecular weight of 500 grams per mole or less;
or a comestibly acceptable salt thereof. Such thiourea compounds are a subgenus of the thioamide compounds of Formula (Ia).

Similarly, in some embodiments of the inventions, the comestible compositions of the invention can comprise at least a savory flavor modulating amount or a sweet flavor modulating amount of one or more non-naturally occurring “thiourea” tastant compounds having the Formula (Ii):

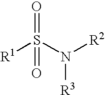

wherein:
a) R¹ and R² are independently selected from organic radicals comprising from three to sixteen carbon atoms optionally contain one or more heteroatoms, and optionally 1 to 10 heteroatoms independently selected from oxygen, nitrogen, sulfur, halogens, or phosphorus; and
b) R³ is hydrogen or an organic radical comprising from three to sixteen carbon atoms, and optionally 1 to 10 heteroatoms independently selected from oxygen, nitrogen, halogens, or phosphorus; and
c) wherein the tastant compound has a molecular weight of 500 grams per mole or less;
or a comestibly acceptable salt thereof.

One of ordinary skill in the art will readily recognize that compounds comprising “linker” groups analogous to the linker groups illustrated in the compounds of Formulas (Ia-k) can in many cases be imagined, synthesized, and subsequently tested for desirable tastant activity. Nevertheless, the tastant compounds of the present invention do not comprise any “amide” compounds having the structure shown below:

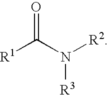

Certain genera of “Amide” compounds within the scope of the excluded amide compounds shown immediately above were disclosed and described as savory and/or sweet flavoring agents in U.S. Patent Publication US 2005 0084506 A1, and PCT Publication WO 2005/041684, the entire disclosures of which are hereby incorporated herein for all purposes. The “amide” compounds disclosed in those patent applications, including certain sub-genera of amide derivative compounds having linker groups such as ureas, oxalamides, acrylamides, and the like, are not part of the currently disclosed inventions.

Similarly, it is known in the prior art, as exemplified by U.S. Pat. No. 4,900,740, that certain compounds comprising a substituted guanidine residue of the structure shown below can serve as high potency sweeteners, but such compounds can be unsuitable for human consumption, and therefore such guanidine compounds may not be part of many embodiments of the current invention.

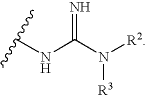

The tastant compounds of Formula (I) also do not include tastant compounds that naturally occur in biological systems, or comestible compositions such as foods or drinks before or after cooking, such as peptides, proteins, nucleic acids, certain amino sugars and/or amino polysaccharides, glycopeptides or glycoproteins, or the like. The tastant compounds of Formula (I) of the invention are man-made and artificial synthetic tastant compounds, although the Applicants do not exclude the possibility that compounds of Formula (I) could conceivably be purposely prepared, either in their specified form or in the form of a sugar, fat, or peptide or protein-modified “prodrug” form, by human beings utilizing one or more of the methods of modern biotechnology.

In the tastant compounds of Formula (I), the R¹ group is present in any of the compounds of Formula (I) and is typically an organic residue comprising at least three carbon atoms, with a variety of additional but alternative limits on the size and/or chemical characteristics of the R¹ group, as will be further described below. Similarly, the R² group is always present in the compounds of Formula (1), and is an organic residue comprising at least three carbon atoms, with a variety of additional but alternative limits on the size and/or chemical characteristics of the R² group.

The R³ group is not however present in some embodiments of the tastant compounds of Formula (I), see for example the carboxylic acid ester derivatives of Formula (Ic), the thioester derivatives of Formula (Ie), the ether derivatives of Formula (Ig), the thioether derivatives of Formula (Ih), and the sulfate ester derivatives of Formula (Ij). If the R³ substitutent group is present, i.e. in the thioamide derivatives of Formula (Ia), the amidine derivatives of Formula (Ib), the keto derivatives of Formula (Id), the amino derivatives of Formula (If), the sulfonamide derivatives of Formula (Ii), and the sulfone derivatives of Formula (Ik). If the R³ substitutent group is present, the R³ group can be hydrogen or an organic residue comprising at least three carbon atoms, with a variety of additional but alternative limits on the size and/or chemical characteristics of the R³ group, as is further discussed below.

In some embodiments of the tastant compounds of Formula (I), R² and R³, together with the atom to which they are commonly bonded can together form a residue that can be carbocyclic or heterocyclic ring, as will be further discussed below.

In some embodiments of the compounds of Formula (I), R¹ and R² are independently selected hydrocarbon or organic residues that may contain one or more heteroatoms, and R³ is, H or a hydrocarbon or organic residue that may contain one or more heteroatoms. In some embodiments, R¹, R² and/or R³ are independently selected from the group consisting of arylalkenyl, heteroarylalkenyl, arylalkyl, heteroarylalkyl, alkyl, alkoxy-alkyl, alkenyl, cycloalkyl, cycloalkenyl, aryl, heteroaryl, —R⁴OH, —R⁴CN, —R⁴CO₂H, —R⁴CO₂R⁵, —R⁴COR⁵, —R⁴CONR⁵R⁶, —R⁴NR⁵R⁶, —R⁴N(R⁵)COR⁶, —R⁴SR⁵, —R⁴SOR⁵, —R⁴SO₂R⁵, —R⁴SO₂NR⁵R⁶ and —R⁴N(R⁵)SO₂R⁶, or optionally substituted groups thereof, and preferably one of R² or R³ is H; wherein each R⁴ is independently a hydrocarbon residue that may contain one or more heteroatoms, preferably independently selected from small (C₁-C₆) alkylene or (C₁-C₆) alkoxyalkylene; and wherein each R⁵ and R⁶ are independently H or a hydrocarbon residue that may contain one or more heteroatoms, preferably independently selected from small (C₁-C₆) alkyl or (C₁-C₆) alkoxyalkyl.

In many embodiments of the compounds of Formula (I), R¹, R² and/or R³ can be an organic or hydrocarbon-based residue having at least three carbon atoms and optionally one to 20, 15, 10, 8, 7, 6, or 5 heteroatoms, independently selected from oxygen, nitrogen, sulfur, halogens, or phosphorus.

In many embodiments of the compounds of Formula (I), one of R² and R³ is optionally hydrogen (“H”), and one or both of R² and R³ comprises an organic or hydrocarbon-based residue having at least three carbon atoms and optionally one to ten heteroatoms independently selected from oxygen, nitrogen, sulfur, halogens, or phosphorus.

The compounds of Formula (I) are relatively “small molecules” as compared to many biological molecules, and can often have a variety of limitations on their overall physical size, molecular weight, and physical characteristics, so that they can be at least somewhat soluble in aqueous media, and are of appropriate size to effectively bind to the relevant T1R1/T1R3 or T1R2/T1R3 taste receptors.

As an example of the overlapping physical and chemical properties and/or physical/chemical limitations on the savory and/or sweet amides of Formula (I), in most embodiments of the compounds of Formula (I), the molecular weight of the compounds of Formula (I) should be less than about 800 grams per mole, or in further related embodiments less than or equal to about 700 grams per mole, 600 grams per mole, 500 grams per ole, 450 grams per mole, 400 grams per mole, 350 grams per mole, or 300 grams per mole.

Similarly, the compounds of Formula (I) can have preferred ranges of molecular weight, such as for example from about 175 to about 500 grams per mole, from about 200 to about 450 grams per mole, from about 225 to about 400 grams per mole, from about 250 to about 350 grams per mole.

In some embodiments, R¹ R² and/or R³ have between 3 and 16 carbon atoms or 4 and 14 carbon atoms or 5 and 12 carbon atoms, and 0, 1, 2, 3, 4, or 5 heteroatoms selected from oxygen, nitrogen, sulfur, fluorine, or chlorine. In some embodiments, at least one of R² or R³ has been 3 and 16 carbon atoms and 0, 1, 2, 3, 4, or 5 heteroatoms independently selected from oxygen, nitrogen, sulfur, fluorine, or chlorine. In some embodiments, at least one of R² or R³ has between 4 and 14 carbon atoms and 0, 1, 2, 3, 4, or 5 heteroatoms independently selected from oxygen, nitrogen, sulfur, fluorine; or even more preferably, at least one of R² or R³ has between 5 and 12 carbon atoms and 0, 1, 2, or 3 heteroatoms independently selected from oxygen, nitrogen, and sulfur.

Again, in many embodiments, it is desirable that the combination of the R¹ R² and/or R³ groups have a limited overall size, shape, and/or molecular weight. Accordingly, in some embodiments, the tastant compound has between 10 and 30 carbon atoms and a molecular weight of 500 grams per mole or less. In other embodiments, the tastant compound has between 12 and 25 carbon atoms and a molecular weight of 450 grams per mole or less.

In some embodiments, R¹, R², and R³ can be independently selected from the group consisting of an arylalkenyl, heteroarylalkenyl, arylalkyl, heteroarylalkyl, alkyl, alkoxy-alkyl, alkenyl, cycloalkyl, cycloalkenyl, aryl, heteroaryl, —R⁴OH, —R⁴OR⁵, —R⁴CN, —R⁴CO₂H, —R⁴CO₂R⁵, —R⁴COR⁵, —R⁴SR⁵, and —R⁴SO₂R⁵, and optionally substituted derivative thereof comprising 1, 2, 3, or 4 substituent groups that can be either inorganic or organic substituent atoms or groups, as those terms are defined elsewhere herein, which can include but are by no means limited to carbonyl, amino groups, hydroxyl, or halogen groups, wherein R⁴ and R⁵ are C₁-C₆ hydrocarbon residues.

In many embodiments of the compounds of Formula I, the optional substituent groups can typically be independently selected from the group consisting of hydroxyl, NH₂, SH, SO₃H, PO(OH)₂, NO₂, halogen, and a C₁-C₈ organic radical, or alternatively C₁-C₄ organic radicals. In related embodiments, the optional substituent groups can be independently selected from hydroxyl, NH₂, SH, halogen, C₁-C₄ alkyl, C₁-C₄ haloalkyl, C₁-C₄ haloalkoxy, C₁-C₄ alkoxyl, C₁-C₄ alkoxy-alkyl, C₁-C₄ hydroxy-alkyl, OH, NH₂, NHR⁶, NR⁶₂, CN, CO₂H, CO₂R⁶, CHO, COR⁶, SH, SR⁶, S(O)R⁶, S(O)₂R⁶, and halogen, wherein R⁶ is C₁-C₄ alkyl. In yet other related embodiments, the optional substituent groups can be independently selected from hydroxy, fluoro, chloro, NH₂, NHCH₃, N(CH₃)₂, COOCH₃, SCH₃, S(O)CH₃, S(O)₂CH₃, SEt, methyl, ethyl, isopropyl, n-propyl, n-butyl, 1-methyl-propyl, isobutyl, t-butyl, vinyl, trifluoromethyl, methoxy, ethoxy, isopropoxy, and trifluoromethoxy groups.

In further related embodiments of the tastant compounds of Formula (I), R¹, R² and R³ can be independently selected from the group consisting of an arylalkenyl, heteroarylalkenyl, arylalkyl, heteroarylalkyl, alkyl, alkoxy-alkyl, alkenyl, cycloalkyl, cycloalkenyl, heterocycle, aryl and heteroaryl groups, and optionally substituted derivatives thereof comprising 1, 2, 3 or 4 carbonyl, amino groups, hydroxyl, or chlorine, or fluorine groups. In both of the embodiments just mentioned, an alternative and preferred set of optional substituent groups would be substituents independently selected from hydroxy, fluoro, chloro, NH₂, NHCH₃, N(CH₃)₂, CO₂CH₃, SEt, SCH₃, S(O)CH₃, S(O)₂CH₃, methyl, ethyl, n-propyl, isopropyl, n-butyl, i-butyl, t-butyl, 1-methy-propyl, vinyl, trifluoromethyl, methoxy, ethoxy, isopropoxy, and trifluoromethoxy substituent groups.

In addition to the above described general physical and chemical characteristics and/or limitations, which can be shared by the various subgenera of the sweet and savory compounds of Formula (I), the compounds of Formula (I) can also share more specifically definable chemical structural features or chemical groups or residues, as is further described below.

The R² and/or R³ Groups

In many embodiments of the compounds of Formula (I), one of R² and R³ is hydrogen and the other R² or R³ group is an organic residue or group. Therefore it should be understood that a statement herein below that “at least one of R² and R³ . . . . ” contemplates as one embodiment that one or R² and R³ is hydrogen and the other of R² and R³ has the structure subsequently described, and as another embodiment that both of R² and R³ have the described structure.

In many embodiments, at least one of R² and R³ is a branched or cyclic organic residue having a carbon atom directly bonded to both (a) the amide nitrogen atom and (b) two additional carbon atoms from other organic residues, which are branched or cyclic organic residues comprising additional hydrogen atoms and up to 10 optional additional carbon atoms, and optionally from zero to five heteroatoms independently selected from oxygen, nitrogen, sulfur, fluorine, and chlorine. Such branched R² and R³ groups include organic radicals having the formula: 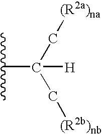
wherein na and nb are independently selected from 1, 2, and 3, and each R^{2a} or R^{2b} substituent residue is independently selected from hydrogen, a halogen, a hydroxy, or a carbon-containing residue optionally having from zero to five heteroatoms independently selected from oxygen, nitrogen, sulfur, and a halogen. In some such embodiments, the R^{2a} or R^{2b} are independent substituent groups, but in other embodiments one or more of the R^{2a} or R^{2b} radicals can be bonded together to form ring structures.

In some such embodiments of the compounds of Formula (I), at least one of the R² and R³ is a branched alkyl radical having 5 to 12 carbon atoms, or at least one of R² and R³ is a cycloalkyl or cycloalkenyl ring comprising 5 to 12 ring carbon atoms. In such embodiments of R² and R³ the branched alkyl radical or the cycloalkyl or cycloalkenyl ring can be optionally substituted with 1, 2, 3, or 4 substituent groups independently selected from hydroxy, fluoro, chloro, NH₂, NHCH₃, N(CH₃)₂, CO₂CH₃, SEt, SCH₃, methyl, ethyl, isopropyl, vinyl, trifluoromethyl, methoxy, ethoxy, isopropoxy, and trifluoromethoxy.

In other embodiments of the tastant compounds of Formula (I), at least one of the R² and R³ is a “benzylic” radical having the structure 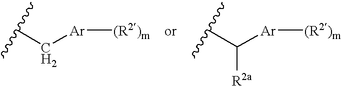
wherein Ar is an aromatic or heteraromatic ring such as phenyl, pyridyl, furanyl, thiofuranyl, pyrrolyl, or similar aromatic ring systems, m is 0, 1, 2, or 3, and each R^{2′} is independently selected from hydroxy, fluoro, chloro, NH₂, NHCH₃, N(CH₃)₂, CO₂CH₃, SEt, SCH₃, methyl, ethyl, isopropyl, vinyl, trifluoromethyl, methoxy, ethoxy, isopropoxy, and trifluoromethoxy, and each R^{2a} substituent group can be independently selected from the group consisting of an alkyl, alkoxy-alkyl, alkenyl, cycloalkenyl, cycloalkyl, —R⁴OH, —R⁴OR⁵, —R⁴CN, —R⁴CO₂H, —R⁴CO₂R⁵, —R⁴COR⁵, —R⁴SR⁵, and —R⁴SO₂R⁵ group.

In many embodiments of the compounds of Formula (I), at least one of R² or R³ is a C₃-C₁₀ branched alkyl. In many such embodiments, the other of R² or R³ is hydrogen. These C₃-C₁₀ branched alkyls have been found to be highly effective R² groups for both savory and sweet tastant compounds. In some embodiments, R³ is a C₄-C₈ branched alkyl. Examples of such branched alkyls include the following structures:

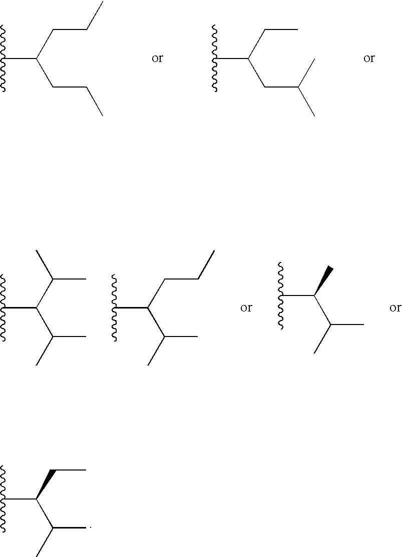

In further embodiments the branched alkyls may optionally contain, inserted into what would have been an alkyl chain, one or two heteroatoms such as nitrogen, oxygen, or sulfur atoms to form amines, ethers, and/or thioethers, sulfoxides, or sulfones respectively, or one or two heteroatomic substituents bonded to the alkyl chains independently selected from a hydroxy, fluoro, chloro, NH₂, NHCH₃, N(CH₃)₂, CO₂CH₃, SCH₃, SEt, CN, trifluoromethyl, methoxy, ethoxy, isopropoxy, and trifluoromethoxy groups.

In further embodiments of the compounds of Formula (I), at least one of R² or R³ is an α-substituted carboxylic acid or α-substituted carboxylic acid lower alkyl ester. Preferably, at least one of R² or R³ is an α-substituted carboxylic acid lower alkyl (especially methyl) ester. In some such preferred embodiments, the α-substituted carboxylic acid or α-substituted carboxylic acid ester residue corresponds to that of a naturally occurring and optically active α-amino acid or an ester thereof, or its opposite enantiomer.

In many embodiments of the compounds of Formula (I), at least one of R² or R³ is a 5 or 6 membered aryl or heteroaryl ring, optionally substituted with 1, 2, 3 or 4 substituent groups independently selected from the group consisting of hydroxyl, NH₂, SH, halogen, or a C₁-C₄ organic radical. In related embodiments, the subtitutents for the aryl or heteroaryl ring are selected from alkyl, alkoxyl, alkoxy-alkyl, OH, CN, CO₂H, CHO, COR⁶, CO₂R⁶′SR⁶, S(O)R⁶, S(O)₂R⁶ halogen, alkenyl, cycloalkyl, cycloalkenyl, aryl, and heteroaryl: and R⁶ is C₁-C₆ alkyl. Preferably the aryl or heteroaryl ring is substituted with 1, 2, 3 or 4 substituent groups selected from the group consisting of hydroxy, fluoro, chloro, NH₂, NHCH₃, N(CH₃)₂, CO₂CH₃, SCH₃, S(O)CH₃, S(O)₂CH₃, SEt, methyl, ethyl, isopropyl, vinyl, trifluoromethyl, methoxy, ethoxy, isopropoxy, and trifluoromethoxy groups.

In some embodiments of the compounds of Formula (I), at least one of R² or R³ is a phenyl, pyridyl, furanyl, thiofuranyl, or pyrrolyl ring optionally substituted with one or two substituents independently selected from hydroxy, fluoro, chloro, NH₂, NHCH₃, N(CH₃)₂, CO₂CH₃, SCH₃, S(O)CH₃, S(O)₂CH₃, SEt, methyl, ethyl, isopropyl, vinyl, trifluoromethyl, methoxy, ethoxy, isopropoxy, and trifluoromethoxy.

In many embodiments of the compounds of Formula (I), at least one of R or R is a cycloalkyl, cycloalkenyl, or saturated heterocyclic ring having 3 to 10 ring carbon atoms, optionally substituted with 1, 2, or 3 substituents independently selected from the group consisting of NH₂, NHCH₃, N(CH₃)₂, CO₂CH₃, SEt, SCH₃, S(O)CH₃, S(O)₂CH₃, C₁-C₄ alkyl, C₁-C₄ haloalkyl, C₁-C₄ alkoxy, C₁-C₄ haloalkoxy, hydroxy, and halogen. In some further embodiments, at least one of R² or R³ is a cyclopentyl, cyclohexyl, cycloheptyl, cyclooctyl ring, or piperidyl ring optionally substituted with 1, 2, or 3 substituents independently selected from the group consisting of hydroxy, fluoro, chloro, NH₂, NHCH₃, N(CH₃)₂, CO₂CH₃, SEt, SCH₃, methyl, ethyl, isopropyl, vinyl, trifluoromethyl, methoxy, ethoxy, isopropoxy, and trifluoromethoxy.

In some preferred embodiments, at least one of R² or R³ is a cyclohexyl ring, optionally substituted with 1, 2, or 3 substitutent groups selected from NH₂, NHCH₃, N(CH₃)₂, CO₂CH₃, SEt, SCH₃, C₁-C₄ alkyl, C₁-C₄ haloalkyl, C₁-C₄ alkoxy, C₁-C₄ haloalkoxy, hydroxy, and halogen groups, and the other of R² or R³ is hydrogen. For example, in some such embodiments, R³ is hydrogen and R² can have one of the following structures: 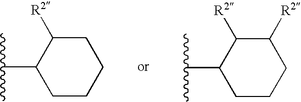
wherein R^{2′} and R^{2″} are independently selected from hydroxy, fluoro, chloro, bromo, NH₂, NHCH₃, N(CH₃)₂, COOCH₃, SCH₃, S(O)CH₃, S(O)₂CH₃, SEt, methyl, ethyl, isopropyl, vinyl, trifluoromethyl, methoxy, ethoxy, isopropoxy, and trifluoromethoxy groups, or preferably methyl groups. Examples of such methyl substituted cyclohexyl rings include the formula:

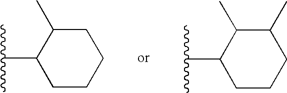

In many embodiments of the compounds of Formula (I), especially compounds having enhancer activity for other sweeteners, or enhancer activity for savory compounds such as MSG, R³ is hydrogen and R² is a cyclopentyl or cyclohexyl ring having a phenyl ring fused thereto, i.e. a 1-(1,2,3,4)tetrahydronapthalene ring radical or an 2,3-dihydro-1H-indene ring radical having the structures: 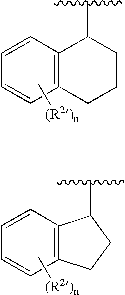
wherein n is 0, 1, 2, or 3, and each R^{2′} can be bonded to either the aromatic or non-aromatic ring. In other embodiments, each R^{2′} is bonded to the aromatic ring as is shown below:

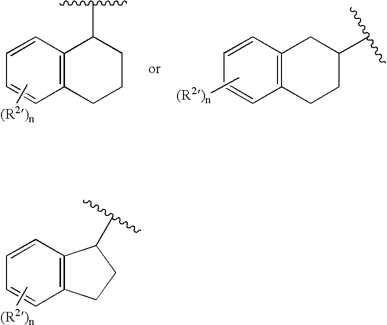

In the tetrahydronapthalenyl and indanyl embodiments shown above, each R^{2′} can be independently selected from the group consisting of hydroxyl, NH₂, SH, halogen, or a C₁-C₄ organic radical. In alternative but related embodiments, each R^{2′} can be independently selected from the group consisting of hydroxyl, NH₂, SH, halogen, C₁-C₄ alkyl, C₁-C₄ haloalkyl, C₁-C₄ haloalkoxy, C₁-C₄ alkoxyl, C₁-C₄ alkoxy-alkyl, C₁-C₄ hydroxy-alkyl, OH, NH₂, NHR⁶), NR⁶₂, CN, CO₂H, CO₂R⁶, CHO, COR⁶, SH, SR⁶, S(O)R⁶, S(O)₂R⁶, and halogen, wherein R⁶ is C₁-C₄ alkyl. In some preferred embodiments, each R^{2′} can be independently selected from the group consisting of hydroxy, fluoro, chloro, NH₂, NHCH₃, N(CH₃)₂, CO₂CH₃, SCH₃, S(O)CH₃, S(O)₂CH₃, SEt, methyl, ethyl, isopropyl, vinyl, trifluoromethyl, methoxy, ethoxy, isopropoxy, and trifluoromethoxy.

In some embodiments at least one of R² or R³ is a 1-(1,2,3,4)tetrahydronapthalene ring with certain preferred substitution patterns. In particular, in some embodiments of the compounds of formula (I) at least one of R² or R³ is a cyclohexyl ring having one of the formulas: 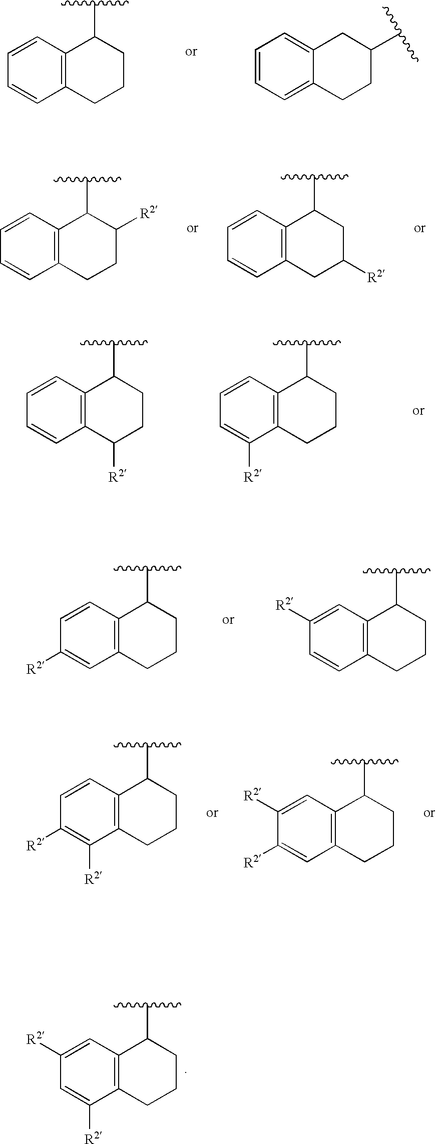
wherein each R^{2′} can be independently selected from the groups described above. Similarly, in some preferred embodiments, at least one of R² or R³ may include one of the structures:

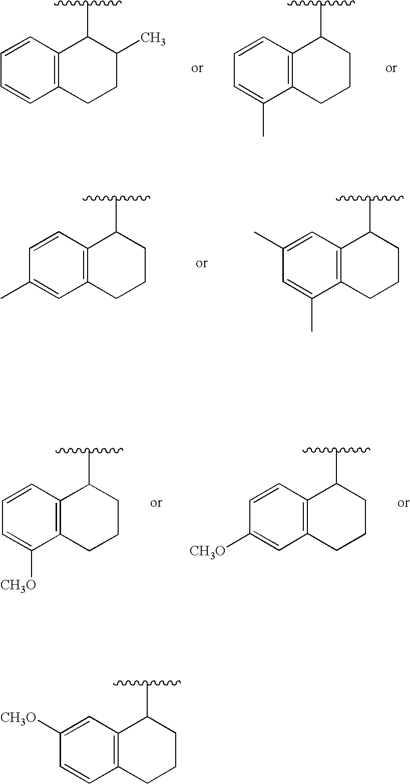

In some embodiments at least one of R² or R³ is an unsubstituted 1-(1,2,3,4) tetrahydronapthalene ring in racemic or optically active form, as shown below:

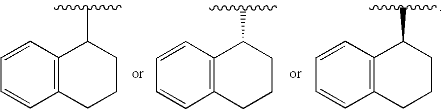

Similarly in the indanyl series R² can have the structures:

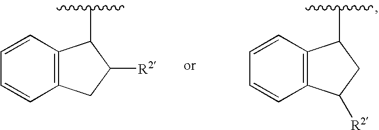

or the R^{2′} substituents can bound to the aromatic ring as show below:

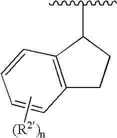

or in more specific embodiments, R² can have one of the exemplary structures show below:

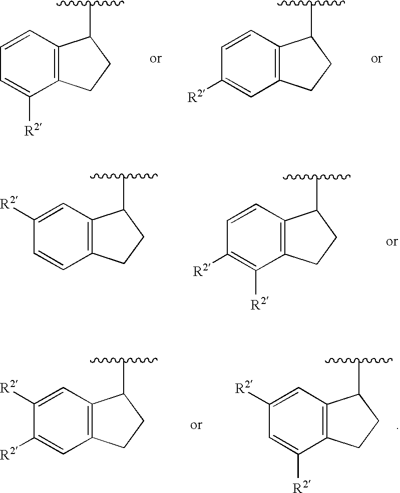

In some embodiments of the tastant compounds of the invention, the tetrahydronapthalene and indane ring systems of the R² groups described above can be modified to comprise one or more heteroatoms or heteroatomic groups into the bicyclic ring systems, to form new heterocyclic and bicyclic analogs of the tetrahydronapthalene and indane ring systems, so as to form new R² groups. For example, it is possible to substitute a nitrogen atom for one of the aromatic rings of a tetrahydronapthalenyl group to form new tetrahydroquinolinyl or tetrahydroisoquinolinyl radicals having the structures shown below: 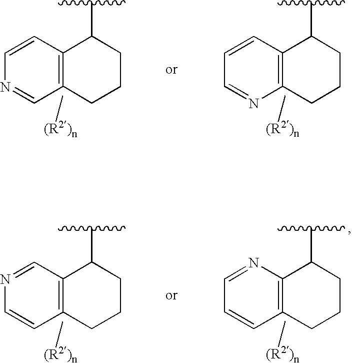
wherein the R^{2′} groups can be bonded to either the aromatic or non-aromatic rings, and can be defined in any of the ways described above in connection with the tetrahydronapthalenyl groups. It will be apparent to those of ordinary skill in the art that at least one additional nitrogen atom could be similarly inserted to form additional and isomeric heteroaryl groups, such as the following exemplary R² groups:

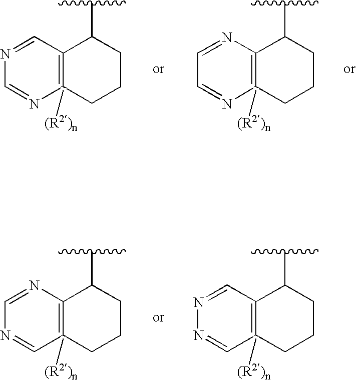

The indanyl R² groups described above can be similarly modified with one or more nitrogen atoms to form additional bicyclic heteroaryl R²groups, such as for example the following structures:

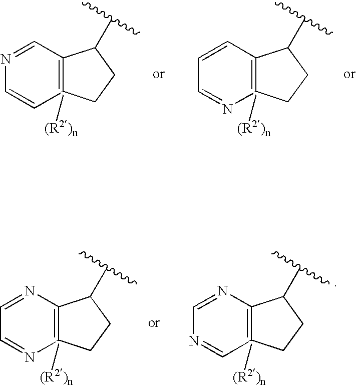

Additionally, one or more heteroatoms or heteratomic groups can be inserted into the cyclopentyl or cyclohexyl groups of the tetrahydronapthalenyl or indanyl groups described above to form additional fused bicyclic heteroaryls, which include but are not limited to the exemplary structures listed below: 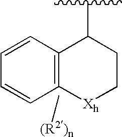
wherein n is 0, 1, 2, or 3, each R^{2′} can be defined in any of the ways described above, and Xₕ is O, S, SO, SO₂, NH, or NRₕ, wherein Rₕ is a C₁-C₄ organic radical. Examples of such R² groups are listed below:

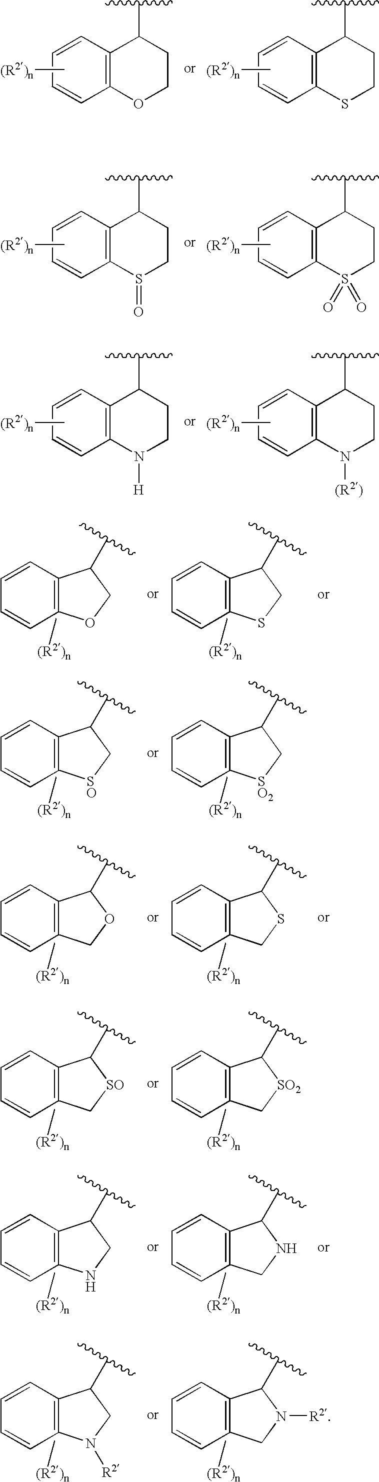

It will also be understood by those of ordinary skill in the art that optical and/or diastereomeric isomerism can occur on the unsaturated five and six membered rings of the R² groups described above, and in many other of the R¹, R², and R³ groups disclosed herein, and that the differing optical isomers (enantiomers) and/or diastereomers can have differing biological activities with respect to the relevant sweet and savory taste receptors. Prediction of which diasteromer or enantiomer of a particular R² group is most likely to be biologically effective can be difficult, and the finding that one particular isomer is more effective for one ring system may not necessarily mean that an analogous isomer of a differently substituted group will be similarly effective.

Applicants have nevertheless found that in many embodiments, the compounds of Formula (I) are particularly effective as sweet enhancers when R² comprises a substituted or unsubstituted tetrahydronapthalenyl, indanyl, tetrahydroquinolinyl, tetrahydronapthalenyl, or the related heterocyclic analogs disclosed above when they comprise an enantiomeric excess of the absolute optical configurations illustrated in the drawings below:

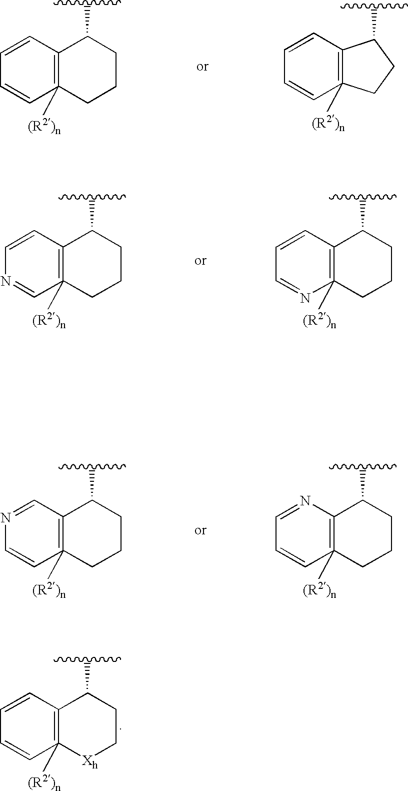

One of ordinary skill is aware that the designation of a particular compound as either “R” or “S” under the Cahn-Ingold-Prelog system of nomenclature for optically active compounds can depend upon the exact nature and number of the substituent groups, but the compounds of Formula (I) having the bicyclic R² ligands and the absolute optical configurations shown in the drawings immediately above are typically “R” at the optically active carbon shown above, and those compounds usually give superior binding to T1R2/T1R3 sweet receptors. It should be noted however that the opposite “S” isomers do typically have some, although typically lower, activity for binding T1R2/T1R3 sweet receptors and/or as sweet enhancer compounds.

Applicants have also found that the T1R1/T1R3 savory receptors often show a notable tendency to more strongly bind compounds of Formula (I) that have the R² groups shown above the opposite “S” configurations, namely:

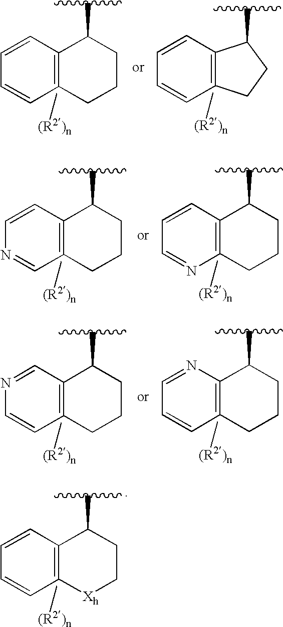

Again, though the T1R1/T1R3 savory receptors often show a significant preference for the “S” isomers of compounds comprising the R² groups shown above, the “R” isomers can retain significant although diminished biological activity as savory tastants or savory enhancer compounds for MSG.

When the specification, claims, and/or drawings of this document indicate that a compound is present in optically active form, as is implied by the discussion and drawings immediately above, it is to be understood that the indicated compounds of Formula (I) are present in at least a small enantiomeric excess (i.e., more than about 50% of the molecules have the indicated optical configuration). Further embodiments preferably comprise an enantiomeric excess of the indicated isomer of at least 75%, or 90%, or 95%, or 98%, or 99%, or 99.5%. Depending on the difference in the biological activities, the cost of production, and/or any differences in toxicity between the two enantiomers, for a given compound it may be advantageous to produce and sell for human consumption a racemic mixture of the enantiomers, or a small or large enantiomeric excess one of the enantiomers of a given compound.

In other embodiments of the tastant compounds of Formula (I), one of R² and R¹ is hydrogen, and the other of R² and R³ is an alkylene substituted phenyl, pyridinyl, or bipyridinyl radical having the structure: 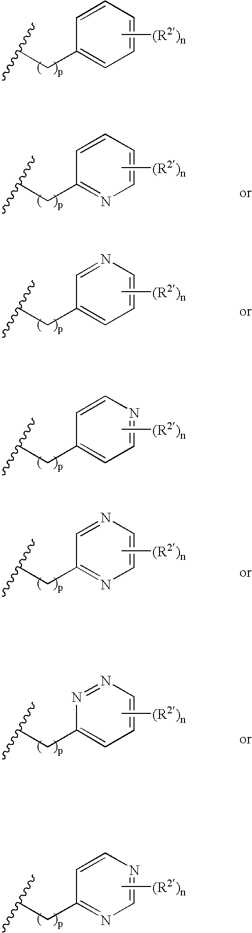
wherein p is, 1 or 2; and n is 0, 1, or 2, and R^{2′} can be any of the substitutent groups defined above.

In other embodiments of the tastant compounds of Formula (I), in some embodiments of the compounds of Formula (I), the R² and R³ groups are not hydrogen and are joined together to make an optionally substituted heterocyclic anine ring. Examples of thioamide compounds of subgenus (Ia) are shown below, though analogous compounds of genuses (Ib), (If), and (Ij) are also within the scope of the present inventions: 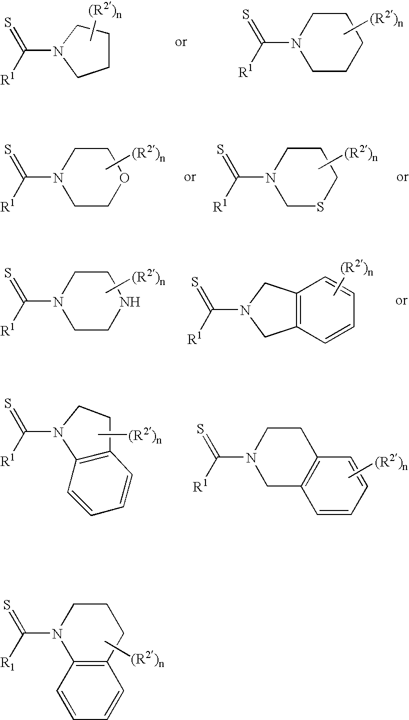
wherein n is 0, 1, or 2, and R^{2′} can be any of the substitutent groups defined above. As will be further described below, thioureas and guanidino compounds are additional subgenera of the tastant compounds of Formula (I) that can have such cyclic embodiments of the R²/R³ groups, and such compounds are useful as sweet enhancer compounds and/or tastants.
   Tastant Compounds Comprising Aryl or Heteroaryl R¹ Groups

In many preferred subgenera of the tastant compounds of Formula (I) having one or both of savory and sweet receptor agonist activity, in a preferred subgenus of the tastant compounds R¹ is an optionally substituted aryl or heteroaryl group. More specifically, some subgenera of the tastant compounds of Formula (I) have one of the following Formulas (IIa-k): 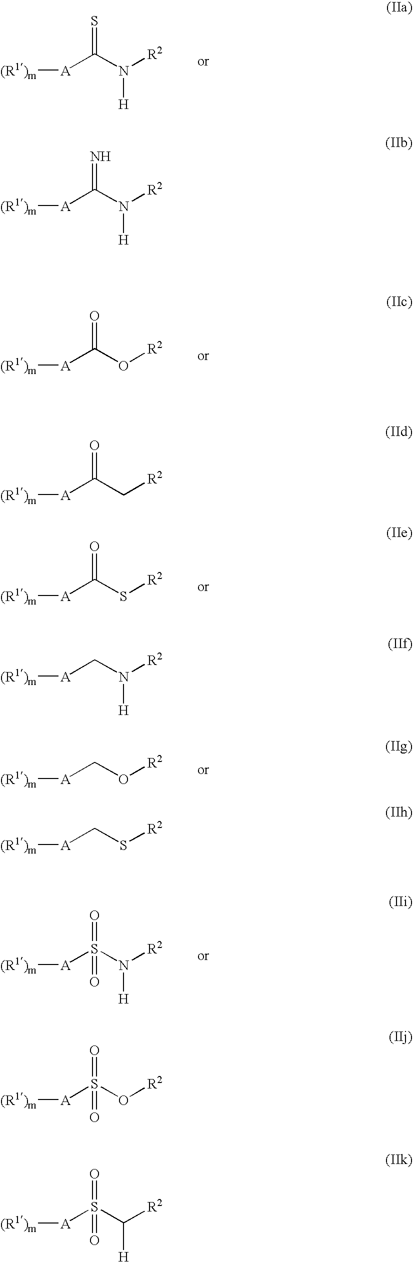
wherein A is a 5 or 6 membered aryl or heteroaryl ring, m is 0, 1, 2, 3 or 4, and R² can be any of the R² groups described hereinabove in connection with the compounds of Formula (I).

In such compounds of Formulas (IIa-k), each R^{1′} can be independently selected from the group consisting of hydroxyl, NH₂, SH, halogen, and a C₁-C₈ or C₁-C₄ organic radical. In related embodiments, each R^{1′} can be independently selected from the group consisting of alkyl, alkoxy, alkoxy-alkyl, hydroxyalkyl, OH, CN, CO₂H, CO₂R⁶, CHO, COR⁶, SR⁶, S(O)R⁶, S(O)₂R⁶, halogen, alkenyl, cycloalkyl, cycloalkenyl, heterocycle, aryl, and heteroaryl; and R⁶ is C₁-C₄ alkyl. In some related but alternative embodiments of the compounds of Formulas (I) and/or (II), each R^{1′} and/or each R^{2′} can be independently selected from the group consisting of hydroxyl, NH₂, SH, halogen, C₁-C₄ alkyl, C₁-C₄ haloalkyl, C₁-C₄ haloalkoxy, C₁-C₄ alkoxyl, C₁-C₄ alkoxy-alkyl, C₁-C₄ hydroxy-alkyl, OH, NH₂, NHR⁶, NR⁶₂, CN, CO₂H, CO₂R⁶, CHO, COR⁶, SH, SR⁶, S(O)R⁶, S(O)₂R⁶, and halogen, wherein R⁶ is C₁-C₄ alkyl. In many preferred embodiments of the compounds of Formulas (I) and/or (II), each R^{1′} is independently selected from the group consisting of hydroxy, fluoro, chloro, NH₂, NHCH₃, N(CH₃)₂, COOCH₃, SCH₃, S(O)CH₃, S(O)₂CH₃, SEt, methyl, ethyl, isopropyl, n-propyl, n-butyl, 1-methyl-propyl, isobutyl, t-butyl, vinyl, trifluoromethyl, methoxy, ethoxy, isopropoxy, and trifluoromethoxy groups. In such compounds of Formula (IIa-k), R² can be any of the structures contemplated above, or the like.

In some embodiments, the A group of Formula (II) is an aryl ring, i.e. it contains somewhere within it's structure at least one six-membered aromatic phenyl ring. The aryls include at least benzene and napthalene rings, which may not, but in many embodiments are, further sustituted with at least 1, 2, or 3 R^{1′} subtituent groups, which can be defined by any of the alternatives recited above.

In many embodiments of the compounds of Formula (II), the A group is a phenyl ring that is directly bonded to the linker group. Two examples of such benzothioamide and benzosulfonamide compounds that are subgenera of the compounds of Formulas (IIa) and (IIi) are shown below:

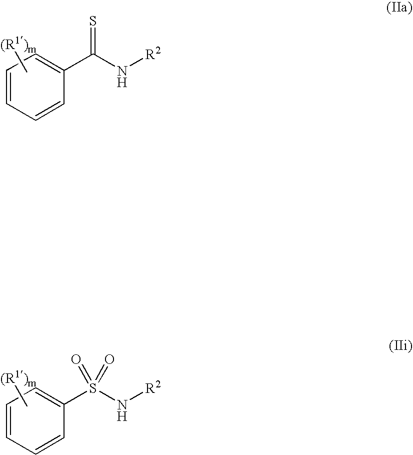

In the compounds of Formula (IIa) and analogous “phenyl” compounds (IIb-k), R² can be any of the structures disclosed above. Such compounds having branched alkyl R² groups can often be effective savory tastants and/or savory enhancers. Similar compounds having any of the optionally substituted tetrahydronapthalene, indanyl, or structually related hetercyclic R² groups disclosed above can be highly effective sweet enhancer compounds.

In some preferred embodiments of the compounds (Iia-k) wherein A is a phenyl ring, one or two of the R^{1′} substituent groups can be bonded together to form a saturated alkylenedioxy ring on an phenyl ring, as exemplified by the following preferred benzothioamide and benzosulfonamide subgenera: 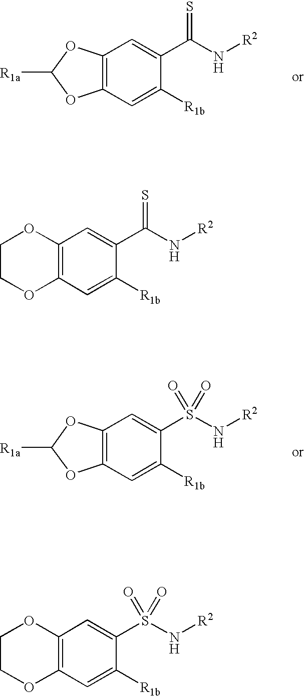
wherein R₁ₐ and R_{1b} are independently hydrogen or a lower alkyl, or alternatively R₁ₐ and R_{1b} are independently hydrogen or methyl, or alternatively both R₁ₐ and R_{1b} are hydrogen.

In many embodiments of the tastant compounds of Formula (II), A is heteroaryl ring, that can be a monocyclic or fused bicyclic heteroaryl ring. The fused bicyclic heteraryls are exemplified by the following benzofurans and benzothiofurans: 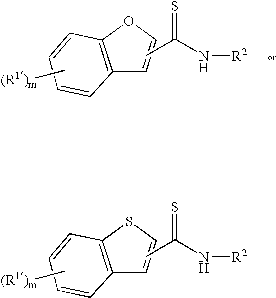
wherein m is 0, 1, 2, or 3 and each R^{1′} can be bonded to either the phenyl or heteroaryl rings and each R^{1′} is independently selected from, hydroxy, fluoro, chloro, NH₂, NHCH₃, N(CH₃)₂, CO₂CH₃, SCH₃, S(O)CH₃, S(O)₂CH₃, SEt, methyl, ethyl, isopropyl, vinyl, trifluoromethyl, methoxy, ethoxy, isopropoxy, and trifluoromethoxy.

Additional examples of fused bicyclic heteroaryls as A groups are typified by the following benzoxazole compounds:

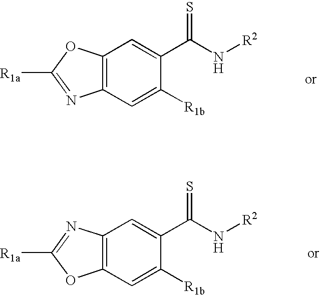

wherein R₁ₐ or R_{1b} is independently hydrogen or a lower alkyl.

In many embodiments of the tastant compounds of Formula (Iia-k), A is a monocyclic heteroaryl ring. The monocyclic heteroaryl tastant compounds that can be used as an A group in Formulas (Iia-k) are typified by the following structures: 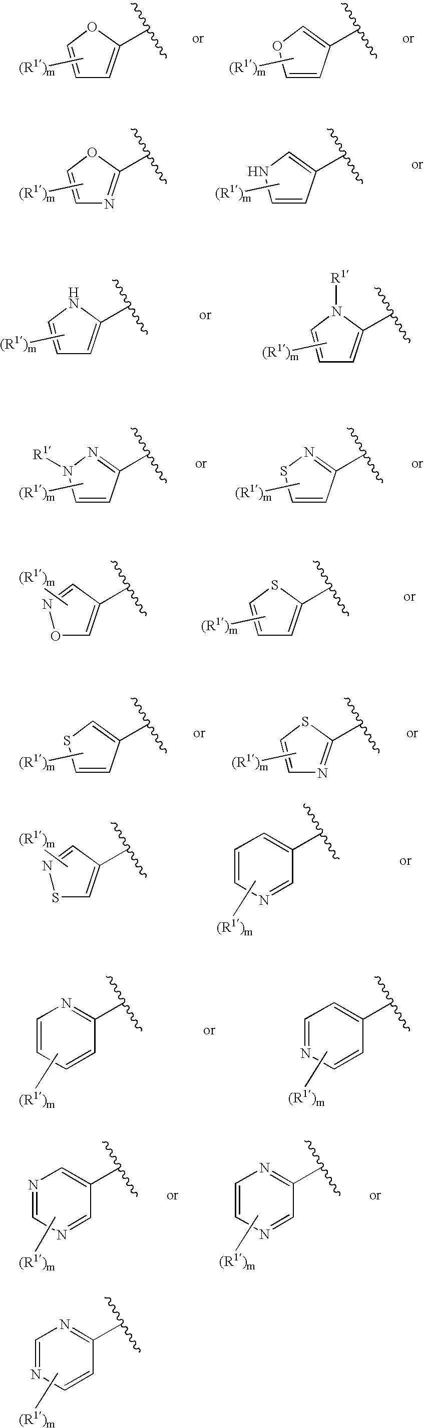
wherein m is 0, 1, 2, or 3. In such compounds of Formula (IIa-k) wherein the A group is a monocyclic heteroaryl, each R^{1′} can be independently selected from the group consisting of hydroxyl, NH₂, SH, halogen, and a C₁-C₈ or C₁-C₄ organic radical. In some related but alternative embodiments of the compounds of Formula (IIa-k), each R^{1′} can be independently selected from the group consisting of hydroxyl, NH₂, SH, halogen, C₁-C₄ alkyl, C₁-C₄ haloalkyl, C₁-C₄ haloalkoxy, C₁-C₄ alkoxyl, C₁-C₄ alkoxy-alkyl, C₁-C₄ hydroxy-alkyl, OH, NR⁶₂, CN, CO₂H, CO₂R⁶, CHO, COR⁶, SH, SR⁶, S(O)R⁶, S(O)₂R⁶, and halogen, wherein R⁶ is C₁-C₄ alkyl. In many preferred embodiments each R^{1′} is independently selected from the group consisting of hydroxy, fluoro, chloro, NH₂, NHCH₃, N(CH₃)₂, COOCH₃, SCH₃, S(O)CH₃, S(O)₂CH₃, SEt, methyl, ethyl, isopropyl, n-propyl, n-butyl, 1-methyl-propyl, isobutyl, t-butyl, vinyl, trifluoromethyl, methoxy, ethoxy, isopropoxy, and trifluoromethoxy groups. In such compounds of Formula (II), R² can be any of the structures contemplated above, or the like.

In some preferred embodiments of the monocyclic heteroaryl tastant compounds, A is a substituted furanyl, thiofuranyl, pyrrolyl, or oxazole ring, so as to form compounds having the structures shown below: 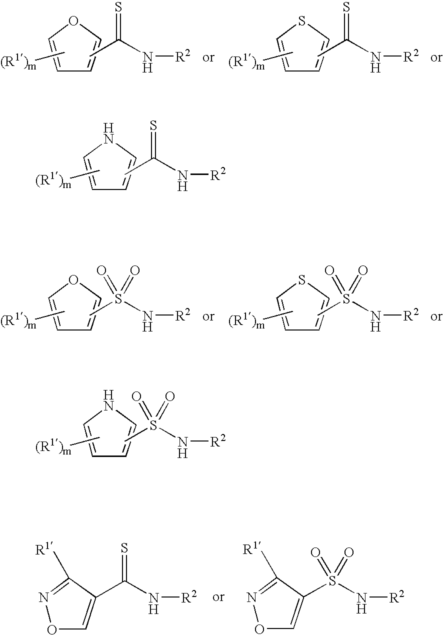
wherein m is 0, 1, 2, or 3. In some such furanyl, thiofuranyl, pyrrolyl, and isooxazole embodiments, m is 1 or 2 and each R^{1′} can be independently selected from the group consisting of hydroxyl, NH₂, SH, halogen, and a C₁-C₈ or C₁-C₄ organic radical, or alternatively independently selected from hydroxy, fluoro, chloro, NH₂, NHCH₃, N(CH₃)₂, COOCH₃, SCH₃, S(O)CH₃, S(O)₂CH₃, SEt, methyl, ethyl, isopropyl, n-propyl, n-butyl, 1-methyl-propyl, isobutyl, t-butyl, vinyl, trifluoromethyl, methoxy, ethoxy, isopropoxy, and trifluoromethoxy groups.

In many embodiments of the compounds of the various subgenera of Formula (II) described immediately above, at least one of R² or R³ can be a C₃-C₁₀ branched alkyl; an α-substituted carboxylic acid or an α-substituted carboxylic acid lower alkyl ester; a 5 or 6 membered aryl or heteroaryl ring, optionally substituted with 1, 2, 3 or 4 substituent groups selected from the group consisting of hydroxy, fluoro, chloro, NH₂, NHCH₃, N(CH₃)₂, CO₂CH₃, SCH₃, S(O)CH₃, S(O)₂CH₃, SEt, methyl, ethyl, isopropyl, vinyl, trifluoromethyl, methoxy, ethoxy, isopropoxy, and trifluoromethoxy groups; a cyclohexyl, optionally substituted with 1, 2, or 3 methyl groups.

The isoxazole compounds of Formula (IIa-k) can be unexpectedly superior as sweet enhancer compounds when R^{1′} is a C₁-C₈ organic radical, such as for example C₁-C₈ alkyl (normal or branched), C₁-C₈ alkoxyl, C₁-C₈ alkoxy-alkyl, C₁-C₈ hydroxy-alkyl, C₁-C₈ amino-alkyl, or a C₁-C₈ optionally substituted aryl or heteroaryl having a five or six membered aromatic ring. In yet additional embodiments, the R^{1′} group of the isoxazole ring is hydroxy, fluoro, chloro, NH₂, NHCH₃, N(CH₃)₂, COOCH₃, SCH₃, S(O)CH₃, S(O)₂CH₃, SEt, methyl, ethyl, isopropyl, n-propyl, n-butyl, 1-methyl-propyl, isobutyl, t-butyl, vinyl, trifluoromethyl, methoxy, ethoxy, isopropoxy, trifluoromethoxy, CH₂OCH₃, CH₂OH, CH₂NH₂, CH₂NHCH₃, or CH₂N(CH₃)₂ group.

In some preferred embodiments, the phenyl, furanyl, thiofuranyl, pyrrolyl, and isoxazole compounds of Formula (IIa), and analogous structures (IIb-k) have an R² group which is a 1-(1,2,3,4)tetrahydronapthalene ring, an 2,3-dihydro-1H-indene ring or one of their heterocyclic analog compounds having one of the formulas shown below: 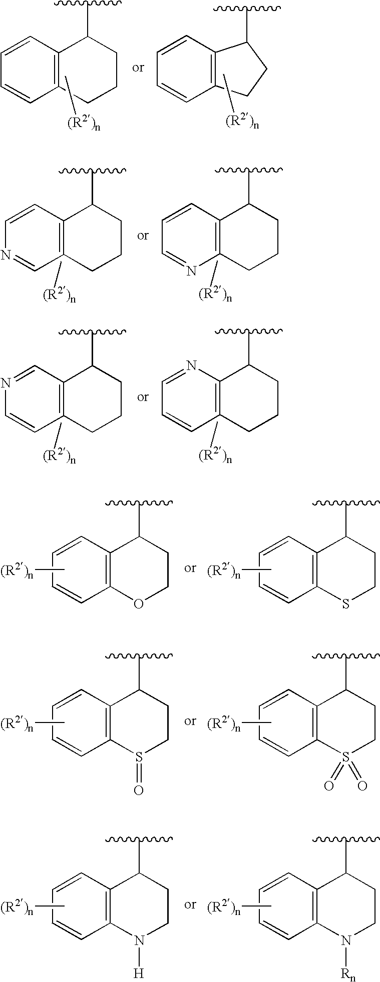
wherein n is 0, 1, 2, or 3, preferably 1 or 2, and each R^{2′} can be bonded to either the aromatic or non-aromatic ring and is independently selected from hydroxy, fluoro, chloro, NH₂, NHCH₃, N(CH₃)₂, CO₂CH₃, SCH₃, S(O)CH₃, S(O)₂CH₃, SEt, methyl, ethyl, isopropyl, vinyl, trifluoromethyl, methoxy, ethoxy, isopropoxy, and trifluoromethoxy; as were described hereinabove with respect to the general tastant compounds of Formula (I). In their applications as sweet enhancers, it is typically preferable that compounds of Formula (IIa-k) that comprise the bicyclic R² groups illustrated above comprise at least an enantiomeric excess of the “R” optical configuration as is illustrated below:

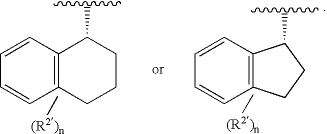

In contrast, when compounds having Formulas (IIa-i) with bicyclic R² groups such as those above are employed as “Umami” tastants or as agents for enhancing Umami flavor of MSG, it has been found that the use of bicyclic indanyl or tetrahydronapthyl R groups comprising the opposite “S” configuration, as exemplified below, can be advantageous:

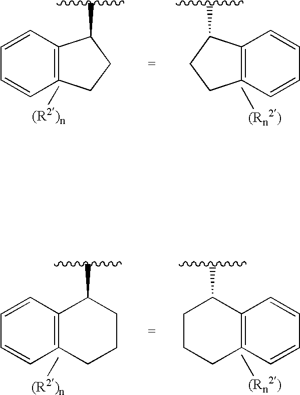

The subgenera of aromatic or heteroaromatic tastant compounds of Formula (II) described immediately above contain many excellent agonists of T1R1/T1R3 savory (“umami”) taste receptors, and/or T1R2/T1R3 sweet taste receptors, at very low concentrations of the tastant compound on the order of micromolar concentrations or less, and can induce a noticeable sensation of a savory umami flavor in humans, and/or can serve as enhancers of the savory umami flavor of MSG, or significantly enhance the effectiveness of a variety of known sweeteners, especially saccharide based sweeteners.

Accordingly, many of the aromatic or heteroaromatic tastant compounds of Formula (II) can be utilized as savory or sweet flavoring agents or savory or sweet flavor enhancers when contacted with a wide variety of comestible products and/or compositions, or their precursors, to produce taste modified comestible or medicinal compositions, as is described elsewhere herein.

Guanidine and ThioUrea Compounds

The invention also relates to additional analogs of the compounds of Formula (I), i.e. the guanidine compounds of Formula (IIIa), the isothiourea compounds of Formula (IIIb) and the thiourea compounds of Formula (IIIc) shown below: 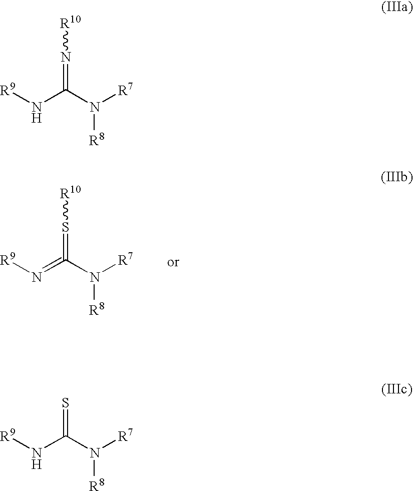
wherein at least R⁹ and R⁷ are independently selected from organic radicals comprising from three to sixteen carbon atoms, or four to 14 carbon atoms, or five to 12 carbon atoms, and can optionally contain one or more heteroatoms, or preferably 1, 2, 3, 4, or 5 heteroatoms selected from oxygen, nitrogen, sulfur, fluorine, chlorine, or bromine; and R⁸ and R¹⁰ are independently selected from hydrogen and organic radicals comprising from three to sixteen carbon atoms that can optionally contain one or more heteroatoms or preferably 1, 2, 3, 4, or 5 heteroatoms selected from oxygen, nitrogen, sulfur, fluorine, chlorine, or bromine.

Nevertheless, it is known in the prior art, as exemplified by U.S. Pat. No. 4,900,740, that certain compounds comprising a substituted guanidine residue of the structure shown below can serve as high potency sweeteners, but such compounds can be unsuitable for human consumption, and therefore such guanidine compounds may not be part of many embodiments of the current invention.

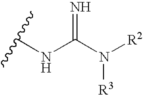

As one of ordinary skill in the art will appreciate, the compounds having Formulas (IIIa-c) are a subgenus of the tastant compounds of Formula (I) wherein R⁹ and the nitrogen atom bound thereto is functionally equivalent to the R¹ group of the compounds of Formulas (Ia) and (Ib), and wherein the R⁷ and R⁸ groups are functionally equivalent to the R² and/or R³ groups of the compounds of Formulas (Ia) and (Ib).

The organic groups that can be employed as the R⁷, R⁸, R⁹, and R¹⁰ radicals can be any C₃-C₁₆, C₄-C₁₄, C₅-C₁₂ organic radical, as that term is defined elsewhere herein. In some embodiments, the organic radical can be independently selected from arylalkenyl, heteroarylalkenyl, arylalkyl, heteroarylalkyl, alkyl, alkoxy-alkyl, alkenyl, cycloalkyl, cycloalkenyl, aryl and heteroaryl groups, each of which may be optionally substituted with 1, 2, or 3 substituent groups independently selected from the group consisting of hydroxyl, NH₂, SH, halogen, and a C₁-C₄ organic radical. In related but alternative embodiments the substituent groups can be independently selected from hydroxyl, NH₂, SH, halogen, C₁-C₄ alkyl, C₁-C₄ haloalkyl, C₁-C₄ haloalkoxy, C₁-C₄ alkoxyl, C₁-C₄ alkoxy-alkyl, C₁-C₄ hydroxy-alkyl, OH, NH₂, NHR⁶, NR⁶₂, CN, CO₂H, CO₂R⁶, CHO, COR⁶, SH, SR⁶, S(O)R⁶, S(O)₂R⁶, and halogen, wherein R⁶ is C₁-C₄ alkyl. In yet further embodiments each substituent group is independently selected from the group consisting of hydroxy, fluoro, chloro, NH₂, NHCH₃, N(CH₃)₂, COOCH₃, SCH₃, S(O)CH₃, S(O)₂CH₃, SEt, methyl, ethyl, isopropyl, n-propyl, n-butyl, 1-methyl-propyl, isobutyl, t-butyl, vinyl, trifluoromethyl, methoxy, ethoxy, isopropoxy, and trifluoromethoxy groups.

In some embodiments of the compounds of Formulas (IIIa-c), R⁹ is a C₃-C₁₆ organic radical. Non-limiting example of such radicals include a C₃-C₁₀ normal or branched alkyl radical optionally comprising 1, 2, or 3 substituent groups independently selected from hydroxy, fluoro, chloro, NH₂, NHCH₃, N(CH₃)₂, COOCH₃, SCH₃, S(O)CH₃, S(O)₂CH₃, SEt, methyl, ethyl, isopropyl, n-propyl, n-butyl, 1-methyl-propyl, isobutyl, t-butyl, vinyl, trifluoromethyl, methoxy, ethoxy, isopropoxy, and trifluoromethoxy groups. In related embodiments, R⁹ is a C₃-C₁₀ branched alkyl radical.

In many embodiments of the of the compounds of Formulas (IIa-c), R⁹ is an aryl or heteroaryl ring which can be optionally substituted with 1, 2, or 3 substituents independently selected from, the group consisting of hydroxyl, NH₂, SH, halogen, or a C₁-C₄ organic radical. For example, in many embodiments, R⁹ comprises an aryl ring which is a phenyl ring and has the structure: 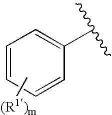
wherein m is 0, 1, 2, or 3, and each R^{1′} is independently selected from hydrogen, hydroxy, fluoro, chloro, NH₂, NHCH₃, N(CH₃)₂, COOCH₃, SCH₃, S(O)CH₃, S(O)₂CH₃, SEt, methyl, ethyl, isopropyl, n-propyl, n-butyl, 1-methyl-propyl, isobutyl, t-butyl, vinyl, trifluoromethyl, methoxy, ethoxy, isopropoxy, and trifluoromethoxy groups.

In some embodiments, the R⁹ radical has the structure: 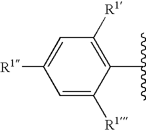
wherein R^{1′}, R^{1″} and R^{1′″} are independently selected from hydrogen, fluoro, chloro, bromo, methyl, and methoxy (provided that at least one of R^{1′}, R^{1″} and R^{1′″} is not hydrogen).

Preferably, the R⁹ radical has the formula: 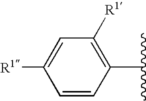
wherein R^{1′} and R^{1″} are independently selected from fluoro, chloro, bromo, methyl, and methoxy. In certain other preferred embodiments, the R⁹ radical has the formula:

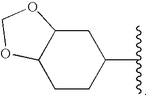

In many embodiments, R⁹ comprises a monocyclic heteroaryl ring having one the structures: 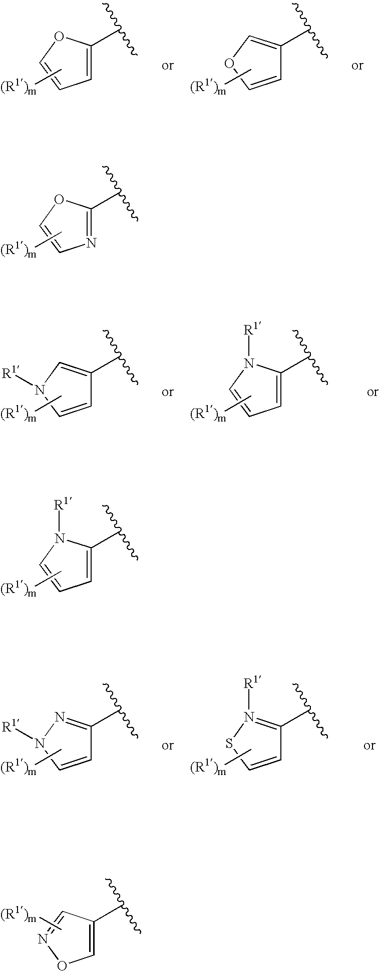 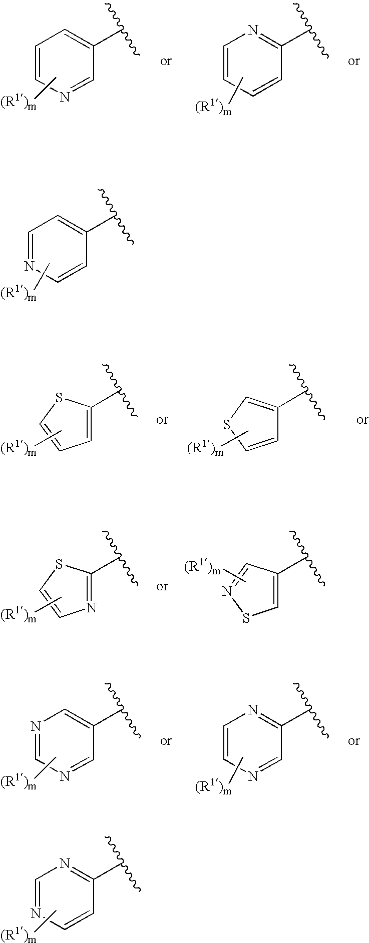
wherein m is 0, 1, 2, or 3, and each R^{1′} is independently selected from hydrogen, hydroxy, fluoro, chloro, NH₂, NHCH₃, N(CH₃)₂, COOCH₃, SCH₃, S(O)CH₃, S(O)₂CH₃, SEt, methyl, ethyl, isopropyl, n-propyl, n-butyl, 1-methyl-propyl, isobutyl, t-butyl, vinyl, trifluoromethyl, methoxy, ethoxy, isopropoxy, and trifluoromethoxy groups.

In some preferred embodiments, R⁹ comprises an isooxazole ring having the structure: 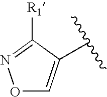
wherein R^{1′} is selected from hydrogen, hydroxy, fluoro, chloro, NH₂, NHCH₃, N(CH₃)₂, COOCH₃, SCH₃, S(O)CH₃, S(O)₂CH₃, SEt, methyl, ethyl, isopropyl, n-propyl, n-butyl, 1-methyl-propyl, isobutyl, t-butyl, vinyl, trifluoromethyl, methoxy, ethoxy, isopropoxy, and trifluoromethoxy groups.

The compounds of Formulas (IIIa-c) comprise an R⁷ radical and/or an R⁸ radical which can be a C₃-C₁₆ organic radical. In some embodiments, R⁷ is a C₃-C₁₆ organic radical and R⁸ is hydrogen. Non-limiting example of suitable R⁷ and/or R⁸ radicals include a C₃-C₁₀ normal or branched alkyl radical optionally comprising 1, 2, or 3 substituent groups independently selected from hydroxy, fluoro, chloro, NH₂, NHCH₃, N(CH₃)₂, COOCH₃, SCH₃, S(O)CH₃, S(O)₂CH₃, SEt, methyl, ethyl, isopropyl, n-propyl, n-butyl, 1-methyl-propyl, isobutyl, t-butyl, vinyl, trifluoromethyl, methoxy, ethoxy, isopropoxy, and trifluoromethoxy groups. In related embodiments, R⁷ and/or R⁸ can be a C₃-C₁₀ branched alkyl radical. In additional embodiments, R⁷ and/or R⁸ can be an α-substituted carboxylic acid or α-substituted carboxylic acid lower alkyl ester.

The R⁷ radical may also be a cycloalkyl or heterocyclic radical, such as cyclohexyl, phenyl, pyridyl, tetrahydronapthalene, or indanyl, each of which cyclic radicals can be optionally substituted with 1, 2, or 3 substituents independently selected from the group consisting of hydroxy, fluoro, chloro, NH₂, NHCH₃, N(CH₃)₂, COOCH₃, SCH₃, S(O)CH₃, S(O)₂CH₃, SEt, methyl, ethyl, isopropyl, n-propyl, n-butyl, 1-methyl-propyl, isobutyl, t-butyl, vinyl, trifluoromethyl, methoxy, ethoxy, isopropoxy, and trifluoromethoxy groups. In some embodiments, R⁷ is phenyl or a five or six membered heteroaryl radical optionally having 1, 2, or 3 substituents independently selected from the group consisting of hydroxyl, NH₂, SH, halogen, or a C₁-C₄ organic radical.

In many embodiments the R⁷ radical of the compounds of Formulas (IIIa-c) have tetrahydronapthalene, or indanyl radicals having the structures: 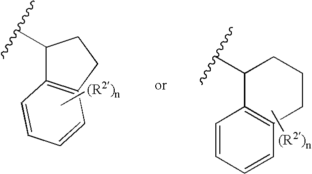
wherein n is 0, 1, 2, or 3, and each R^{2′} can be bound to either ring and independently selected from the group consisting of hydroxyl, NH₂, SH, halogen, or a C₁-C₄ organic radical, or independently selected from hydrogen, hydroxy, fluoro, chloro, NH₂, NHCH₃, N(CH₃)₂, COOCH₃, SCH₃, S(O)CH₃, S(O)₂CH₃, SEt, methyl, ethyl, isopropyl, n-propyl, n-butyl, 1-methyl-propyl, isobutyl, t-butyl, vinyl, trifluoromethyl, methoxy, ethoxy, isopropoxy, and trifluoromethoxy groups.

It is to be understood that the additional subgenera of these tetrahydronapthalenyl and indanyl radical disclosed hereinabove in connection with the compounds of Formula (I) that have more limited geometrical and/or optical isomerism can also be employed in the compounds of Formula (III).

In some embodiments, R⁷ is an alkylene substituted heteroaryl ring radical having the structure: 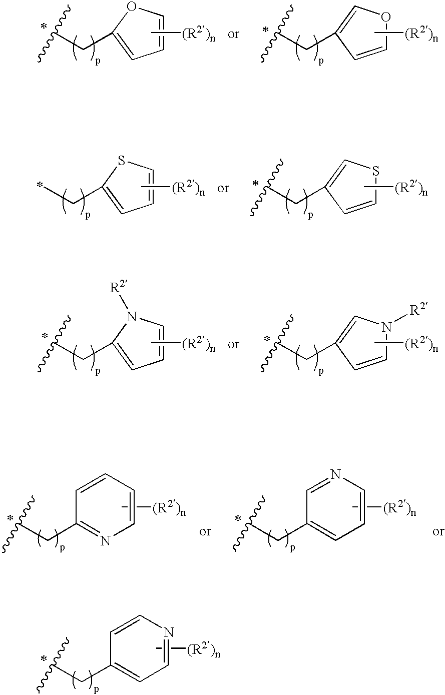
wherein p can be 1 or 2; n can be 0, 1, or 2, and each R^{2′} can be independently selected from any of the optional substituent groups described elsewhere herein, such as for example hydroxyl, NH₂, SH, SO₃H, PO(OH)₂, NO₂, halogen, and a C₁-C₈ organic radical, or alternatively hydroxyl, NH₂, SH, halogen, or a C₁-C₄ organic radicals. In some embodiments each R^{2′} is independently selected from the group consisting of hydroxy, fluoro, chloro, NH₂, NHCH₃, N(CH₃)₂, COOCH₃, SCH₃, S(O)CH₃, S(O)₂CH₃, SEt, methyl, ethyl, isopropyl, n-propyl, n-butyl, 1-methyl-propyl, isobutyl, t-butyl, vinyl, trifluoromethyl, methoxy, ethoxy, isopropoxy, and trifluoromethoxy groups.

In related embodiments, R⁷ can be an alkylene substituted heteroaryl ring radical having the structure: 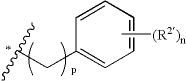
wherein p is 1 or 2; n is 0, 1, or 2, and each R²′ is independently selected from the group consisting of hydroxyl, NH₂, SH, SO₃H, PO(OH)₂, NO₂, halogen, and a C₁-C₈ organic radical.

In some embodiments of the compounds of Formula (IV), R⁷ and R⁸ together form a heterocyclic or heteroaryl ring radical having 5, 6, or 7 ring atoms that may be optionally substituted with 1, 2, or 3 substituents independently selected from hydroxy, fluoro, chloro, NH₂, NHCH₃, N(CH₃)₂, COOCH₃, SCH₃, SEt, methyl, ethyl, isopropyl, vinyl, trifluoromethyl, methoxy, ethoxy, isopropoxy, and trifluoromethoxy groups. In related embodiments, R⁷ and R⁸ together with the nitrogen atom bound thereto can form a heterocyclic ring radical having one of the structures: 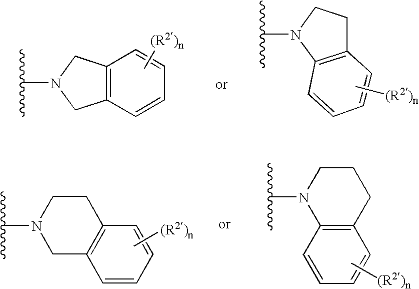
wherein n is 0, 1, 2, or 3, and each R^{2′} can be independently selected from the group consisting of hydroxyl, NH₂, SH, halogen, or a C₁-C₄ organic radical, or independently selected from hydroxy, fluoro, chloro, NH₂, NHCH₃, N(CH₃)₂, COOCH₃, SCH₃, S(O)CH₃, S(O)₂CH₃, SEt, methyl, ethyl, isopropyl, n-propyl, n-butyl, 1-methyl-propyl, isobutyl, t-butyl, vinyl, trifluoromethyl, methoxy, ethoxy, isopropoxy, and trifluoromethoxy groups.

In additional related embodiments of the compounds of Formula (IIIa-c), R⁷ and R⁸ and the nitrogen atom bound thereto together form a dihydroindole radical having the structure: 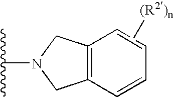
wherein R^{2′} is independently selected from hydroxy, fluoro, chloro, NH₂, NHCH₃, N(CH₃)₂, COOCH₃, SCH₃, S(O)CH₃, S(O)₂CH₃, SEt, methyl, ethyl, isopropyl, n-propyl, n-butyl, 1-methyl-propyl, isobutyl, t-butyl, vinyl, trifluoromethyl, methoxy, ethoxy, isopropoxy, and trifluoromethoxy groups. In additional embodiments, R⁷, and R⁸ and the nitrogen atom bound thereto together form one of the structures: 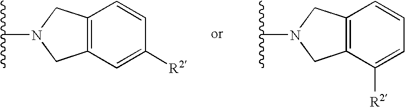
wherein R^{2′} is independently selected from hydroxy, fluoro, chloro, NH₂, NHCH₃, N(CH₃)₂, COOCH₃, SCH₃, S(O)CH₃, S(O)₂CH₃, SEt, methyl, ethyl, isopropyl, n-propyl, n-butyl, 1-methyl-propyl, isobutyl, t-butyl, vinyl, trifluoromethyl, methoxy, ethoxy, isopropoxy, and trifluoromethoxy groups.

In many embodiments of the compounds of Formulas (IIIa-c), R⁹ is an optionally substituted aryl or heteroaryl radical, and R⁷ and R⁸ form one of the heterocyclic ring radicals shown immediately above. Examples of such compounds have the thiourea or guanidino structures shown below:

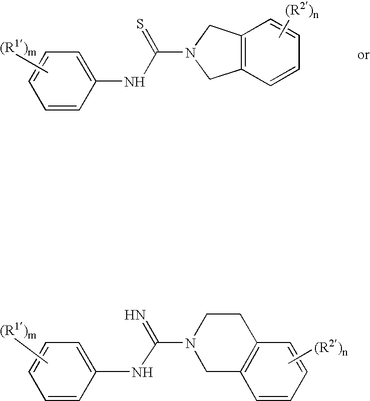

Certain embodiments of the thiourea and/or guanidine compounds of Formula (IIIa-c) shown above are particularly effective as enhancers of the sweet taste of known sweeteners if m is 1, 2, or 3, and one or two small R^{2′} substituents for the dihydroindole ring are arrayed in certain favored geometries. Accordingly, in some preferred embodiments, the urea compounds of Formula (IVa) have the structures shown below: 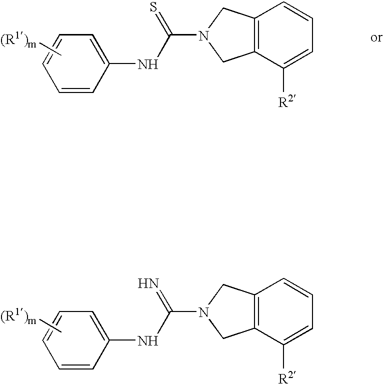
wherein m is 1, 2, or 3, and each R^{1′} and R^{2′} can be independently selected from fluoro, chloro, bromo, NH₂, NHCH₃, N(CH₃)₂, SEt, SCH₃, methyl, ethyl, trifluoromethyl, methoxy, ethoxy, isopropoxy, and trifluoromethoxy, or two R^{1′} groups together form a methylenedioxy ring. In preferred embodiments of these compounds, R^{2′} is methyl or methoxy.
   Comestibly or Pharmaceutically Acceptable Compounds

Many of the tastant compounds of Formula (I) or its various subgenera or species comprise acidic or basic groups, so that depending on the acidic or basic character (“pH”) of the comestible or medicinal compositions in which they are formulated, they may be present as salts, which are preferably comestibly acceptable (i.e. designated as generally recognized as safe, or GRAS) or pharmaceutically acceptable salts (many of which have been recognized by the Federal Food and Drug Administration).

The tastant compounds of Formula (I) having acidic groups, such as carboxylic acids, will tend (at near neutral physiological pH) to be present in solution in the form of anionic carboxylates, and therefore will in preferred embodiments have an associate comestibly and/or pharmaceutically acceptable cation, many of which are known to those of ordinary skill in the art. Such comestibly and/or pharmaceutically acceptable cations include alkali metal cations (lithium, sodium, and potassium cations), alkaline earth metal cations (magnesium, calcium, and the like), or ammonium (NH₄)⁺ or organically substituted ammonium cations such as (R—NH₃)⁺ cations.

The tastant compounds of Formula (I) having basic substituent groups, such as amino or nitrogen containing heterocyclic groups, will tend (at near neutral physiological pH, or at the acidic pH common in many foods) to be present in solution in the form of cationic ammonium groups, and therefore will in preferred embodiments have an associate comestibly and/or pharmaceutically acceptable anion, many of which are known to those of ordinary skill in the art. Such comestibly and/or pharmaceutically acceptable anionic groups include the anionic form of a variety of carboxylic acids (acetates, citrates, tartrates, anionic salts of fatty acids, etc.), halides (especially fluorides or chlorides), nitrates, and the like.

The tastant compounds of Formula (I) and its various subgenera should preferably be comestibly acceptable, i.e. deemed suitable for consumption in food or drink, and should also be pharmaceutically acceptable. The typical method of demonstrating that a flavorant compound is comestibly acceptable is to have the compound tested and/or evaluated by an Expert Panel of the Flavor and Extract Manufacturers Association and declared as to be “Generally Recognized As Safe” (“GRAS”). The FEMA/GRAS evaluation process for flavorant compounds is complex but well known to those of ordinary skill in the food product preparation arts, as is discussed by Smith, in an article entitled “GRAS Flavoring Substances 21,” Food Technology, 57(5):46-59, May 2003, the entire contents of which are hereby incorporated herein by reference.

When being evaluated in the FEMA/GRAS process, a new flavorant compound is typically tested for any adverse toxic effects on laboratory rats when fed to such rats for at least about 90 days at a concentration 100-fold, or 1000-fold, or even higher concentrations than the proposed maximum allowable concentration of the compound in a particular category of food products being considered for approval. For example, such testing of the tastant compounds of the invention might involve combining the tastant compound with rat chow and feeding it to laboratory rats such as Crl:CD(SD)IGS BR rats, at a concentration of about 100 milligrams/Kilogram body weight/day for 90 days, and then sacrificing and evaluating the rats by various medical testing procedures to show that the tastant compound of Formula (I) causes no adverse toxic effects on the rats.

The Compounds of the Invention as Savory or Sweet Taste Enhancers

The tastant compounds of Formula (I) and its various compound subgenera and species, are intended to be savory or sweet taste flavorant compounds or flavor modifiers for comestible or medicinal products. As is apparent from the teachings and Examples herein, many compounds of Formula (I) are agonists of an hT1R1/hT1R3 “savory” receptor, or an hT1R2/hT1R3 sweet receptor, at least at relatively high tastant compound concentrations, and accordingly many of the tastant compounds of Formula (I) can have utility as savory or sweet flavorants or flavor enhancers, in their own right, at least at relatively high concentrations.

Nevertheless, it is preferable to use as little of such artificial flavorants as possible, so as to minimize both cost and any undesirable health side effects of administration of the compounds of Formula (I) at high concentration levels. Accordingly, it is desirable to test the compounds of Formula (D) for their effectiveness as taste receptor agonists at lower concentration levels, so as to identify the best and most effective tastant compounds within the compounds of Formula (I). As was disclosed in WO 03/001876, and U.S. Patent publication US 2003-0232407 A1, and as described herein below, laboratory procedures now exist for measuring the agonist activities of compounds for an hT1R1/hT1R3 “savory” and hT1R2/hT1R3 sweet receptors. Such measurement methods typically measure an “EC₅₀”, i.e. the concentration at which the compound causes 50% activation of the relevant receptor.

Preferably, the tastant compounds of Formula (I) that are savory flavor modifiers have an EC₅₀ for the hT1R1/hT1R3 receptor expressed in a suitable cell line, such as an HEK293-Gα15 cell line, of less than about 30 μM. More preferably, such tastant compounds have an EC₅₀ for the hT1R1/hT1R3 receptor of less than about 10 μM, 5 μM, 3 μM, 2 μM, 1 μM, or 0.5 μM.

Preferably, the tastant compounds of Formula (I) that are sweet flavor modifiers or sweet flavor enhancers have an EC₅₀ for the hT1R2/hT1R3 receptor of less than about 30 μM. More preferably, such tastant compounds have an EC₅₀ for the hT1R2/hT1R3 receptor expressed in a suitable cell line, such as an HEK293-Gα15 cell line, of less than about 10 μM, 5 μM, 3 μM, 2 μM, 1 μM, or 0.5 μM.

In some embodiments, the tastant compounds of Formula (I) are savory flavor modulators or enhancers of the agonist activity of monosodium glutamate for an hT1R1/hT1R3 receptor. Herein below is described an assay procedure for so-called EC₅₀ ratios, i.e. for dissolving a compound of Formula (I) in water containing MSG, and measuring the degree to which the tastant compound lowers the amount of MSG required to activate 50% of the available hT1R1/hT1R3 receptors. Preferably, the tastant compounds of Formula (I), when dissolved in a water solution comprising about 1 μM of the tastant compound will decrease the observed EC₅₀ of monosodium glutamate for an hT1R1/hT1R3 receptor expressed in an HEK293-Gα15 cell line by at least 50%, i.e. the tastant compound will have an EC50 ratio of at least 2.0, or preferably 3.0, 5.0, or 7.0.

Although no specific EC₅₀ ratio assays for sweet enhancers have yet been developed, it is believed the tastant compounds of Formula (I), and more specifically many of the amides of Formula (II) can modulate the binding of a known sweetener such as for example sucrose, fructose, glucose, erythritol, isomalt, lactitol, mannitol, sorbitol, xylitol, a known natural terpenoid, flavonoid, or protein sweetener, aspartame, saccharin, acesulfame-K, a cyclamate, sucralose, alitame or erythritol to an hT1R2/hT1R3 receptor. Appropriate assays for such sweet enhancement properties can be readily developed by one of ordinary skill in the arts by using appropriate cell lines expressing hT1R2/hT1R3 receptors.

The above identified assays are useful in identifying the most potent of the tastant compounds of Formula (I) for savory and/or sweet taste modifier or enhancer properties, and the results of such assays are believed to correlate well with actual savory or sweet taste perception in animals and humans, but ultimately the results of the assays can be confirmed, at least for the most potent of the compounds of Formula (I), by human taste testing. Such human taste testing experiments can be well quantified and controlled by tasting the candidate compounds in aqueous solutions, as compared to control aqueous solution, or alternatively by tasting the amides of the inventions in actual food compositions.

Accordingly, in order to identify the more potent of the savory taste modifiers or agents, or enhancers of the Umami flavor of MSG in a comestible or medicinal composition, a water solution comprising a savory flavor modifying amount of the tastant compound should have a savory taste as judged by the majority of a panel of at least eight human taste testers.

Correspondingly, in order to identify the more potent of the savory taste enhancers of Formula (I), a water solution comprising a savory flavor modifying amount of an tastant compound of Formula (I) and 12 mM monosodium glutamate, would have an increased savory taste as compared to a control water solution comprising 12 mM monosodium glutamate, as determined by the majority of a panel of at least eight human taste testers. Preferably, in order to identify the more potent of the savory taste enhancers, a water solution comprising a savory flavor modifying amount (preferably about 30, 10, 5, 2 ppm, or 1 ppm) of the tastant compound of Formula (I) and 12 mM monosodium glutamate will have an increased savory taste as compared to a control water solution comprising 12 mM monosodium glutamate and 100 μM inosine monophosphate, as determined by the majority of a panel of at least eight human taste testers.

Similar human taste testing procedures can be used to identify which of the compounds of Formula (I) are the more effective sweet taste agents or sweet taste enhancing agents. Preferred sweet taste modifiers of Formula (I) can be identified when a modified comestible or medicinal product has a sweeter taste than a control comestible or medicinal product that does not comprise the tastant compound, as judged by the majority of a panel of at least eight human taste testers.

Preferred sweet taste enhancers of Formula (I) can be identified when a water solution comprising a sweet tasting amount of a known sweetener selected from the group consisting of sucrose, fructose, glucose, erythritol, isomalt, lactitol, mannitol, sorbitol, xylitol, a known natural terpenoid, flavonoid, or protein sweetener, aspartame, saccharin, acesulfame-K, cyclamate, sucralose, and alitame, and a sweet flavor modifying amount of the tastant compound (preferably about 30, 10, 5, or 2 ppm) has a sweeter taste than a control water solution comprising the sweet tasting amount of the known sweetener, as judged by the majority of a panel of at least eight human taste testers. In such taste test experiments, sucrose would preferably be present at a concentration of about 6 grams/100 milliliters, a 50:50 mixture of glucose and fructose would preferably be present at a concentration of about 6 grams/100 milliliters, aspartame would preferably be present at a concentration of about 1.6 mM, acesulfame-K would preferably be present at a concentration of about 1.5 mM, cyclamate would preferably be present at a concentration of about 10 mM, sucralose would preferably be present at a concentration of about 0.4 mM, or alitame would preferably be present at a concentration of about 0.2 mM.

Using the Compounds of Formula (I) to Prepare Comestible Compositions

Flavors, flavor modifiers, flavoring agents, flavor enhancers, savory (“umami”) flavoring agents and/or flavor enhancers, the compounds of Formula (I) and its various subgenera and species of compounds have application in foods, beverages and medicinal compositions wherein savory or sweet compounds are conventionally utilized. These compositions include compositions for human and animal consumption. This includes foods for consumption by agricultural animals, pets and zoo animals.

Those of ordinary skill in the art of preparing and selling comestible compositions (i.e., edible foods or beverages, or precursors or flavor modifiers thereof) are well aware of a large variety of classes, subclasses and species of the comestible compositions, and their large number of known ingredients and/or precursors, and utilize well-known and recognized terms of art to refer to those comestible compositions while endeavoring to prepare and sell various of those compositions. Such a list of terms of art is enumerated below, and it is specifically contemplated hereby that the various subgenera and species of the compounds of Formula (I) could be used to modify or enhance the savory and/or sweet flavors of the following list comestible compositions, either singly or in all reasonable combinations or mixtures thereof:
One or more confectioneries, chocolate confectionery, tablets, countlines, bagged selflines/softlines, boxed assortments, standard boxed assortments, twist wrapped miniatures, seasonal chocolate, chocolate with toys, alfajores, other chocolate confectionery, mints, standard mints, power mints, boiled sweets, pastilles, gums, jellies and chews, toffees, caramels and nougat, medicated confectionery, lollipops, liquorice, other sugar confectionery, gum, chewing gum, sugarized gum, sugar-free gum, functional gum, bubble gum, bread, packaged/industrial bread, unpackaged/artisanal bread, pastries, cakes, packaged/industrial cakes, unpackaged/artisanal cakes, cookies, chocolate coated biscuits, sandwich biscuits, filled biscuits, savory biscuits and crackers, bread substitutes, breakfast cereals, rte cereals, family breakfast cereals, flakes, muesli, other rte cereals, children's breakfast cereals, hot cereals, ice cream, impulse ice cream, single portion dairy ice cream, single portion water ice cream, multi-pack dairy ice cream, multi-pack water ice cream, take-home ice cream, take-home dairy ice cream, ice cream desserts, bulk ice cream, take-home water ice cream, frozen yoghurt, artisanal ice cream, dairy products, milk, fresh/pasteurized milk, full fat fresh/pasteurized milk, semi skimmed fresh/pasteurized milk, long-life/uht milk, full fat long life/uht milk, semi skimmed long life/uht milk, fat-free long life/uht milk, goat milk, condensed/evaporated milk, plain condensed/evaporated milk, flavored, functional and other condensed milk, flavored milk drinks, dairy only flavored milk drinks, flavored milk drinks with fruit juice, soy milk, sour milk drinks, fermented dairy drinks, coffee whiteners, powder milk, flavored powder milk drinks, cream, cheese, processed cheese, spreadable processed cheese, unspreadable processed cheese, unprocessed cheese, spreadable unprocessed cheese, hard cheese, packaged hard cheese, unpackaged hard cheese, yoghurt, plain/natural yoghurt, flavored yoghurt, fruited yoghurt, probiotic yoghurt, drinking yoghurt, regular drinking yoghurt, probiotic drinking yoghurt, chilled and shelf-stable desserts, dairy-based desserts, soy-based desserts, chilled snacks, fromage frais and quark, plain fromage frais and quark, flavored fromage frais and quark, savory fromage frais and quark, sweet and savory snacks, fruit snacks, chips/crisps, extruded snacks, tortilla/corn chips, popcorn, pretzels, nuts, other sweet and savory snacks, snack bars, granola bars, breakfast bars, energy bars, fruit bars, other snack bars, meal replacement products, slimming products, convalescence drinks, ready meals, canned ready meals, frozen ready meals, dried ready meals, chilled ready meals, dinner mixes, frozen pizza, chilled pizza, soup, canned soup, dehydrated soup, instant soup, chilled soup, uht soup, frozen soup, pasta, canned pasta, dried pasta, chilled/fresh pasta, noodles, plain noodles, instant noodles, cups/bowl instant noodles, pouch instant noodles, chilled noodles, snack noodles, canned food, canned meat and meat products, canned fish/seafood, canned vegetables, canned tomatoes, canned beans, canned fruit, canned ready meals, canned soup, canned pasta, other canned foods, frozen food, frozen processed red meat, frozen processed poultry, frozen processed fish/seafood, frozen processed vegetables, frozen meat substitutes, frozen potatoes, oven baked potato chips, other oven baked potato products, non-oven frozen potatoes, frozen bakery products, frozen desserts, frozen ready meals, frozen pizza, frozen soup, frozen noodles, other frozen food, dried food, dessert mixes, dried ready meals, dehydrated soup, instant soup, dried pasta, plain noodles, instant noodles, cups/bowl instant noodles, pouch instant noodles, chilled food, chilled processed meats, chilled fish/seafood products, chilled processed fish, chilled coated fish, chilled smoked fish, chilled lunch kit, chilled ready meals, chilled pizza, chilled soup, chilled/fresh pasta, chilled noodles, oils and fats, olive oil, vegetable and seed oil, cooking fats, butter, margarine, spreadable oils and fats, functional spreadable oils and fats, sauces, dressings and condiments, tomato pastes and purees, bouillon/stock cubes, stock cubes, gravy granules, liquid stocks and fonds, herbs and spices, fermented sauces, soy based sauces, pasta sauces, wet sauces, dry sauces/powder mixes, ketchup, mayonnaise, regular mayonnaise, mustard, salad dressings, regular salad dressings, low fat salad dressings, vinaigrettes, dips, pickled products, other sauces, dressings and condiments, baby food, milk formula, standard milk formula, follow-on milk formula, toddler milk formula, hypoallergenic milk formula, prepared baby food, dried baby food, other baby food, spreads, jams and preserves, honey, chocolate spreads, nut-based spreads, and yeast-based spreads.

Preferably, the compounds of Formula (I) can be used to modify or enhance the savory or sweet flavor of one or more of the following subgenera of comestible compositions: confectioneries, bakery products, ice creams, dairy products, sweet and savory snacks, snack bars, meal replacement products, ready meals, soups, pastas, noodles, canned foods, frozen foods, dried foods, chilled foods, oils and fats, baby foods, or spreads, or a mixture thereof.

In general an ingestible composition will be produced that contains a sufficient amount of one or more compounds within the scope of Formula (I) or its various subgenera described hereinabove to produce a composition having the desired flavor or taste characteristics such as “savory” or “sweet” taste characteristics.

Typically at least a savory flavor modulating amount, a sweet flavor modulating amount, a savory flavoring agent amount, a sweet flavoring agent amount, a savory flavor enhancing amount, a sweet flavor enhancing amount of one or more of the compounds of Formula (I) will be added to the comestible or medicinal product, or one or more of their precursors, optionally in the presence of known savory flavor agents such as MSG, or known sweeteners, so that the savory or sweet flavor modified comestible or medicinal product has an increased (enhanced) savory and/or sweet taste as compared to the comestible or medicinal product prepared without the tastant compound, as judged by human beings or animals in general, or in the case of formulations testing, as judged by a majority of a panel of at least eight human taste testers, via procedures described elsewhere herein.

The concentration of savory or sweet flavoring agent needed to modulate or improve the flavor of the comestible or medicinal product or composition will of course vary dependent on many variables, including the specific type of ingestible composition, what known savory or sweet flavoring agents are also present and the concentrations thereof, and the effect of the particular compound on such savory compounds. As noted, a significant application of the compounds of Formula (I) is for modulating (inducing, enhancing or inhibiting) the savory taste or other taste properties of other natural or synthetic savory tastants, such as MSG. A broad but also low range of concentrations of the tastant compounds of Formula (I) would typically be required, i.e. from about 0.001 ppm to 100 ppm, or narrower alternative ranges from about 0.1 ppm to about 10 ppm, from about 0.01 ppm to about 30 ppm, from about 0.05 ppm to about 15 ppm, from about 0.1 ppm to about 5 ppm, or from about 0.1 ppm to about 3 ppm. In many embodiments, MSG would also be present at a concentration of at least about 10 ppm, or preferably 100 or 1000 ppm.

Examples of foods and beverages wherein compounds according to the invention may be incorporated included by way of example the Wet Soup Category, the Dehydrated and Culinary Food Category, the Beverage Category, the Frozen Food Category, the Snack Food Category, and seasonings or seasoning blends.

“Wet Soup Category” means wet/liquid soups regardless of concentration or container, including frozen Soups. For the purpose of this definition soup(s) means a food prepared from meat, poultry, fish, vegetables, grains, fruit and other ingredients, cooked in a liquid which may include visible pieces of some or all of these ingredients. It may be clear (as a broth) or thick (as a chowder), smooth, pureed or chunky, ready-to-serve, semi-condensed or condensed and may be served hot or cold, as a first course or as the main course of a meal or as a between meal snack (sipped like a beverage). Soup may be used as an ingredient for preparing other meal components and may range from broths (consommé) to sauces (cream or cheese-based soups).

“Dehydrated and Culinary Food Category” means: (i) Cooking aid products such as: powders, granules, pastes, concentrated liquid products, including concentrated bouillon, bouillon and bouillon like products in pressed cubes, tablets or powder or granulated form, which are sold separately as a finished product or as an ingredient within a product, sauces and recipe mixes (regardless of technology); (ii) Meal solutions products such as: dehydrated and freeze dried soups, including dehydrated soup mixes, dehydrated instant soups, dehydrated ready-to-cook soups, dehydrated or ambient preparations of ready-made dishes, meals and single serve entrees including pasta, potato and rice dishes; and (iii) Meal embellishment products such as: condiments, marinades, salad dressings, salad toppings, dips, breading, batter mixes, shelf stable spreads, barbecue sauces, liquid recipe mixes, concentrates, sauces or sauce mixes, including recipe mixes for salad, sold as a finished product or as an ingredient within a product, whether dehydrated, liquid or frozen.

“Beverage Category” means beverages, beverage mixes and concentrates, including but not limited to, alcoholic and non-alcoholic ready to drink and dry powdered beverages.

Other examples of foods and beverages wherein compounds according to the invention may be incorporated included by way of example carbonated and non-carbonated beverages, e.g., sodas, fruit or vegetable juices, alcoholic and non-alcoholic beverages, confectionary products, e.g., cakes, cookies, pies, candies, chewing gums, gelatins, ice creams, sorbets, puddings, jams, jellies, salad dressings, and other condiments, cereal, and other breakfast foods, canned fruits and fruit sauces and the like.

Additionally, the subject compounds can be used in flavor preparations to be added to foods and beverages. In preferred instances the composition will comprise another flavor or taste modifier such as a savory tastant.

Methods for Modifying the Taste of Comestible or Medicinal Compositions

In many embodiments, the inventions relate to methods for modulating the savory or sweet taste of a comestible or medicinal product comprising:
a) providing at least one comestible or medicinal product, or one or more precursors thereof, and
b) combining the comestible or medicinal product or one or more precursors thereof with at least a savory flavor modulating amount or a sweet flavor modulating amount of at least one non-naturally occurring tastant compound, or a comestibly acceptable salt thereof, so as to form a modified comestible or medicinal product;
wherein the tastant compound has one of Formulas (Ia-k), (IIa-k), or (IIIa-c), or any of their various subgenera or species compounds described herein, wherein R¹, R², and R³, or R⁷, R⁸, and R⁹ can be defined in the many ways also described hereinabove. Examples of such methods include but are not limited to the methods embodied below.

In some exemplary embodiments, the invention relates to a method for enhancing the sweet taste of a comestible or medicinal product comprising:
a) providing at least one comestible product, or one or more precursors thereof, and
b) combining the comestible product or one or more precursors thereof with at least a savory flavor modulating amount or a sweet flavor modulating amount of one or more non-naturally occurring tastant compounds, or a mixture thereof, or a comestibly acceptable salt thereof, so as to form a modified comestible product;

wherein the one or more tastant compounds have Formulas (Ia-k):

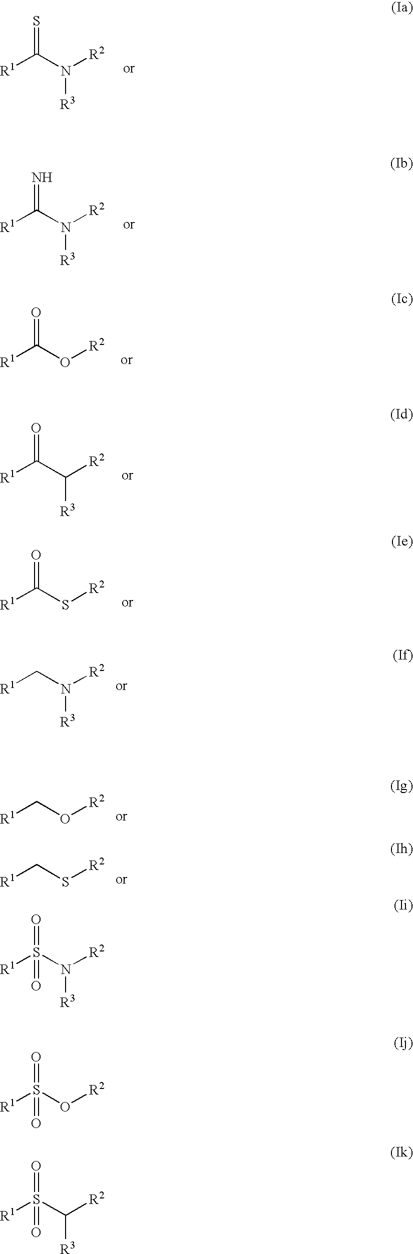

wherein
a) R¹ is an organic residue having at least three carbon atoms and optionally one to ten heteroatoms independently selected from oxygen, nitrogen, sulfur, halogens, or phosphorus; and
b) R² an organic residue having at least three carbon atoms and optionally one to ten heteroatoms independently selected from oxygen, nitrogen, sulfur, halogens, or phosphorus;
c) R³ is hydrogen or an organic residue having at least three carbon atoms and optionally one to ten heteroatoms independently selected from oxygen, nitrogen, sulfur, halogens, or phosphorus; and
wherein the tastant compound has between 10 and 30 carbon atoms and a molecular weight of 500 grams per mole or less;
and wherein the tastant compound is not an amide compound having the formula

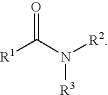

In related embodiments, the invention relates to methods for enhancing the sweet taste of a comestible or medicinal product comprising:
a) providing at least one comestible product, or one or more precursors thereof, and
b) combining the comestible product or one or more precursors thereof with at least a savory flavor modulating amount or a sweet flavor modulating amount of one or more non-naturally occurring tastant compounds, or a mixture thereof, or a comestibly acceptable salt thereof, so as to form a modified comestible product;

wherein the tastant compounds have the structures (IIa-k):

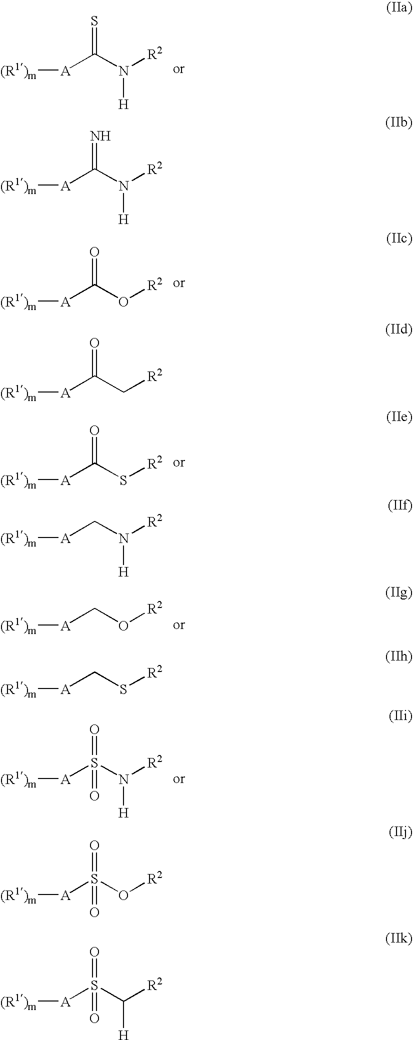

wherein
a) A is a 5 or 6 membered aryl or heteroaryl ring, m is 0, 1, 2, 3 or 4, and each R^{1′} is independently selected from the group consisting of hydroxyl, NH₂, SH, halogen, and a C₁-C₄ organic radical, and
b) R² an organic residue having three to 16 carbon atoms and optionally one to ten heteroatoms independently selected from oxygen, nitrogen, sulfur, halogens, or phosphorus;
or a comestibly acceptable salt thereof.

In further embodiments, the invention relates to methods for increasing the sweet taste of a comestible or medicinal product comprising:
a) providing at least one comestible product, or one or more precursors thereof, and
b) combining the comestible product or one or more precursors thereof with at least a savory flavor modulating amount or a sweet flavor modulating amount of one or more non-naturally occurring tastant compounds, or a mixture thereof, or a comestibly acceptable salt thereof, so as to form a modified comestible product;
wherein the tastant compounds have the structures: 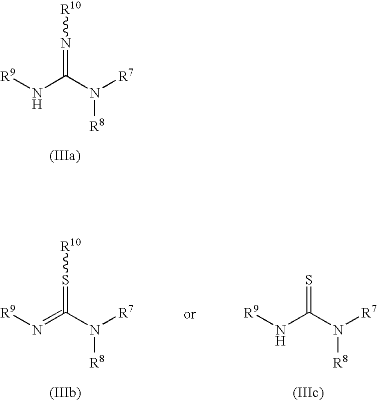
and wherein
   R⁹ is a C₃-C₁₆ organic radical; and
   i) R⁷ is a C₃-C₁₆ organic residue and R⁸ is hydrogen; or
   ii) R⁷ and R⁸ together with the nitrogen atom bound thereto form a heterocyclic ring radical having one of the structures: 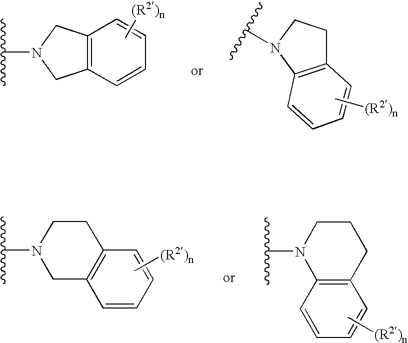
wherein n is 0, 1, 2, or 3, and each R²′ is independently selected from the group consisting of hydroxyl, NH₂, SH, halogen, or a C₁-C₄ organic radical; and R¹⁰ is hydrogen or a C₁-C₄ organic radical.

The invention also relates to the modified comestible or medicinal products produced by the processes disclosed above, or similar processes employing the various subgenera and/or species of the compounds of any one or all of Formulas (Ia-k), (IIa-k), or (IIIa-c).

The invention also relates to similar processes for producing comestible or medicinal products well known to those of ordinary skill in the art. The tastant compounds of Formula (I) and its various subgenera can be combined with or applied to the comestible or medicinal products or one or more precursors thereof in any of innumerable ways known to cooks, food preparers the world over, or producers of comestible or medicinal products. For example, the tastant compounds of Formula (I) could be dissolved in or dispersed in or one of many comestibly acceptable liquids, solids, or other carriers, such as water at neutral, acidic, or basic pH, fruit or vegetable juices, vinegar, marinades, beer, wine, natural water/fat emulsions such as milk or condensed milk, edible oils and shortenings, fatty acids, certain low molecular weight oligomers of propylene glycol, glyceryl esters of fatty acids, and dispersions or emulsions of such hydrophobic substances in aqueous media, salts such as sodium chloride, vegetable flours, solvents such as ethanol, solid edible diluents such as vegetable powders or flours, and the like, and then combined with precursors of the comestible or medicinal products, or applied directly to the comestible or medicinal products.

Making the Tastant Cmpounds of Formula (I)

The starting materials used in preparing the compounds of the invention, i.e. the various structural subclasses and species of the tastant compounds of Formula (I) and their synthetic precursors, especially the organic carboxylic acids and benzoic acids, isocyanates, and the various amines, anilines, alcohols, amino acids, etc, were often known compounds, or made by known methods of the literature, or are commercially available from various sources well known to those of ordinary skill in the art, such as for example, Sigma-Aldrich Corporation of St. Louis, Mo. USA and their subsidiaries Fluka and Riedel-de Haën, at their various other worldwide offices, and other well know suppliers such as Fisher Scientific, TCI America of Philadelphia, Pa., ChemDiv of San Diego, Calif., Chembridge of San Diego, Calif., Asinex of Moscow, Russia, SPECS/BIOSPECS of the Netherlands, Maybridge of Cornwall, England, Acros, TimTec of Russia, Comgenex of South San Francisco, Calif., and ASDI Biosciences of Newark, Del.

It will be apparent to the skilled artisan that methods for preparing precursors and functionality related to the compounds claimed herein are generally described in the literature. The skilled artisan given the literature and this disclosure is well equipped to prepare any of the necessary starting materials and/or claimed compounds. In some of the Examples cited below, starting materials were not readily available, and therefore were synthesized, and the synthesis of the starting materials is therefore exemplified.

It is recognized that the skilled artisan in the art of organic chemistry can readily carry out manipulations without further direction, that is, it is well within the scope and practice of the skilled artisan to carry out these manipulations. These include reduction of carbonyl compounds to their corresponding alcohols, oxidations, acylations, aromatic substitutions, both electrophilic and nucleophilic, etherifications, esterification, saponification, nitrations, hydrogenations, reductive amination and the like. These manipulations are discussed in standard texts such as March's Advanced Organic Chemistry (3d Edition, 1985, Wiley-Interscience, New York), Feiser and Feiser's Reagents for Organic Synthesis, Carey and Sundberg, Advanced Organic Chemistry and the like, the entire disclosures of which are hereby incorporated by reference in their entireties for their teachings regarding methods for synthesizing organic compounds.

The skilled artisan will readily appreciate that certain reactions are best carried out when other functionality is masked or protected in the molecule, thus avoiding any undesirable side reactions and/or increasing the yield of the reaction. Often the skilled artisan utilizes protecting groups to accomplish such increased yields or to avoid the undesired reactions. These reactions are found in the literature and are also well within the scope of the skilled artisan. Examples of many of these manipulations can be found for example in T. Greene and P. Wuts, Protecting Groups in Organic Synthesis, 3rd Ed., John Wiley & Sons (1999).

The following abbreviations have the indicated meanings:
CH₃CN=Acetonitrile
CHCl₃=Chloroform
DIC=N,N′-Diisopropylcarbodiimide
DIPEA=Diisopropylethylamine
DMAP=4-(dimethylamino)-pyridine
DMF=N,N-dimethylformamide
EDCI=1-(3-Dimethylaminopropyl)-3-ethylcarbodiimide hydrochoride
DCM=Dichloromethane

ESIMS=electron spray mass spectrometry
Et₃N=triethylamine
EtOAc=ethyl acetate
EtOH=Ethyl Alcohol

Fmoc=N-(9-fluorenylmethoxycarbonyl-
HCl=Hydrochloric acid
H₂SO₄=Sulfuric acid
HOBt=1-Hydroxybenzotriazole
MeOH=Methyl Alcohol
MgSO₄=magnesium sulfate
NaHCO₃=sodium bicarbonate
NaOH=Sodium Hydroxide
Na₂SO₄=Sodium Sulfate
Ph=phenyl
r.t.=room temperature
SPOS=solid phase organic synthesis
THF=tetrahydrofuran
TLC=thin layer chromatography

Alkyl Group Abbreviations
Me=methyl
Et=ethyl
n-Pr=normal propyl
i-Pr=isopropyl
n-Bu=normal butyl
i-Bu=isobutyl
t-Bu=tertiary butyl
s-Bu=secondary butyl
n-Pen=normal pentyl
i-Pen=isopentyl n-Hex=normal hexyl
i-Hex=isohexyl

Polymer Supported Reagent Abbreviations
PS-Trisamine=Tris-(2-aminoethyl)amine polystyrene
PS-NCO=methylisocyanate polystyrene
PS-TsNHNH₂=toluensulfonylhydrazone polystyrene
   Synthetic Methods

The following Schemes and Examples are provided for the guidance of the reader, and represent a variety of methods for making the tastant compounds disclosed herein. The disclosed methods are exemplary only, not limiting, and it will be apparent to one or ordinary skill in the art that other methods, many of which are known in the art, may be employed to prepare the tastant compounds of the various embodiments of the invention. Such methods specifically include solid phase based chemistries, including combinatorial chemistry.

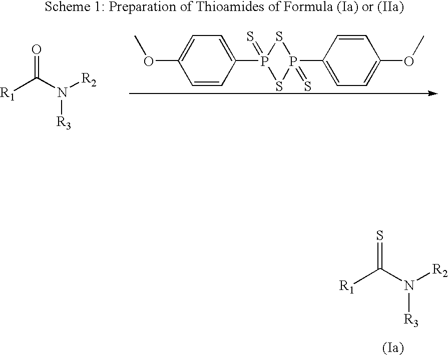

Thioamides of Formulas (Ia) and (IIa) can be easily prepared by substitution of sulfur for the oxygen atom of a corresponding amide compound by treatment with Lawesson's reagent as illustrated above (see Pedersen et al., Bull. Soc. Chim. Bel. 1978, 87, 223) and Example 1.

The amide tastant compounds of Formula (Ia) can be prepared by many methods known in the art, including the method disclosed in detail in Examples 1 and 18, i.e. condensation of carboxylic acids and/or their derivatives (such as esters, acid halides etc) with primary or secondary amines, often in the presence of dehydrating agents, coupling agents, and/or appropriate catalysts, to produce the desired carboxamide precursor compounds. Large numbers of suitable starting materials, such as primary and secondary amines, and carboxylic acids and their derivatives, are readily available or can be readily synthesized by methods known in the literature or are readily available commercially. In some cases, methods for synthesis of certain amine or carboxylic acid starting materials are given below.

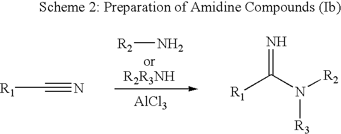

Amidine compounds of Formula (Ib) can be for example prepared from arylnitriles by exothermic reaction with primary or secondary amines in a solventless system in presence of anhydrous AlCl₃. (see Brodrick et al., J. Chem. Soc. 1951, 1343)

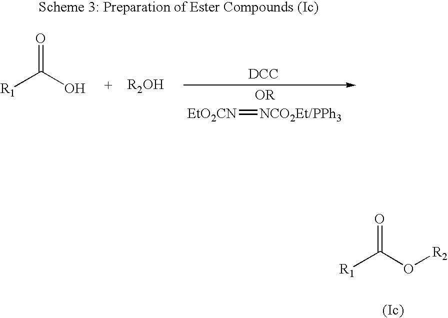

Many methods for making carboxylic ester compounds of Formula (Ic) are known in the literature and the March, Fieser and Fieser, and other treatises disclosed above. For example, esters are often prepared by condensation of a carboxylic acid halide and an alcohol, or a carboxylic acid and an alcohol in the presence of a dehydrating apparatus such as a Dean Stark trap, or a dehydrating agent such as for example DCC, or under Mistsunobu conditions (see Mitsunobu et al, Chem. Soc. Jap. 1967, 40, 2380).

Scheme 4: Preparation of Ketones of Formulas (Ic)

Many methods for making ketone compounds of Formula (Id) are known in the literature and the March, Fieser and Fieser, and other treatises disclosed above. One such method is disclosed below.

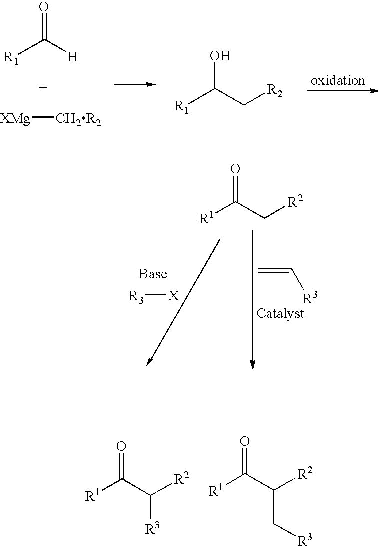

Ketone (Id) can be prepared by reacting aldehydes, and preferably aromatic aldehydes with nucleophilic organometallic compounds such as Grignard reagents or organolithium compounds to yield an alcohol, which can be oxidized to a ketone by many known methods. (See B. Whitmore et al. JACS 1942, 64, 1620) The ketone can be further alkylated by many organic electrophiles such as organic halides or by amine catalyzed Michael addition of activated olefins (see for example J. M. Betancourt et al. Synthesis 2004, 9, 1509).

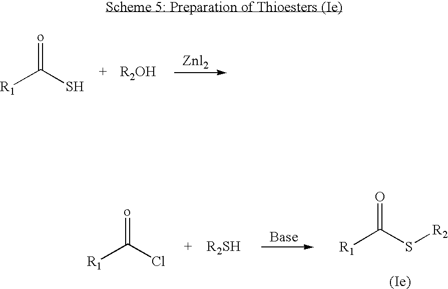

Thioesters of Formula (Ie) can be prepared by reacting a thioacid with an alcohol in presence of zinc iodide (see Gautier et al, Tetrahedron Lett, 1986, 27, 15). Alternatively, thioester (Ie) can be prepared from a carboxylic acid chloride and a thiol in presence of a base.

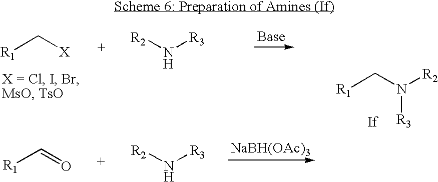

Amines of Formula (If) can be prepared by treatment of R₁ CH₂X, where X is Cl, Br, or I, or various sulfate derivatives, with an amine in the presence of a base, or by reductive amination of an aldehyde with an amine in presence of a reducing agent such as NaBH(OAc)₃.

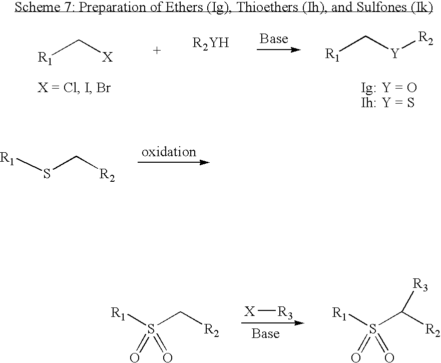

Ethers (Ig) and thioethers (Ih) can be prepared from the alkylhalide and an alcohol or thiol respectively, in presence of a base. The thioethers can be oxidized to sulfones by a variety of known agents and methods, including treatment with hydrogen peroxide or various well known organic peracids, such as m-chloro-perbenzoic acid (MCPBA). Hydrogen atoms adjacent to the sulfone groups can be removed by treatment with strong bases and alkylation of the resulting anions with alkylating agents such as organic halides, triflates, and the like.

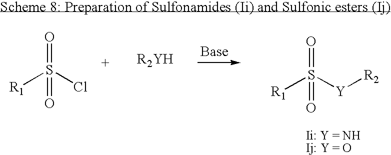

Sulfonamides (Ii) and sulfonic esters (Ih) can be prepared by condensing sulfonyl chloride precursors of R¹ and amine or alcohol precursors of R² in presence of a base.

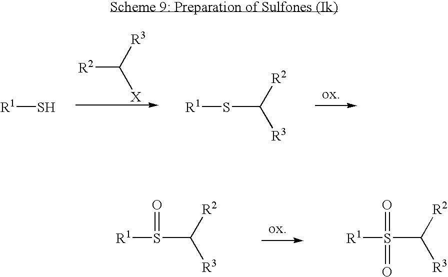

Sulfone (Ik) can be prepared by oxidation of a thioether (see L. Xu et al. J. Org. Chem. 2003, 68, 5388; K. Sato et al. Tetrahedron 2001, 57, 2469) that is readily available from reaction of a thiol precursor of R¹ with an alkyl halide precursor of R² and/or R³ (see M. A. P. Martins et al. Synthesis 2001, 13, 1959).

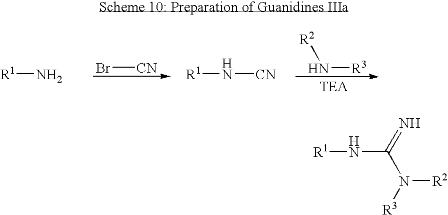

Guanidine (IIIa) can be prepared in reaction of bromocyanide with an amine precursor of R¹, to generate a cyanoamine, which can be condensed with a primary or secondary amine precursor of R² and/or R³. See W. Fast et al. Bioorg. Med. Chem. 1997, 5, 8, 1601; R. A. Pufahl et al. Biochemistry 1992, 31, 6822.

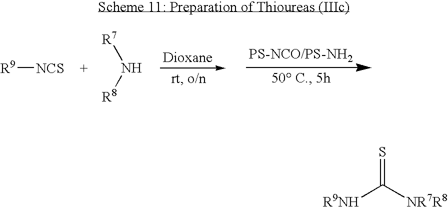

Thiourea (IIIc) can be prepared in reaction of an amine precursor of R¹ (R) with an isothiocyanate precursor of R² and/or R³, (R⁷ and/or R⁸).

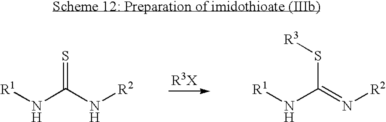

Imidothioate (IIIb) can be prepared from thiourea IIIc by alkylation with an alkyl halide. (See J. L. La Mattina et al. J. Med. Chem. 33, 2, 543, 1990).

A very wide variety of carboxylic acid, ketone, amine, and alcohol derivatives that are suitable precursors of the RX groups of the tastant compounds of Formulas (I), and various subgenuses of the compounds of Formula (I), are readily available by methods or ready adaptation of methods known in the prior art, or are available commercially. In particular, the substituted aryl or heteroaryl carboxylic acid compounds that are precursors of the compounds of Formula (II) are often readily available commercially, or through use of very well known synthetic methodologies. Similarly, many amine compounds that are suitable precursors of the tastant compounds of Formula (I) are readily available commercially or through known methods of synthesis. Nevertheless, disclosed in the Schemes and/or Examples below are methods for synthesizing certain starting building block precursors of the R¹ and R² groups.

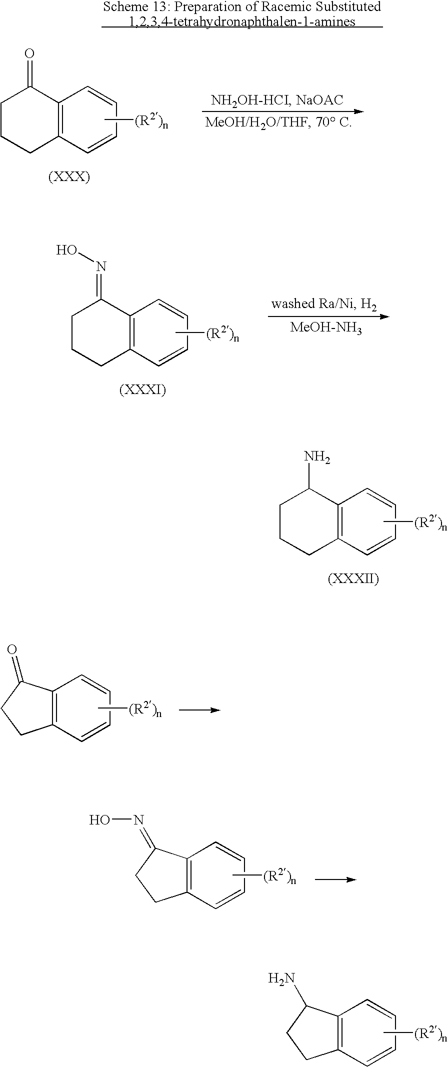

As shown in Scheme 7, racemic 1,2,3,4-tetrahydronaphthalen-1-amines (XXXII) can be readily prepared by converting substituted 3,4-dihydronaphthalen-1(2H)-ones (wherein independently selected R substituents can be present on either ring) to the oxime (XXXI) by treatment with hydroxylamine. Hydrogenation of the oximes in presence of Ra/Ni in MeOH—NH₃, or reduction with various known reducing agents, readily provide the racemic substituted 1,2,3,4-tetrahydronaphthalen-1-amine derivatives (XXXII). Racemic substituted indanones are readily produced by an analogous reaction sequence, as shown above.

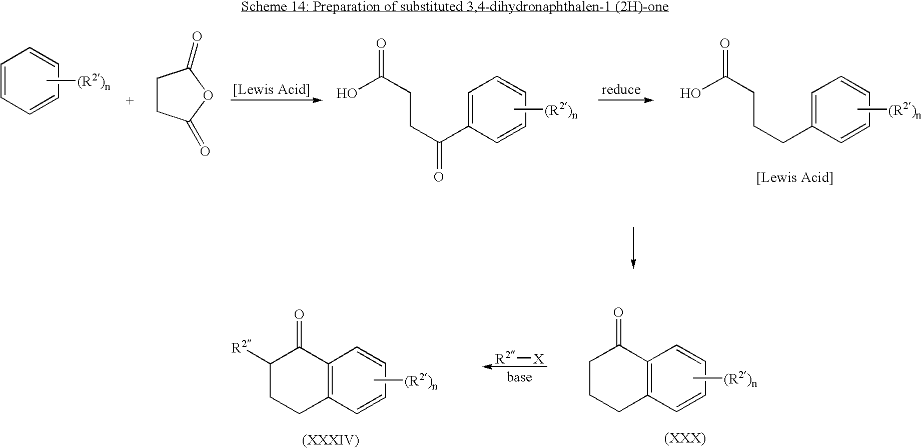

Many substituted dihydronapthaleneones are readily commercially available or can be prepared using many conventional methods, such as those as illustrated above. These ketones can of course be reduced to the corresponding alcohols, which can be precursors of of the esters of Formula (Ic), ethers of Formula (Ig) or sulfate esters of Formula (Ij).

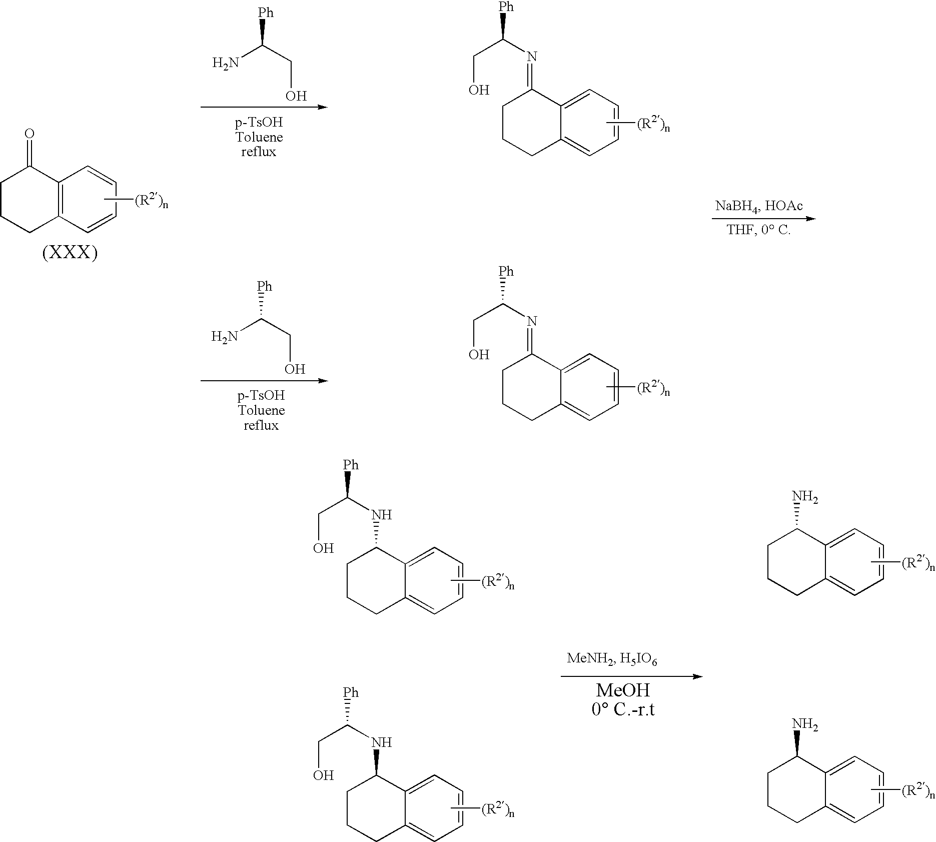

Chiral substituted 1,2,3,4-tetrahydronaphthalen-1-amines derivatives (S enantiomers, or R enantiomer) can be prepared from dihydronapthalenyl ketones such as (XXX) using an asymmetric synthesis (see Stalker, R. A. et al., Tetrahedron 2002, 58, 4837-4849). Ketone (XXX) is converted to the chiral imine by condensation with S- or R-phenylglycinol respectively. The imine is then enantioselectively reduced to the amine with sodium borohydride, followed by oxidative cleavage of the chiral auxiliary, to provides the amine of the illustrated optical configurations with enantiomeric excesses greater than 99%.

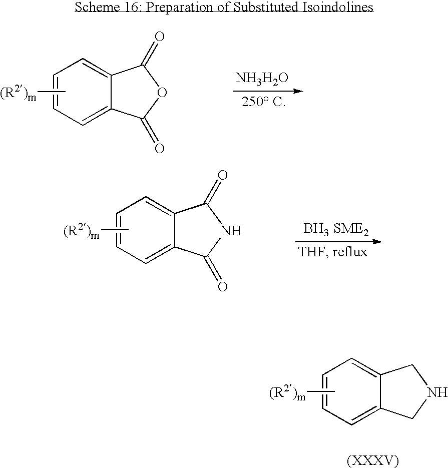

Substituted isoindolines (XXXV) can be prepared from substituted phthalic anhydrides by treatment of the phthalic anhydrides with a concentrated ammonia solution to give the substituted phthalimide (see Noyes, W. A., Porter, P. K. Org. Syn., Coll. Vol. 1, 457), followed by reduction of the phthalimide with borane methyl sulfide complex (see Gawley, R. E., Chemburkar, S. R., Smith, A. L., Anklekar, T. V. J. Org. Chem. 1988, 53, 5381).

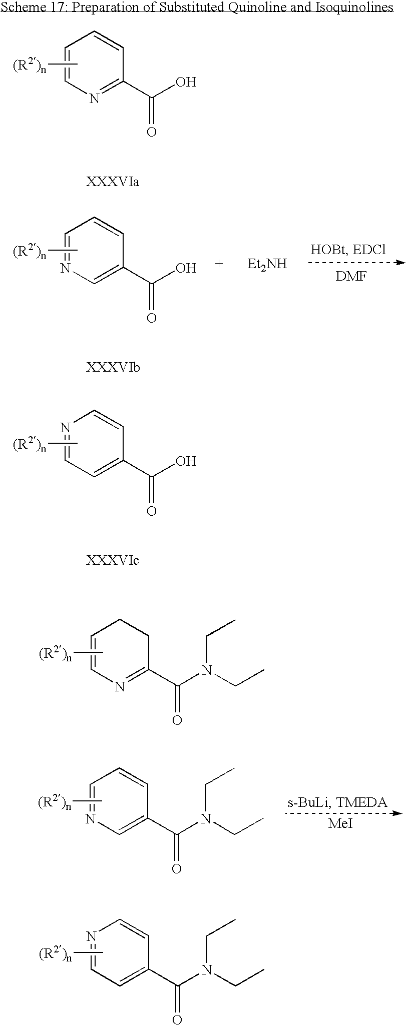

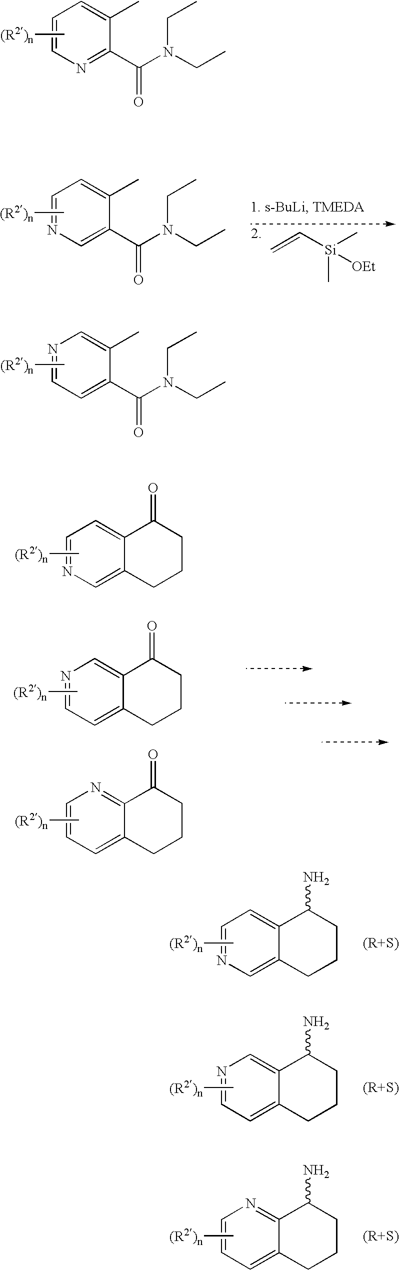

A variety of substituted heteroaromatic tetralins can be synthesized from pyridine carboxylic acids (XXXVa-c). Reaction of the carboxylic acid with diethylamine in the presence of HOBt and EDCI provides an activated aromatic amide, which allows for methylation ortho to the amide when treated with s-BuLi, TMEDA and MeI (see Date, M.; Watanabe, M.; Furukawa, S. Chem. Pharm. Bull. 1990, 38, 902-906). The methylated diethylamides can then be cyclized to the desired dihydroquinolin-8(5H)-one or dihydroisoquinolin-5(6H)-one by treatment with s-BuLi, TMEDA and ethoxydimethylvinyl silane. Conversion of the ketone to the desired racemic or enantiomerically pure quinoline-8-amines or isoquinoline-5-amines (XVa-c) can be achieved as described in Schemes 13 or 15.

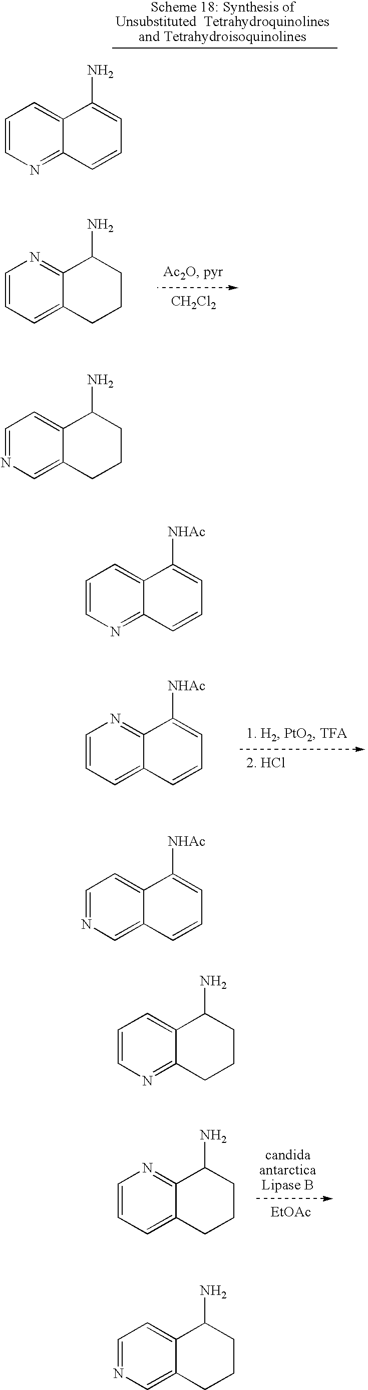

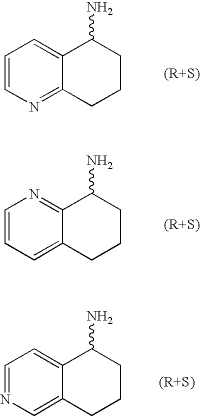

Unsubstituted tetrahydroquinolines and tetrahydroisoquinolines can be synthesized as described by McEachern and coworkers (see Skupinska, K. A.; McEachern, E. J.; Skerlj, R. T.; Bridger, G. J. J. Org. Chem. 2002, 67, 7890-7893) starting from amino substituted quinoline or isoquinoline precursors. Acetylation of the amino quinoline or isoquinoline, followed by hydrogenation of the cyclohexyl ring in the presence of Adam's catalyst, followed by deacetylation provide the racemic amino-cyclohexanes, which can be resolved by selective acetylation of one optical isomer with an alkyl acetate such as ethyl acetate with candida antartica lipase (CALB) in to yield a mixture of a desired enantiomerically pure amine and an acetamide of the other enantiomer, which mixture can be readily separated by many means (see Skupinska, K. A.; McEachern, E. J.; Baird, I. R.; Skerlj, R. T.; Bridger, G. J. J. Org. Chem. 2003, 68, 3546-3551).

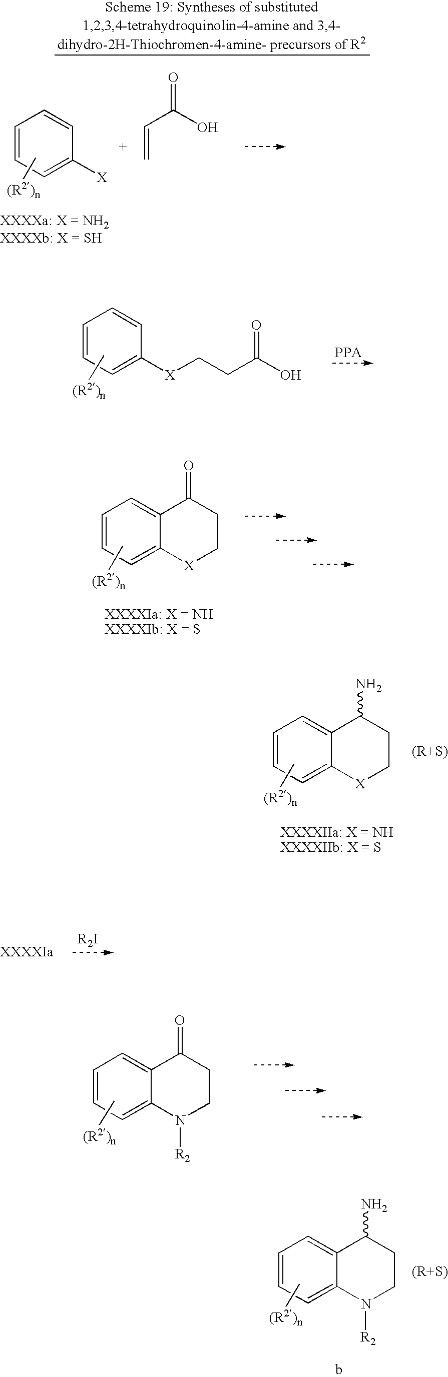

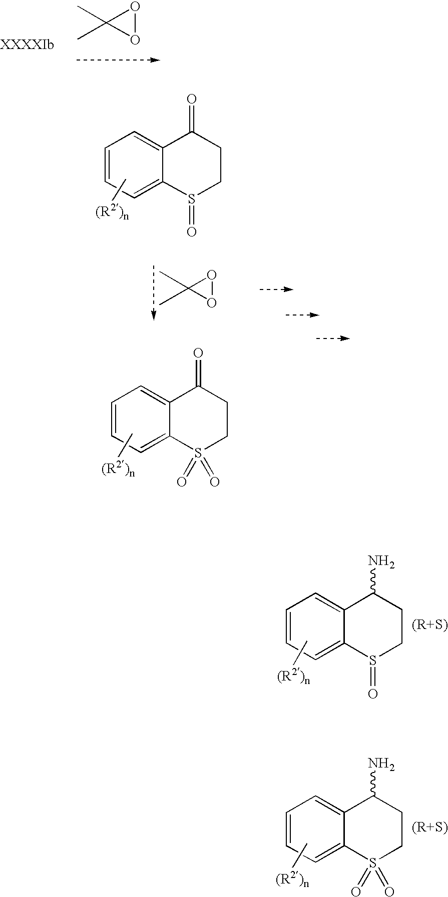

The syntheses of 1,2,3,4-tetrahydroquinolin-4-amine and 3,4-dihydro-2H-thiochromen-4-amine precursors of R², can be achieved via a Michael addition of aniline (XXXXa) or thiophenol (XXXXb) to acrylic acid (see Ahn, Y.; Cohen, T. J. Org. Chem. 1994, 59, 3142-3150), followed by cyclization with polyphosphoric acid (PPA) to provide the cyclized heterocyclic ketones (XXXXIa and XXXXIb) (see Higuchi, R. I.; Edwards, J. P.; Caferro, T. R.; Ringgenberg, J. D.; Kong, J. W.; Hamann, L. G.; Arienti, K. L.; Marschke, K. B.; Davis, R. L.; Farmer, L. J.; Jones, T. K. Bioorg. Med. Chem. Lett. 1999, 9, 1335-1340 and Kinoshita, H.; Kinoshita, S.; Munechika, Y.; Iwamura, T.; Watanabe, Sh.-I.; Kataoka, T. Eur. J. Org. Chem. 2003, 4852-4861). Alkylation of the nitrogen amino ketone (XXXXIa) provides an N-alkylated ketone (XXV), and the desired amines (XXIVa, XXIVb and XXVI) can be obtained in racemic mixtures by the method of Scheme 7 ir enantioselectively using the method described in Scheme 9. Oxidation of the 2,3-dihydrothiochromen-4-one (XXXXIB) to the sulfoxide can be achieved by treatment with limited quantities of dimethyldioxirane, while treatment with an excess of the oxidizing agent results in formation of the sulfone (see Patonay, T.; Adam, W.; Lévai, A.; Kövér, P.; Németh, M.; P, E.-M.; Peters, K. J. Org. Chem. 2001, 66, 2275-2280). The desired enantiomerically pure amines (XXIX and XXX) can be synthesized as outlined in Scheme 15.

In view of the disclosures, teachings, treatises, and references cited above, all of which are hereby incorporated herein by reference, one of ordinary skill in the art of synthetic organic chemistry is thoroughly equipped to prepare the necessary and/or claimed compounds by those methods given the literature and this disclosure.

Measuring the Biological Activity of the Compounds of the Invention

Cell based technologies and assays, such as those disclosed in WO 02/064631, and WO 03/001876, and U.S. Patent Publication US 2003-0232407 A1 were used both to initially screen a wide variety of classes of compounds for agonist or antagonist activity for T1R1/T1R3 “savory” taste receptors, or T1R2/T1R3 “sweet” taste receptors that had been expressed in appropriate cell lines. Once initial “hits” were obtained for tastant compounds in such cell lines, the same assays and also certain cell and/or receptor-based assays were used as analytical tools to measure the ability of the compounds of Formula (I) to enhance the savory taste of MSG or the sweet taste of known sweeteners such as sucrose, fructose, and were used to provide empirical data to guide an interative process of synthesizing and testing structural variants of the tastant compounds, in combination with occasional human taste testing of high interest compounds, so as to design, test, and identify species and genuses of compounds with increased and optimized levels of desirable biological activities.

Many embodiments of the inventions relate to the identification of specific compounds and classes of the tastant compounds of Formula (Ia-k) that modulate (increase or decrease) the activity of the T1R1/T1R3 (preferably hT1R1/hT1R3) savory taste receptor (umami receptor), alone or in combination with another compound that activates hT1R1/hT1R3, e.g., MSG. Particularly, in many embodiments the invention relate to the tastant compounds of Formula (Ia-k) that modulate the activity of hT1R1/hT1R3 (human umami receptor) in vitro and/or in vivo. In another aspect, the invention relates to compounds that modulate the human perception of savory (umami) taste, alone or in combination with another compound or flavorant, when added to a comestible or medicinal product or composition.

Many embodiments of the inventions relate to the identification of classes and/or species of the tastant compounds of Formula (Ia-k) that modulate (increase or decrease) the activity of the T1R2/T1R3 (preferably hT1R2/hT1R3) sweet taste receptor (alone or in combination with another compound that activates hT1R2/hT1R3, or otherwise induces a sweet taste, e.g., sucrose, glucose, fructose, and the like. Particularly, the invention relates to the tastant compounds of Formula (Ia-k) that modulate the activity of hT1R2/hT1R3 (human sweet receptor) in vitro and/or in vivo. In another aspect, the invention relates to compounds of Formula (Ia-k) that modulate the human perception of sweet taste, alone or in combination with another compound or flavorant composition, when added to a comestible or medicinal product or composition.

In Vitro hT1R1/hT1R3 Umami Taste Receptor Activation Assay

In order to identify new savory flavoring agents and enhancers, including compounds with savory agonist and enhancer activities (dual activity), the tastant compounds of Formula (I) were screened in primary assays and secondary assays including compound dose response and enhancement assay. In a primary assay for potential ability to modulate umami taste, tastant compounds of Formula (I) that can be either savory flavoring agents in their own right or flavor enhancers of MSG are identified and scores of their activities are given as percentage of the maximum MSG intensity (%). In compound dose response, an EC₅₀ is calculated to reflect the potency of the compound as a savory agonist or enhancer.

An HEK293 cell line derivative (see e.g., Chandrashekar, et al., Cell (2000) 100: 703-711) which stably expresses Gα15 and hT1R1/hT1R3 under an inducible promoter (see WO 03/001876 A2) was used to identify compounds with savory tasting properties.

Compounds disclosed in this application were initially selected based on their activity on the hT1R1/hT1R3-HEK293-Gα15 cell line. Activity was determined using an automated fluorometric imaging assay on a FLIPR instrument (Fluorometric Intensity Plate Reader, Molecular Devices, Sunnyvale, Calif.) (designated FLIPR assay). Cells from one clone (designated clone I-17) were seeded into 384-well plates (at approximately 48,000 cells per well) in a medium containing Dulbecco's modified Eagle's medium (DMEM) supplemented with GlutaMAX (Invitrogen, Carlsbad, Calif.), 10% dialyzed fetal bovine serum (Invitrogen, Carlsbad, Calif.), 100 Units/ml Penicillin G, 100 μg/ml Streptomycin (Invitrogen, Carlsbad, Calif.) and 60 pM mifepristone (to induce expression of hT1R1/hT1R3, (see WO 03/001876 A2). I-17 cells were grown for 48 hours at 37° C. I-17 cells were then loaded with the calcium dye Fluo-3AM (Molecular Probes, Eugene, Oreg.), 4 μM in a phosphate buffered saline (D-PBS) (Invitrogen, Carlsbad, Calif.), for 1.5 hours at room temperature. After replacement with 25 μl D-PBS, stimulation was performed in the FLIPR instrument and at room temperature by the addition of 25 μl D-PBS supplemented with different stimuli at concentrations corresponding to twice the desired final level. Receptor activity was quantified by determining the maximal fluorescence increases (using a 480 nm excitation and 535 nm emission) after normalization to basal fluorescence intensity measured before stimulation.

For dose-responses analysis, stimuli were presented in duplicates at 10 different concentrations ranging from 1.5 nM to 30 μM. Activities were normalized to the response obtained with 60 mM monosodium glutamate, a concentration that elicits maximum receptor response. EC₅₀s (concentration of compound that causes 50% activation of receptor) were determined using a non-linear regression algorithm, where the Hill slope, bottom asymptotes and top asymptotes were allow to vary. Identical results were obtained when analyzing the dose-response data using commercially available software for non-linear regression analysis such as GraphPad PRISM (San Diego, Calif.).

In order to determine the dependency of hT1R1/hT1R3 for the cell response to different stimuli, selected compounds of Formula (I) were subjected to a similar analysis on 1-17 cells that had not been induced for receptor expression with mifepristone (designated as un-induced 1-17 cells). The un-induced I-17 cells do not show any functional response in the FLIPR assay to monosodium glutamate or other savory-tasting substances. Compounds were presented to un-induced umami cells at 10 μM—or three times the maximum stimulation used in the dose-response analysis. Compounds covered in this document do not show any functional response when using un-induced umami cells in the FLIPR assay.

In some aspects of the present invention, an EC₅₀ of lower than about 10 mM is indicative of compounds of Formula (I) that induce T1R1/T1R3 activity and are therefore considered a savory agonist. A savory agonist will have EC₅₀ values of less than about 20 μM, 15 μM, 10 μM, 5 μM, 3 μM, 2 μM, 1 μM, 0.8 μM or 0.5 μM.

In umami taste enhancement activity assay experiments, which produce an “EC₅₀ ratio” measurement of how effectively the tastant compounds of the invention enhance the savory flavorant (typically MSG) already in a test solution. A series of measurements of the dose response is run in solutions comprising MSG alone, then a second dose response is run with MSG in combination with predetermined amounts of a candidate compound of Formula (I) at the same time.

In this assay, increasing concentrations of monosodium glutamate (ranging from 12 μM to 81 mM) were presented, in duplicates, in the presence or absence of a fixed concentration of the test compound. Typical compound concentrations tested were 30 μM, 10 μM, 3 μM, 1 μM, 0.3 μM, 0.1 μM and 0.03 μM. The relative efficacy of compounds of Formula (I) at enhancing the receptor was determined by calculating the magnitude of a shift in the EC₅₀ for monosodium glutamate. Enhancement was defined as a ratio (EC₅₀R) corresponding to the EC₅₀ of monosodium glutamate, determined in the absence of the test compound, divided by the EC₅₀ of monosodium glutamate, determined in the presence of the test compound. Compounds exhibiting EC₅₀R>2.0 were considered enhancers.

Stated alternatively, “EC₅₀ ratio” as compared to MSG is calculated based on the following definitions:

EC₅₀ Ratio vs. MSG=EC₅₀ (MSG)/EC₅₀ (MSG+[Compound])
wherein “[compound]” refers to the concentration of the compound of Formula (I) used to elicit (or enhance or potentiate) the MSG dose response.

It should be noted that the EC₅₀ ratio measured can depend somewhat on the concentration of the compound itself. Preferred savory enhancers would have a high EC₅₀ Ratio vs. MSG at a low concentration of the compound used. Preferably the EC₅₀ ratio experiments to measure umami enhancement are run at a concentration of a compound of Formula (I) between about 10 μM to about 0.1 μM, or preferably at 1.0 PLM or 3.0 μM.

An EC₅₀ ratio of greater than 1 is indicative of a compound that modulates (potentiates) hT1R1/hT1R3 activity and is a savory enhancer. More preferably, the savory taste enhancer compounds of Formula (I) will have EC₅₀ ratio values of at least 1.2, 1.5, 2.0, 3.0, 4.0, 5.0, 8.0, or 10.0, or even higher.

In one aspect, the extent of savory modulation of a particular compound is assessed based on its effect on MSG activation of T1R1/T1R3 in vitro. It is anticipated that similar assays can be designed using other compounds known to activate the T1R1/T1R3 receptor.

Specific compounds and generic classes of compounds that been shown to modulate hT1R1/hT1R3 based on their EC₅₀ ratios evaluated according to the above formula are identified in the detailed description of the invention, the examples, and the claims.

The procedures used for human taste testing of the umami/savory compounds of Formula (I) are reported hereinbelow. Comparable EC₅₀ assays for activity of the compounds of Formula (I) for sweet receptor agonism and/or sweet taste perception in humans are also reported hereinbelow.

In Vitro hT1R2/hT1R3 Sweet Taste Receptor Activation Assay

An HEK293 cell line derivative (see Chandrashekar, J., Mueller, K. L., Hoon, M. A., Adler, E., Feng, L., Guo, W., Zuker, C. S., Ryba, N. J.,. Cel,l 2000, 100, 703-711.) that stably expresses Gα15 and hT1R2/hT1R3 (see Li, X., Staszewski, L., Xu, H., Durick, K., Zoller, M., Adler, E. Proc Natl Acad Sci USA 2002, 99, 4692-4696, and PCT Publication No. WO 03/001876) was used to identify compounds with sweet taste enhancing properties. These references are hereby incorporated herein by reference for their methods of preparing and maintaing the cell lines discussed below, and for their methods for screeing compounds that inhibit the biological receptors.

Compounds covered in this document were initially selected based on their activity on the hT1R2/hT1R3—HEK293-Gα15 cell line (Li, et al. vide supra). Activity was determined using an automated fluorometric imaging assay on a FLIPR instrument (Fluorometric Intensity Plate Reader, Molecular Devices, Sunnyvale, Calif.) (designated FLIPR assay). Cells from one clone (designated S-9 cells) were seeded into 384-well plates (at approximately 50,000 cells per well) in a medium containing DMEM Low Glucose (Invitrogen, Carlsbad, Calif.), 10% dialyzed fetal bovine serum (Invitrogen, Carlsbad, Calif.), 100 Units/ml Penicillin G, and 100 μg/ml Streptomycin (Invitrogen, Carlsbad, Calif.) (Li, et al. vide supra) see also World Patent No. WO 03/001876 A2). S-9 cells were grown for 24 hours at 37° C. S-9 cells were then loaded with the calcium dye Fluo-3AM (Molecular Probes, Eugene, Oreg.), 4 μM in a phosphate buffered saline (D-PBS) (Invitrogen, Carlsbad, Calif.), for 1 hour at room temperature. After replacement with 25 μl D-PBS, stimulation was performed in the FLIPR instrument and at room temperature by the addition of 25 μl D-PBS supplemented with different stimuli at concentrations corresponding to twice the desired final level. Receptor activity was quantified by determining the maximal fluorescence increases (using a 480 nm excitation and 535 nm emission) after normalization to basal fluorescence intensity measured before stimulation.

For dose-responses analysis, stimuli were presented in duplicates at 10 different concentrations ranging from 60 nM to 30 μM. Activities were normalized to the response obtained with 400 mM D-fructose, a concentration that elicits maximum receptor response. EC50s were determined using a non-linear regression algorithm (using a Senomyx, Inc. software), where the Hill slope, bottom asymptotes and top asymptotes were allow to vary. Identical results were obtained when analyzing the dose-response data using commercially available software for non-linear regression analysis such as GraphPad PRISM (San Diego, Calif.).

In order to determine the dependency of hT1R2/hT1R3 for the cell response to different stimuli, selected compounds were subjected to a similar analysis on HEK293-Gα15 cells (not expressing the human sweet receptor). The HEK293-Gα15 cells do not show any functional response in the FLIPR assay to D-Fructose or any other known sweeteners. Similarly, compounds covered in this document do not induce any functional response when using HEK293-Gα15 cells in the FLIPR assay.

### EXAMPLES

The following examples are given to illustrate a variety of exemplary embodiments of the invention and are not intended to be limiting in any manner.

For the purpose of this document, the compounds individually disclosed in the following Examples 1-17 and corresponding Tables A and B can be referred in shorthand by the number of the example. For example, as shown immediately bellow, Example 1 discloses a synthesis of a particular compound N-(heptan-4-yl)benzo[d][1,3]dioxole-5-carbothioamide, and the results of experimental assays of its biological effectiveness, which compound is and can be referred to herein in shorthand form as Compound 1. Similarly, the first compound illustrated in Table A can be referred to elsewhere herein as Compound A1.

### Example 1

### Umami Compounds

### N-(heptan-4-yl)benzo[d][1,3]dioxole-5-carbothioamide

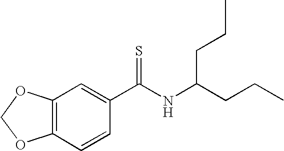

To a solution of 132 mg (0.5 mmol) N-(heptan-4-yl)benzo[d][1,3]dioxole-5-carboxamide (example a) in 5 ml of toluene was added 303 mg (0.75 mmol) of Lawesson reagent and the mixture was stirred at 65° C. overnight. To the cooled mixture 5 ml of toluene was added and a solid was filtered off. The toluene was washed with sat. NaHCO₃, water and dried over MgSO₄. A crude product, obtained following evaporation, was further purified on silica gel to give the title product as a white solid (85 mg, 42%). ¹H NMR (500 MHz, dMSO): δ 0.86-0.90 (t, 6H), 1.29-1.34 (m, 4H), 1.52-1.64 (m, 4H), 4.67-4.70 (m, 1H), 6.08 (s, 2H), 6.93-6.95 (d, 1H), 7.28-7.30 (m, 2H), 9.74-9.76 (d, 1H). MS (M+H, 280.1).

a. N-(heptan-4-yl)benzo[d][1,3]dioxole-5-carboxamide: To a solution of heptan-4-amine (8.06 mL, 54 mmol) in triethylamine (15.3 mL, 108 mmol) and dichloromethane (135 mL), was added, dropwise at 0° C., a solution of benzo[1,3]dioxole-5-carbonyl chloride (10 g, 54 mmol) dissolved in dichloromethane (135 mL). The reaction mixture was stirred for 1 h. Solvent was removed under reduced pressure and the residue was dissolved in EtOAc. The organic layer was washed successively with 1 N aq. HCl, 1 N aq. NaOH, water, brine, dried (MgSO₄) and concentrated. The residue was recrystallized in EtOAc and Hexanes to afford 6.9 g of N-(heptan-4-yl)benzo[d][1,3]dioxole-5-carboxamide (48.3%) as a white solid. ¹H NMR (500 MHz, CDCl₃): δ 0.92 (t, 6H), 1.38 (m, 6H), 1.53 (m, 2H), 4.11 (m, 1H), 5.63 (m, 1H), 6.01 (s, 2H), 7.98 (d, 1H), 7.27 (s, d, 2H). MS(M+H, 264).

The compound had EC₅₀ for activation of a hT1R1/hT1R3 umami receptor expressed in an HEK293 cell line of 8.8 μM, and when present at 0.03 μM enhanced the effectiveness of monosodium glutamate with an EC₅₀ ratio of 3.

### Example 2

### (1-(4-ethoxyphenyl)-3-(2-(pyridin-2-yl)ethyl)thiourea

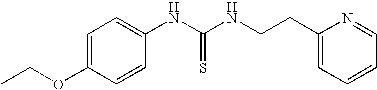

To a solution of 1-ethoxy-4-isothiocyanatobenzene (40 uM, 1 eq) in 1,4-Dioxane (400 uL), was added 2-(pyridin-2-yl)ethanamine (40 uM, 1 eq) in 1,4-dioxane (400 uL). The reaction mixture was shaken at room temperature overnight. Next a 64:36 w/w mixture of PS-NCO (1.63 mmol/g) and PS-trisamine (3.2 mmol/g) was made and 50 mg of the above mixed resins were added to the reaction and the mixture shaken at 50° C. for 5 h. The resulting suspension was cooled down to room temperature and filtered. The solvents were removed under reduced pressure to provide (1-(4-ethoxyphenyl)-3-(2-(pyridin-2-yl)ethyl)thiourea in 32% yield (100% purity by LC/MS).

The compound had EC₅₀ for activation of a hT1R1/hT1R3 umami receptor expressed in an HEK293 cell line of 0.55 μM.

Additional compounds that were synthesized (A1-5, 15-19, 21) or purchased [A6, 7, 8, 10, 13, from Ryan Scientific of Isle of Palms, S.C.; A8 from Aldrich of St. Louis, Mo.; A12 and A14 from ChemBridge of san Diego, Calif.; A11 from Specs/BioSpecs of Delft, The Netherlands; A22 from Princeton BioMolecular Research from Monmouth Junction, N.J.; A23 from ASDI of Newark, Del.], were experimentally tested and found to have a relatively high level of effectiveness as an activator of a hT1R1/hT1R3 umami receptor expressed in an HEK293 cell line. The results of that testing are shown below in Table A.

TABLE A

| | | | | |
|---|---|---|---|---|
| Compound No. | Compound | Umami EC₅₀ (μM) | EC₅₀ ratio (vs. MSG) | @ (μM) |

Umami Compounds

| | | | | |
|---|---|---|---|---|
| A1 | 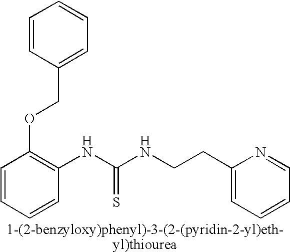 | 1.31 | | |
| A2 | 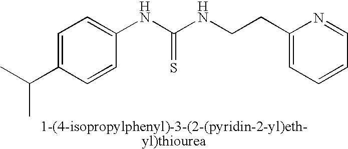 | 1.43 | | |
| A3 | 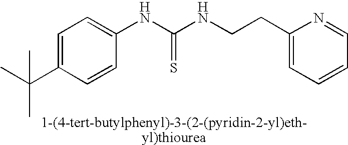 | 1.92 | | |
| A4 | 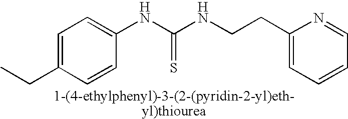 | 1.37 | | |
| A5 | 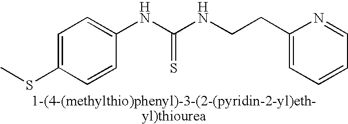 | 3.26 | | |
| A6 | 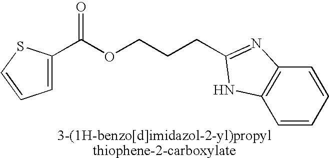 | 3.5 | 4.4 | 3 |
| A7 | 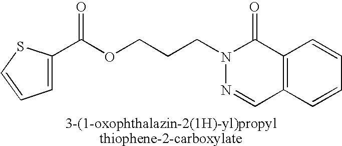 | 6 | 3.8 | 3 |
| A8 | 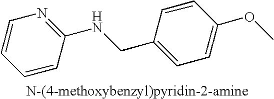 | 11.75 | 3.1 | 1 |
| A9 | 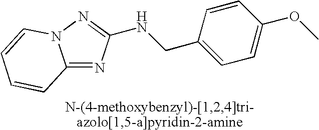 | 11.8 | 3.6 | 3 |
| A10 | 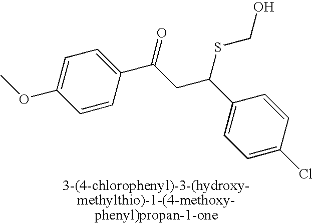 | 6.05 | | |
| A11 | 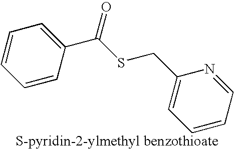 | 6.34 | 6.5 | 3 |
| A12 | 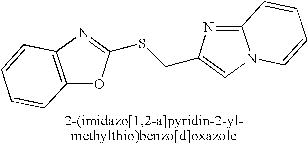 | 5.14 | 2.81 | 1 |
| A13 | 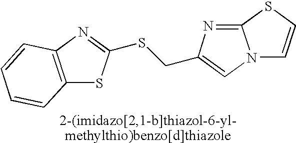 | 5.19 | 3.6 | 3 |
| A14 | 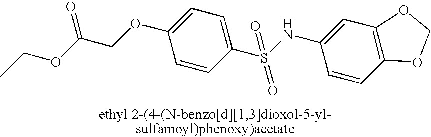 | 14.4 | | |
| A15 | 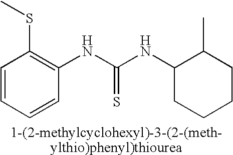 | 3.0 | | |
| A16 | 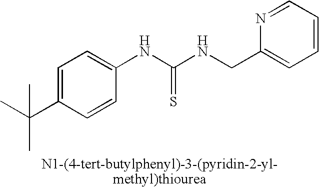 | 3.71 | | |
| A17 | 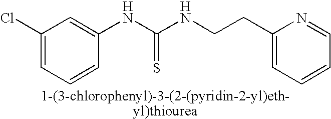 | 4.53 | 4.7 | 1 |
| A18 | 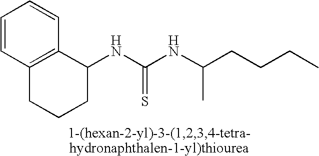 | 7.88 | | |
| A19 | 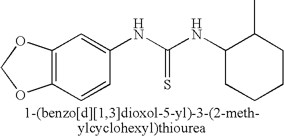 | 13.36 | | |
| A20 | 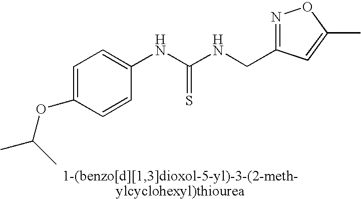 | 11.0 | | |
| A21 | 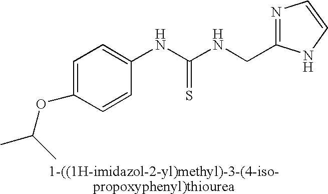 | 14.5 | | |
| A22 | 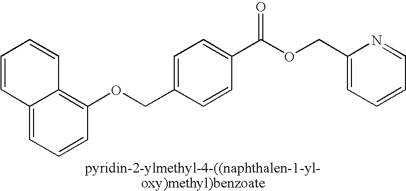 | 3.87 | | |
| A23 | 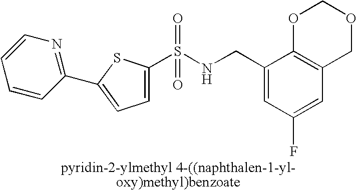 | 10.33 | | |

Umami/Savory Flavor Experiments Using Human Panelists

General Panelist Selection: Basic screening of sensory taste testers: Potential panelists are tested for their abilities to rank and rate intensities of solutions representing the five basic tastes. Panelists rank and rate intensity of five different concentrations of each of the five following compounds: sucrose (sweet), sodium chloride (salty), citric acid (sour), caffeine (bitter), and monosodium glutamate (savory). In order to be selected for participation in testing, panelists need to correctly rank and rate samples for intensity, with a reasonable number of errors.

Preliminary Taste Tests: The panelists selected in the above procedure are deemed qualified for performing Preliminary Taste Testing procedures. The preliminary taste tests are used to evaluate new compounds for intensity of basic tastes and off-tastes. A small group of panelists (n=5) taste approximately 5 concentrations of the compound (range typically between 1-100 μM, in half-log cycles, e.g., 1, 3, 10, 30, and 100 μM) in water and in a solution of 12 mM MSG to evaluate enhancement. Panelists rate the five basic tastes (sweet, salty, sour, bitter, and savory) as well as off-tastes (such as chemical, metallic, sulfur) on a labeled magnitude scale. Samples are served in 10 mL portions at room temperature. The purpose of the test is to determine the highest concentration at which there is no objectionable off-taste, and determine if obvious savory taste or enhancement of savory taste exists at any of the concentrations tested.

If the compound is effective and does not have objectionable off-tastes, it is tested with a trained (expert panel) in a larger study.

Trained Panelist Selection: A trained expert panel is used to further evaluate compounds that have been tested with the preliminary taste test.

Panelists for the trained panel are selected from the larger group of qualifying taste panelists. Panelists are further trained on savory taste by ranking and rating experiments using MSG and IMP combinations. Panelists complete a series of ranking, rating, and difference from reference tests with savory solutions. In ranking and rating experiments, panelists evaluate easy MSG concentrations (6, 18, 36 mM) and more difficult MSG concentrations (3, 6, 12, 18 mM MSG) in water.

Compound testing with Trained Panel: Compounds tested by the trained panel are evaluated in difference from reference experiments. Panelists are given a reference sample (12 mM MSG+100 μM IMP) and asked to rate samples on a scale of −5 to +5 in terms of difference in savory taste from the reference (score: −5=much less savory taste than the reference; 0=same savory taste as the reference; +5=much more savory taste than the reference). Test samples are solutions with varying amounts of MSG, IMP, and the compound. Typically, each session compares the reference sample to numerous test samples. Tests typically included various samples with varying concentrations of MSG and IMP, as well as one blind sample of the reference itself, to evaluate panel accuracy. Compounds are tested against the reference in samples with and without 12 mM MSG. All samples are presented in 10 ml volumes at room temperature. Two sessions are completed for each compound tested to evaluate panel reproducibility.

Taste Test in Product Prototype: could be done similarly as described above.

Sweet Tastant Compound Examples

Examples of tastant compounds of Formula (I) were synthesized and experimentally tested for effectiveness as activator of a hT1R2/hT1R3 “sweet” receptor expressed in an HEK293 cell line. Examples of the synthesis and biological effectiveness testing in terms of Sweet EC₅₀ measurements for such sweet compounds are listed below.

### Example 3

### 1-(4-Isopropoxyphenyl)-3-(thiophen-3-ylmethyl)thiourea

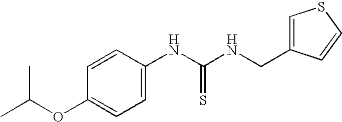

To a solution of 1-isopropoxy-4-isothiocyanatobenzene (example 1a) (193 mg, 1 eq) in acetonitrile (3 mL), was added, thiophen-3-ylmethanamine (97 mg, 1 eq). The reaction mixture was placed in a microwave reactor and was microwaved for 5 minutes at 150° C. The product was purified by reverse phase HPLC. Solvent system: acetonitrile/water (10% to 100% gradient), 10 minutes run. Yield: 52%. ¹H NMR (500 MHz, DMSO): a 1.25 (d, 6H, J: 6 Hz), 4.55 (m, H), 4.67 (d, 2H, J:5.6 Hz), 6.86 (d, 2H, J:6.7 Hz), 7.11 (dd, 1H, J₁:1.3 Hz, J₂:4.93 Hz), 7.19 (d, 2H, J:8.9 Hz), 7.32 (dd, 1H, J₁:0.9 Hz, J₂:2.9 Hz), 7.48 (dd, 1H, J₁:3.0 Hz, J₂:4.9 Hz); 9.35 (br s, 1H). MS(M+H, 307). Melting Point: 80.5-81.5° C.

The compound had EC₅₀ for activation of a hT1R2/hT1R3 sweet receptor of 0.15 μM.

a. 1-isopropoxy-4-isothiocyanatobenzene: To a solution of di(2-pyridyl) thionocarbonate (2.3 g, 1 eq) in dichloromethane (150 mL), was added dropwise a solution of 4-isopropoxybenzenamine (1.5 mL, 1 eq) in dichloromethane (50 mL). The reaction mixture was stirred overnight at room temperature. Solvent was evaporated to give desired product with yield of 70%.

### Example 4

### 1-(furan-3-ylmethyl)-3-(4-isopropoxyphenyl)thiourea

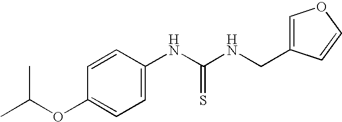

Prepared in a similar manner to example 3 using faran-3-ylmethanamine and 1-isopropoxy-4-isothiocyanatobenzene (example 1a). The product was purified by reverse phase HPLC. Solvent system: acetonitrile/water (10% to 100% gradient), 10 minutes run. Yield: 55%. MS (M+H, 291). Melting point: 89-90° C.

The compound had EC₅₀ for activation of a hT1R2/hT1R3 sweet receptor of 0.23 μM.

### Example 5

### 1-(4-Isopropoxyphenyl)-3-(thiophen-2-ylmethyl)thiourea

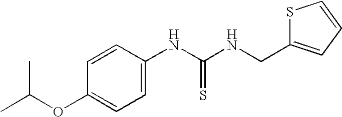

Prepared in a similar manner to example 3 using thiophen-2-ylmethanamine and 1-isopropoxy-4-isothiocyanatobenzene (example 1a). The product was purified by reverse phase HPLC. Solvent system: acetonitrile/water (10% to 100% gradient), 10 minutes run. Yield: 65%. MS (M+H, 307).

The compound had EC₅₀ for activation of a hT1R2/hT1R3 sweet receptor of 0.12 μM.

### Example 6

### 1-(4-Isopropoxyphenyl)-3-(furan-2-ylmethyl)thiourea

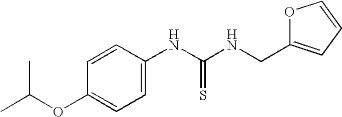

Prepared in a similar manner to Example 3 using furan-2-ylmethanamine and 1-isopropoxy-4-isothiocyanatobenzene (example 1a). The product was purified by reverse phase HPLC. Solvent system: acetonitrile/water (10% to 100% gradient), 10 minutes run. Yield: 50%. MS (M+H, 291).

The compound had EC₅₀ for activation of a hT1R2/hT1R3 sweet receptor of 0.55 μM.

### Example 7

### 1-(4-ethoxyphenyl)-3-(furan-2-ylmethyl)thiourea

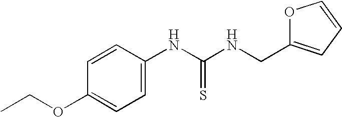

To a solution of 2-(isothiocyanatomethyl)furan (70 mg, 1 eq) in acetonitrile (2 mL), was added 4-ethoxybenzenamine (69 mg, 1 eq). The reaction mixture was placed in a microwave reactor and was microwaved for 5 minutes at 150 C. The product was purified by reverse phase HPLC. Solvent system: acetonitrile/water (10% to 100% gradient), 10 minutes run. Yield: 71% yield. MS(M+H, 277).

The compound had EC₅₀ for activation of a hT1R2/hT1R3 sweet receptor of 1.7 μM.

### Example 8

### 1-(4-ethoxyphenyl)-3-(furan-3-ylmethyl)thiourea

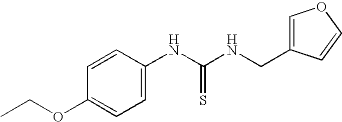

Prepared in a similar manner as Example 7 using 1-ethoxy-4-isocyanatobenzene and furan-3-ylmethanamine. The product was purified by reverse phase HPLC. Solvent system: acetonitrile/water (10% to 100% gradient), 10 minutes run. Yield: 72%. MS(M+H, 277).

The compound had EC₅₀ for activation of a hT1R2/hT1R3 sweet receptor of 0.23 μM.

### Example 9

### 1-(4-sec-Butoxy-phenyl)-3-furan-2-ylmethyl-thiourea

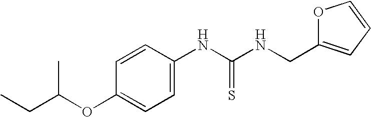

Potassium hydroxide (28 mg, 1 eq) was dissolved in ethanol (2 mL). To the solution, 1-(furan-2-ylmethyl)-3-(4-hydroxyphenyl)thiourea (example 9a) (124 mg, 1 eq) was added. The reaction mixture was placed in a microwave reactor and was microwaved for 5 minutes at 120 C. To this reaction mixture, a solution of 2-iodobutane (100 mg, 1.1 eq) in ethanol (1 mL) was added slowly. The reaction was shaken at 80 C overnight. The product was purified by reverse phase HPLC. Solvent system: acetonitrile/water (10% to 100% gradient), 10 minutes run. Yield: 35% yield. MS(M+H, 305).

The compound had EC₅₀ for activation of a hT1R2/hT1R3 sweet receptor of 5.3 μM.

### a. 1-(furan-2-ylmethyl)-3-(4-hydroxyphenyl)thiourea

Prepared in a similar manner to Example 7 using 2-(isothiocyanatomethyl)furan and 4-aminophenol. Yield: 70%. MS(M+H, 249).

### Example 10

### 1-(furan-3-ylmethyl)-3-(4-isopropylphenyl)thiourea

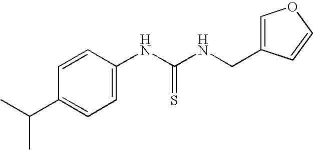

Prepared in a similar manner to example 2 using furan-3-ylmethanamine and 1-isopropyl-4-isothiocyanatobenzene. The product was purified by reverse phase HPLC. Solvent system: acetonitrile/water (10% to 100% gradient), 10 minutes run. Yield: 69%. MS (M+H; 275).

The compound had EC₅₀ for activation of a hT1R2/hT1R3 sweet receptor of 0.75 μM.

### Example 11

### 1-benzyl-3-(4-isopropylphenyl)thiourea

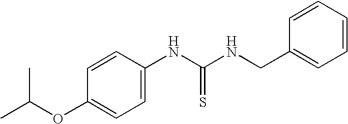

To a solution of 4-isopropoxybenzenamine (76 mg, 1 eq) in dichloromethane (2 mL) was added O-phenyl carbonochloridothioate (86 mg, 1 eq). The reaction was stirred for 5 hours at room temperature. Triethylamine (50 mg, 1 eq) was added into this reaction mixture, followed by phenylmethanamine (54 mg, 1 eq). The reaction was stirred overnight at room temperature. The product was purified by reverse phase HPLC. Solvent system: acetonitrile/water (10% to 100% gradient), 10 minutes run. Yield: 55%. MS (M+H; 301).

The compound had EC₅₀ for activation of a hT1R2/hT1R3 sweet receptor of 1 μM.

### Example 12

### 5-((o-toluidino)methyl)-2-methoxyphenol

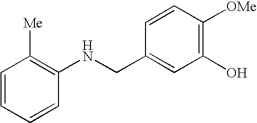

To a solution of 2-methylaniline (1.07 g, 10.0 mmol) and the commercially available aldehyde isovanillin (1.52 g, 10.0 mmol) in dry 1,2-dichloroethane (50 mL) was added NaBH(OAc)₃ (1.5 equiv.) in small portions at RT under argon. The reaction mixture was then stirred at RT under argon overnight. Standard work-up followed by purification by chromatography on silica gel eluting with EtOAc/hexanes (1:4) gave the title compound (2.21 g, 91%) as a white solid. Mp: 104-105° C. ¹H NMR (500 MHz, CDCl₃): δ 2.21 (s, 3H), 3.85 (b, 1H), 3.93 (s, 3H), 4.32 (d, J=4.6 Hz, 2H), 5.70 (s, 1H), 6.66 (d, J=7.4 Hz, 1H), 6.72 (t, J=7.5 Hz, 1H), 6.87 (d, J=7.4 Hz, 1H), 6.93 (dd, J=7.4 Hz, 1.98 Hz, 1H), 7.02 (d, J=1.98 Hz, 1H), 7.12 (d, J=7.5 Hz, 1H), 7.16 (t, J=7.4 Hz, 1H). ¹³C NMR (500 MHz, CDCl₃): δ 17.7, 48.1, 56.2, 110.2, 110.9, 114.0, 117.3, 119.3, 122.1, 127.3, 130.2, 133.0, 146.0, 146.3. MS(MH⁺, 244).

The compound had an EC₅₀ for activation of a hT1R2/hT1R3 sweet receptor expressed in an HEK293 cell line of 2.98 μM.

### Example 13

### 5-((4-fluoro-2-methylphenylamino)methyl)-2-methoxyphenol

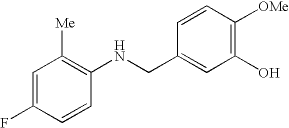

To a solution of 4-fluoro-2-methylaniline (1.25 g, 10.0 mmol) and isovanillin (1.52 g, 10.0 mmol) in dry 1,2-dichloroethane (50 mL) was added NaBH(OAc)₃ (1.5 equiv.) in small portions at RT under argon. The reaction mixture was then stirred at RT under argon overnight. Standard work-up followed by purification by chromatography on silica gel eluting with EtOAc/hexanes (1:4) gave the title compound (2.51 g, 96%) as a white solid. MS(MH⁺, 262).

The compound had an EC₅₀ for activation of a hT1R2/hT1R3 sweet receptor expressed in an HEK293 cell line of 2.29 μM.

### Example 14

### 5-((2,4-difluorophenylamino)methyl)-2-methoxyphenol

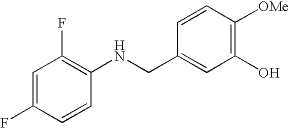

Prepared in a manner similar to that of Examples 12 or 13 using 2,4-difluoroaniline and isovanillin. MS(MH⁺, 266).

The compound had an EC₅₀ for activation of a hT1R2/hT1R3 sweet receptor expressed in an HEK293 cell line of 2.1 μM.

### Example 15

### 2-methoxy-5-((2,4,6-trifluorophenylamino)methyl)phenol

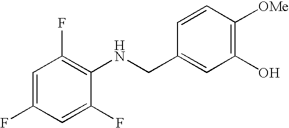

Prepared in a manner similar to that of Examples 12 or 13 using 2,4,6-trifluoroaniline and isovanillin. MS(MH⁺, 284).

The compound had an EC₅₀ for activation of a hT1R2/hT1R3 sweet receptor expressed in an HEK293 cell line of 2.32 μM.

### Example 16

### 5-((2-fluorophenylamino)methyl)-2-methoxyphenol

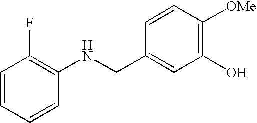

Prepared in a manner similar to that of Examples 12 or 13 using 2-fluoroaniline and isovanillin. MS(MH⁺, 248).

The compound had an EC₅₀ for activation of a hT1R2/hT1R3 sweet receptor expressed in an HEK293 cell line of 2.41 μM.

### Example 17

### 5-((2,5-dimethylphenylamino)methyl)-2-methoxyphenol

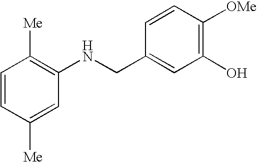

Prepared in a manner similar to that of Examples 12 or 13 using 2,5-dimethylaniline and isovanillin. MS(MH⁺, 258).

The compound had an EC₅₀ for activation of a hT1R2/hT1R3 sweet receptor expressed in an HEK293 cell line of 2.58 μM.

### Example 18

### (R)-3-Ethyl-isoxazole-4-carbothioic acid (5-methoxy-1,2,3,4-tetrahydro-naphthalen-1-yl)-amide

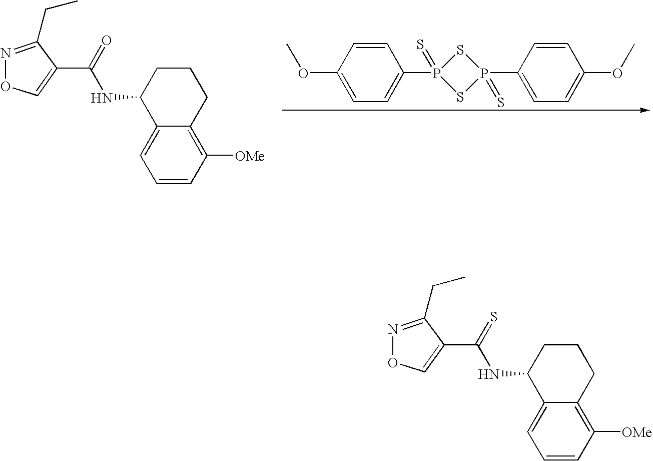

(R)-3-Ethyl-N-(5-methoxy-1,2,3,4-tetrahydronaphthalen-1-yl)isoxazole-4-carboxamide (see Example 18a) is dissolved in toluene and treated with Lawweson's reagent overnight to give (R)-3-Ethyl-isoxazole-4-carbothioic acid (5-methoxy-1,2,3,4-tetrahydro-naphthalen-1-yl)-amide.

a. Preparation of (R)-3-Ethyl-N-(5-methoxy-1,2,3,4-tetrahydronaphthalen-1-yl)isoxazole-4-carboxamide. To a solution of 3-ethylisoxazole-4-carboxylic acid (example b) (30 mg, 0.21 mmol), HOBt (41 mg, 0.30 mmol) and EDCI.HCl (58 mg, 0.30 mmol) dissolved in 2 mL DMF, was added (R)-5-methoxy-1,2,3,4-tetrahydronaphthalen-1-amine (example d) (53 mg, 0.30 mmol). The reaction was stirred at rt for 24 h, at which time it was concentrated in vacuo and purified by preparative TLC (10:1 Hex:EtOAc) to provide (R)-3-Ethyl-N-(5-methoxy-1,2,3,4-tetrahydronaphthalen-1-yl)isoxazole-4-carboxamide as a white solid. ¹H NMR (400 MHz, CD₃OD): δ 1.30 (t, 3H, J=7.20 Hz), 1.84 (m, 2H), 1.97 (m, 2H), 2.68 (m, 2H), 2.96 (q, 2H, J=7.60 Hz), 3.81 (s, 3H), 5.21 (m, 1H), 6.80 (d, 1H, J=7.60 Hz), 6.85 (d, 1H, J=7.60 Hz), 7.14 (d, 1H, J=8.00 Hz), 8.98 (s, 1H). MS(M+H, 301).

b. Preparation of 3-ethylisoxazole-4-carboxylic acid: To a solution of ethyl 3-ethylisoxazole-4-carboxylate (example c) (422 mg, 2.49 mmol) in 2 mL of 1:1 EtOH:H₂O, was added NaOH (110 mg, 2.74 mmol). The reaction was stirred at rt for 24 h, at which time it was neutralized with 1N HCl, extracted with EtOAc, dried over MgSO₄, filtered and concentrated in vacuo to yield a white solid carried onto next step without further purification.

c. Preparation of ethyl 3-ethylisoxazole-4-carboxylate: To a solution was prepared by the method of McMurry, J. E.; Org. Syn. Coll. Vol. 6, 781, of ethyl 3-(pyrrolidin-1-yl)acrylate (2.0 g, 11.8 mmol), Et₃N (4.7 mL) and nitropropane (1.38 mL, 15.4 mmol) in 12 mL CHCl₃ at 0° C., was added a solution of POCl₃ (1.21 mL, 13.00 mmol) in 2.5 mL CHCl₃ via addition funnel over 3 h. Upon complete addition of POCl₃ mixture, the reaction was warmed to rt, stirred for 20 h and quenched with H₂O. The organic layer was separated and washed successively with 1N HCl, 5% NaOH and brine. The resulting solution was dried over MgSO₄, filtered, concentrated in vacuo and purified by flash-column chromatography (4:1 Hex:EtOAc) to yield ethyl 3-ethylisoxazole-4-carboxylate as a white solid (1.43 g, 72%). ¹H NMR (500 MHz, DMSO-d₆): δ 1.21 (t, 3H, J=7.62 Hz), 1.28 (t, 3H, J=7.30 Hz), 2.85 (q, 2H, J=7.47 Hz), 4.26 (q, 2H, J=6.98 Hz), 9.51 (s, 1H). ³C NMR (125 MHz, DMSO-d₆): δ 11.9, 14.0, 18.5, 60.5, 79.1, 160.8, 162.7, 164.7, 164.8.

d. Preparation of (R)-5-methoxy-1,2,3,4-tetrahydronaphthalen-1-amine: To a solution of (S)-2-((R)-5-methoxy-1,2,3,4-tetrahydronaphthalen-1-ylamino)-2-phenylethanol (example e) (3.22 g, 10.83 mmol) in 70 mL of MeOH at 0° C. were added methylamine (7.5 mL, 40% solution in H₂O) and periodic acid (6.4 g, 28.15 mmol, in 50 mL H₂O). The reaction mixture was stirred at rt for 4 h, at which time it was extracted with ether. To the combined ether extracts was added 30 mL of 2N HCl, and the biphasic mixture was stirred for 30 min, concentrated in vacuo, and the remaining aqueous phase was washed with ether, basified with 6 N NaOH solution at 0° C., extracted with ether, dried over K₂CO₃, filtered and concentrated in vacuo to yield 1.72 g of crude (R)-5-methoxy-1,2,3,4-tetrahydronaphthalen-1-amine (90%), carried onto the next step without further purification.

e. Preparation of (S)-2-((R)-5-methoxy-1,2,3,4-tetrahydronaphthalen-1-ylamino)-2-phenylethanol: To a solution of NaBH₄ (781 mg, 20.63 mmol), dissolved in 40 mL anhydrous THF under Ar at 0° C., was added glacial acetic acid (3.48 mL, 60.10 mmol) dropwise. The mixture was stirred at 0° C. for 15 min or until the gas evolution was complete. A solution of (S)-2-(5-methoxy-3,4-dihydronaphthalen-1(2H)-ylideneamino)-2-phenylethanol (example f) (5.3 g, 17.94 mmol) dissolved in 25 mL anhydrous THF was added to the NaBH(OAc)₃ mixture, and the reaction was stirred for 3 h at 0° C. Upon completion, the reaction was quenched by addition of sat'd K2CO3, diluted with EtOAc, and the organic layer was dried over MgSO4, filtered, concentrated in vacuo and purified by flash-column chromatography (15-25% EtOAc in Hex) to yield (S)-2-((R)-5,7-dimethyl-1,2,3,4-tetrahydronaphthalen-1-ylamino)-2-phenylethanol as a white waxy solid (3.22 g, 60% from tetralone). ¹H NMR (500 MHz, CDCl₃): δ 1.70 (m, 3H), 1.84 (m, 1H), 2.51 (m, 1H), 2.74 (m, 1H), 3.50 (dd, 1H, J=10.73, 7.95 Hz), 3.71 (dd, 1H, J=10.76, 4.67 Hz), 3.77 (m, 1H), 3.81 (s, 3H), 3.99 (dd, 1H, J=7.95, 4.60 Hz), 6.72 (d, 1H, J=7.98 Hz), 6.96 (d, 1H, J=7.70 Hz), 7.15 (t, 1H, J=7.90 Hz), 7.29 (m, 1H), 7.36 (m, 4H). MS(M+H, 298).

f. Preparation of (S)-2-(5-methoxy-3,4-dihydronaphthalen-1(2H)-ylideneamino)-2-phenylethanol: To a 50 mL round-bottom flask equipped with a Dean-Stark trap and reflux condenser were added 5-methoxy tetralone (3.7 g, 21.0 mmol), (S)-phenylglycinol (3.17 g, 23.1 mmol), toluenesulfonic acid monohydrate (200 mg, 1.05 mmol) and xylenes (40 mL). The reaction was refluxed overnight, cooled to rt, diluted with toluene and washed successively with sat'd NaHCO₃ (1×), H₂O (5×) and brine (1×). The resulting solution was dried over MgSO₄, filtered, concentrated in vacuo and carried onto the next step without further purification.

### Example 19

### 1-((1H-pyrrol-2-yl)methyl)-3-(4-isopropoxyphenyl)thiourea

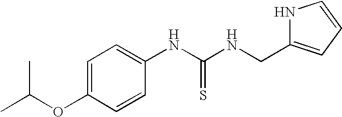

To a solution of (1H-pyrrol-2-yl)methanamine (Example 19a) (0.5 g, 5.2 mmol, 1 eq) in acetonitrile (100 mL) was added slowly at room temperature 1-isopropoxy-4-isothiocyanatobenzene (Example 19b) dissolved in acetonitrile (50 mL). The reaction was stirred overnight at room temperature. The solvent was evaporated under vacuum and the crude reaction was disolved in ethyl acetate and washed with water and brine. The organic solution was dried over sodium sulfate, filtered and evaporated under vacuum. The residue was purified by column chromatography on silica gel (Eluent: 20 to 30% ethyl acetate in hexane) and crystallized twice, in dichloromethane/hexanes first and then in water/ethanol. Yield: 30%. Mp: 135-137. Analytical: M+1: 290, found: 290. H¹ NMR(400 MHz, CdCl₃): δ 1.34 (d, 6H, J: 6 Hz), 4.55 (m, H), 4.76 (d, 2H, J:6.4 Hz),_{—}5.97 (br s, 1H), 6.06 (dd, 1H, J₁:6.4 Hz, J₂:3.2 Hz), 6.24(t, 1H, J:5.2 Hz), 6.74 (dd, 1H, J₁:4 Hz, J₂:2.4 Hz), 6.89 (dd, 2H, J₁:6.8 Hz, J₂:2.4 Hz), 7.08 (dd, 2H, J₁:8.8 Hz, J₂:2.4 Hz), 7.62 (br s, 1H); 9.66 (br s, 1H).

The compound had EC₅₀ for activation of a hT1R2/hT1R3 sweet receptor of 0.025 μM.

a. Preparation of (1H-pyrrol-2-yl)methanamine: To a solution of 1-H-pyrrole-2-carbonitrile (10 mmol, 1 eq) in THF (100 mL), was added dropwise borane in THF (1M solution, 30 mmol, 3 eq). The reaction mixture was refluxed overnight. After cooling to room temperature a solution of 6M HCl was added dropwise until bubbles disappeared and the reaction mixture was refluxed for 3 hours. After cooling to room temperature the reaction mixture was washed with ether twice. The aqueous layer was collected and cooled down to 0° C. in an ice bath. 12M NaOH was added dropwise to the aqueous layer until pH ˜8. The aqueous layer was saturated with potassium carbonate and the product was extracted with dichloromethane. The organic layer was dried down over sodium sulfate, filtered and evaporated under reduced pressure to give (1H-pyrrol-2-yl)methanamine. Yield: 76%.

### Example 19b

### Preparation of 1-isopropoxy-4-isothiocyanatobenzene

To a solution of 4-isopropoxybenzenamine (16.5 mmol, 1 eq) in dichloromethane (150 mL), was added a solution of di-2-pyridiyl thionocarbonate (16.5 mmol, 1 eq). The reaction was stirred at room temperature for 3 hours and the solvent evaporated under vacuum. The residue was disolved in ethyl acetate and washed with water and brine, dried over sodium sulfate, filtered and evaporated to give crude 1-isopropoxy-4-isothiocyanatobenzene use as this in the next step. Yield: 80%

Other tastant compounds of Formula (1) were also synthesized (B1-8, 10-28, 30-41) or purchased (B29, 43, 44, 47, 49 from Ryan Scientific of Isle of Palms, S.C.; B45 from Asinex of Moscow, Russia; B46, 48 from Chem Div of San Diego, Calif.; B42 from Princeton BioMolecular Research of Monmouth Junction, N.J.) and experimentally tested for effectiveness as activator of a hT1R2/hT1R3 “sweet” receptor expressed in an HEK293 cell line. The results of that testing are shown below in Table B.

| Compound No. | Compound | Sweet EC₅₀ μM |
|---|---|---|
| B1 | 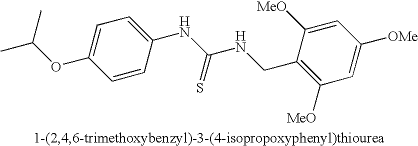 | 0.26 |
| B2 | 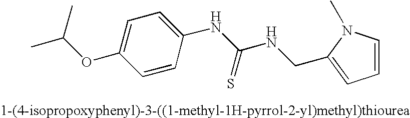 | 2.59 |
| B3 | 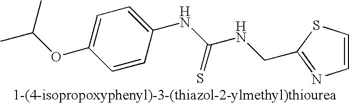 | 1.38 |
| B4 | 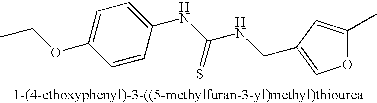 | 1.44 |
| B5 | 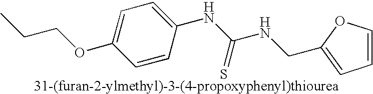 | 1.51 |
| B6 | 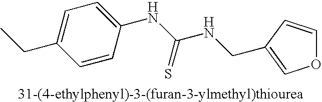 | 1.88 |
| B7 | 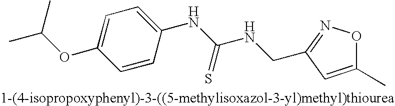 | 1.89 |
| B8 | 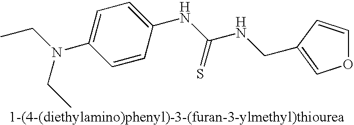 | 4.09 |
| B9 | 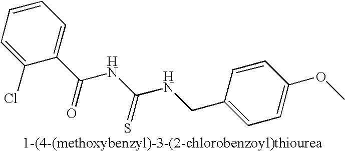 | 4.9 |
| B10 | 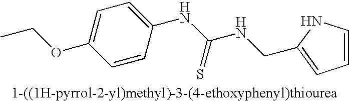 | 0.16 |
| B11 | 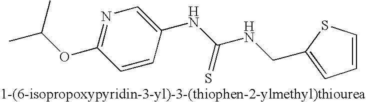 | 0.22 |
| B12 | 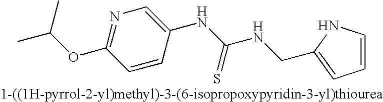 | 0.34 |
| B13 | 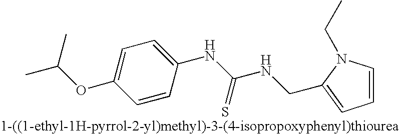 | 1.29 |
| B14 | 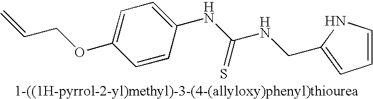 | 0.16 |
| B15 | 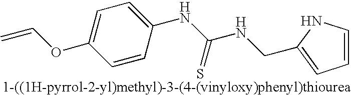 | 0.18 |
| B16 | 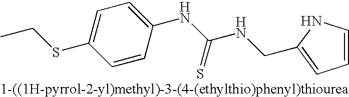 | 0.21 |
| B17 | 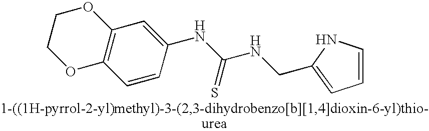 | 0.31 |
| B18 | 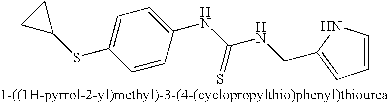 | 0.41 |
| B19 | 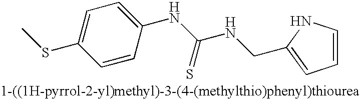 | 0.43 |
| B20 | 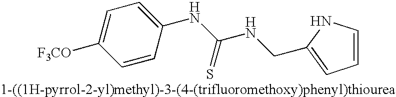 | 0.59 |
| B21 | 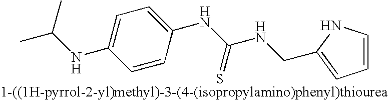 | 0.63 |
| B22 | 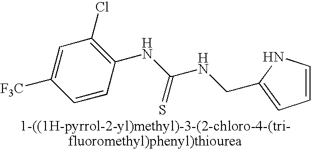 | 0.67 |
| B23 | 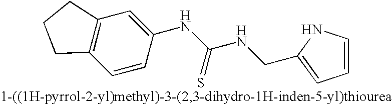 | 0.79 |
| B24 | 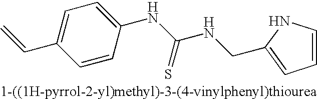 | 0.87 |
| B25 | 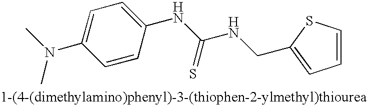 | 1.50 |
| B26 | 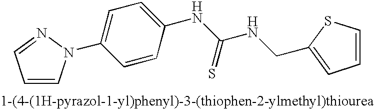 | 1.53 |
| B27 | 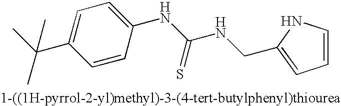 | 1.71 |
| B28 | 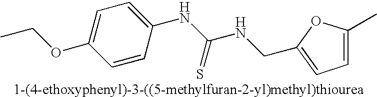 | 1.91 |
| B29 | 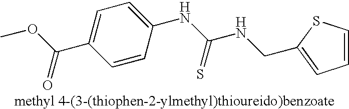 | 2.94 |
| B30 | 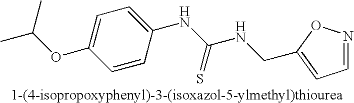 | 3.86 |
| B31 | 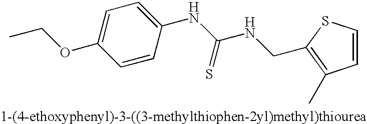 | 4.16 |
| B32 | 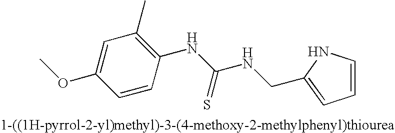 | 5.19 |
| B33 | 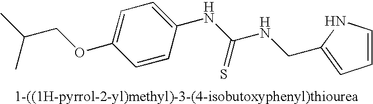 | 5.56 |
| B34 | 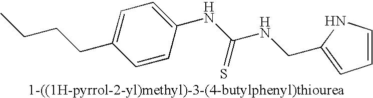 | 5.96 |
| B35 | 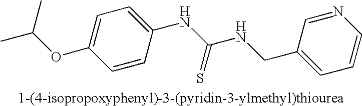 | 6.71 |
| B36 | 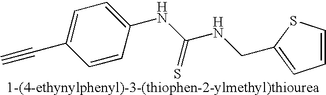 | 7 |
| B37 | 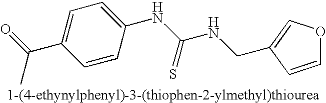 | 7.45 |
| B38 | 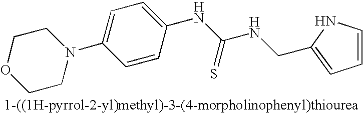 | 8.17 |
| B39 | 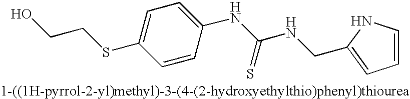 | 8.5 |
| B40 | 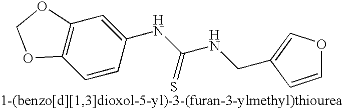 | 11.56 |
| B41 | 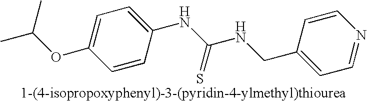 | 14.24 |
| B42 | 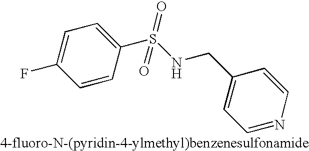 | 6.5 |
| B43 | 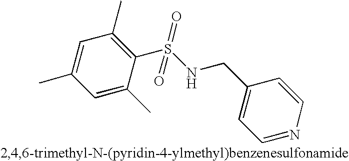 | 0.76 |
| B44 | 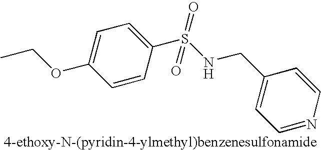 | 0.93 |
| B45 | 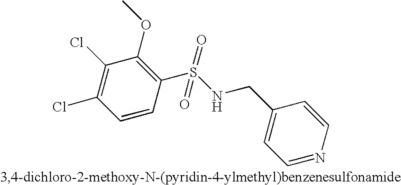 | 2.18 |
| B46 | 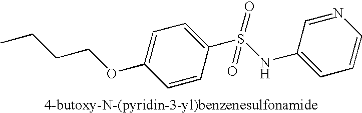 | 2.19 |
| B47 | 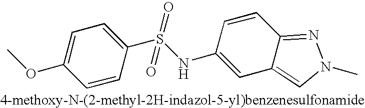 | 2.94 |
| B48 | 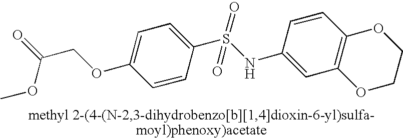 | 7.97 |
| B49 | 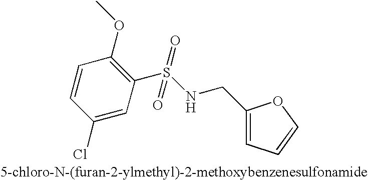 | 8 |

Sweet Flavor and Sweet Flavor Enhancement Measurement Using Human Panelists

Purpose: To investigate the intensity of various tastes and off-tastes of an experimental compound. To determine the maximum concentration of the experimental compound that does not elicit an undesirable characteristic or off-taste.

Overview: Various concentrations of the experimental compound (normally aqueous solutions containing 1, 3, 10, and 30 uM concentrations of the experimental compound; and optionally 50 uM and/or 100 uM concentrations) are individually tasted by trained human subjects and rated for intensity of several taste attributes. The experimental compound may also be tasted when dissolved in a “key tastant” solution.

Procedure: An appropriate quantity of the experimental compound is dissolved in water typically also containing 0.1% ethanol, which is utilized to aid initial dispersion of the compound in the aqueous stock solution. When appropriate, the experimental compound may also be dissolved in aqueous solutions of a “key tastant” (for example, 4% sucrose, 6% sucrose, 6% fructose/glucose, or 7% fructose/glucose, at pH 7.1 or 2.8).

Five human Subjects are used for preliminary taste tests. The Subjects have a demonstrated ability to taste the desired taste attributes, and are trained to use a Labeled Magnitude Scale (LMS) from 0 (Barely Detectible Sweetness) to 100 (Strongest Imaginable Sweetness). Subjects refrain from eating or drinking (except water) for at least 1 hour prior to the test. Subjects eat a cracker and rinse with water four times to clean the mouth before taste tests.

The aqueous solutions are dispensed in 10 ml volumes into 1 oz. sample cups and served to the Subjects at room temperature. Samples of the experimental compound dissolved in an appropriate key tastant (e.g., 4% sucrose, 6% fructose, or 6% fructose/glucose, typically at pH 7.1) at various concentrations of the experimental compound may also be served to the Subjects. Subjects also receive a reference sample of the key tastant (e.g., sucrose, fructose, or fructose/glucose, typically at pH 7.1) at different concentrations for comparison.

Subjects taste the solutions, starting with the lowest concentration, and rate intensity of the following attributes on the Labeled Magnitude Scale (LMS) for sweetness, saltiness, sourness, bitterness, savory (umami), and other (off-taste). Subjects rinse three times with water between tastings. If a particular concentration elicits an undesirable characteristic or off-taste, subsequent tastings of higher concentrations are eliminated. After a break, Subjects taste a solution of the key tastant (e.g., 4% sucrose, 6% fructose, or 6% fructose/glucose, typically at pH 7.1) without the experimental compound. Then solutions of the key tastant plus experimental compound are tasted in increasing order of concentration. The key tastant solution can be retasted for comparison with key tastant+experimental compound solutions if necessary. Discussion among panelists is permitted.

The maximum concentration of an experimental compound that does not elicit an objectionable characteristic or off-taste is the highest concentration that a particular compound will be tested at in subsequent sensory experiments. To confirm preliminary test results, the test may be repeated with another small group of panelists.

The preliminary profiling test is always the first test performed on a new experimental compound. Depending on the results of the preliminary profiling test, additional more quantitative tests may be performed to further characterize the experimental compound.

“Difference from Reference” Human Taste Test Procedures

Purpose: To determine how the intensity of a test sample of an experimental compound differs from that of a reference sample in terms of sweetness. This type of study requires a larger panel (typically 15-20 Subjects) in order to obtain statistically significant data.

Overview: A group of 10 or more panelists taste pairs of solutions where one sample is the “Reference” (which typically does not include an experimental compound and is an approved substance or Generally Recognized As Safe (GRAS) substance, i.e., a sweetener) and one sample is the “Test” (which may or may not include an experimental compound). Subjects rate the difference in intensity of the test sample compared to the reference sample for the key attribute on a scale of −5 (much less sweet than the reference) to +5 (much more sweet than the reference). A score of 0 indicates the test sample is equally as sweet as the reference.

Procedure: Ten or more Subjects are used for the “Difference from Reference” tests. Subjects have been previously familiarized with the key attribute taste and are trained to use the −5 to +5 scale. Subjects refrain from eating or drinking (except water) for at least 1 hour prior to the test. Subjects eat a cracker and rinse with water four times to clean the mouth.

Test solutions can include the experimental compound in water, the experimental compound plus a key tastant (e.g., 4% sucrose, 6% sucrose, 6% fructose, 6% fructose/glucose, or 7% fructose/glucose, at pH 7.1 or 2.8), and a range of key tastant only solutions as references.

Samples of the key tastant without the experimental compound are used to determine if the panel is rating accurately; i.e., the reference is tested against itself (blind) to determine how accurate the panel is rating on a given test day. The solutions are dispensed in 10 ml volumes into 1 oz. sample cups and served to the Subjects at room temperature.

Subjects first taste the reference sample then immediately taste the test sample and rate the difference in intensity of the key attribute on the Difference from Reference scale (−5 to +5). All samples are expectorated. Subjects may retaste the samples but can only use the volume of sample given. Subjects must rinse at least twice with water between pairs of samples. Eating a cracker between sample pairs may be required depending on the samples tasted.

The scores for each test are averaged across Subjects and standard error is calculated. Panel accuracy can be determined using the score from the blind reference test. ANOVA and multiple comparison tests (such as Tukey's Honestly Significant Difference test) can be used to determine differences among pairs, provided the reference sample is the same among all tests. If the identical test pair is tested in another session, a Student's t-test (paired, two-tailed; alpha=0.05) can be used to determine if there is any difference in the ratings between sessions.

A number of different reference sweeteners have been utilized for the measurement of sweet taste enhancement. For example, a reference sample consisting of 4% sucrose can be used, which has a greater than the threshold level sweetness (i.e., 2% sucrose), and a sweetness in the region of sweet taste perception where human subjects are most sensitive to small changes in sweet taste perception. A 50:50 mix of fructose: glucose can be used to better model high fructose corn syrup solutions commonly utilized in the beverage industry. A 6% fructose/glucose mixture is approximately equal in sweet taste perception as 6% sucrose, which is also within the range where panelists are sensitive to small changes in sweet taste perception. After initial studies in 6% fructose/glucose at pH 7.1, studies shift to evaluating the performance of the compound in a product prototype more similar to a cola beverage, i.e. higher concentrations of sweetener and lower pH.

The results of some human taste tests of the compounds of the invention in aqueous compositions intended to model the composition of a carbonated beverage are shown below in Table F.

TABLE C
Sweet Taste Test Results

| | Contents | | Perceived Equivalent |
|---|---|---|---|
| Compound No. | of Solution | pH | Sweet Solution |
| 19 | 20 uM Compound | 7.1 | Greater or equal to 8% but less |
| | 19 + 6% | | or equal to 9% fructose/glucose |
| | fructose/glucose | | |

### Example 20

### Soup Preparation Using an Ethanol Stock Solution

A compound of the invention is diluted using 200 proof ethanol to 1000× the desired concentration in soup. The compound can be sonicated and heated (if stable) to ensure complete solubility in ethanol. The soup from bouillon base is made by adding 6 g of vegetable bouillon base in 500 mL of hot water in a glass or stoneware bowl. The water is heated to 80° C. The concentration of MSG in the dissolved bouillon is 2.2 g/L and there is no IMP added. After the bouillon base is dissolved, the ethanol stock solution is added to the soup base. For 500 mL of soup, 0.5 mL of the 1000× ethanol stock is added for a final ethanol concentration of 0.1%. If the ethanol interferes with the taste of the soup, a higher concentration of ethanol stock solution can be prepared provided the compound is soluble.

### Example 21

### Chip Preparation

A salt mixture of a compound of the invention is made by mixing with salt such that a 1.4% of the salt mixture added w/w to chips would result in the desired concentration of the compound. For 1 ppm final of the compound on chips, 7 mg of the compound is mixed with 10 g of salt. The compound is ground using a mortar and pestle with the salt and the compound and salt are mixed well. The chips are broken into uniform small pieces by using a blender. For each 98.6 g of chips, 1.4 g of the salt mixture is weighed out. The chip pieces are first heated in a microwave for 50 seconds or until warm. The pieces are spread out on a large piece of aluminum foil. The salt mixture is spread evenly over the chips. The chips are then placed in a plastic bag making sure that all the salt is place in the bag as well. The salt mixture and chips are then shaken to ensure that the salt is spread evenly over the chips.

### Example 22

### Cookie Preparation

A compound of the invention is diluted using 200 proof ethanol to 1000× the desired concentration in the final product. The compound can be sonicated and heated (if stable) to ensure complete solubility in ethanol. The solution containing the compound of the invention is then mixed with other liquid ingredients (i.e., water, liquid egg, and flavorings) until well blended. The mixture is blended with a dry emulsifier such as lecithin and further blended with shortening. The shortening is blended with dry components (i.e., flour, sugar, salt, cocoa) which have been well mixed. Dough is portioned out onto a baking sheet, and baked at desired temperature until done.

### Example 23

### Juice Preparation

A compound of the invention is diluted using 200 proof ethanol to 1000× the desired concentration in juice. The compound is further blended with the alcohol component of natural and/or artificial flavors to make a “key”. The flavor key is blended with a portion of juice concentrate to assure homogeneity. The remainder of the juice concentrate is diluted with water and mixed. Sweeteners, such as HFCS (High Fructose Corn Syrup), aspartame, or sucralose, are mixed in and blended. The flavor/compound portion is added as a final step, and blended.

### Example 24

### Spicy Tomato Juice or Bloody Mary Mix

A compound of the invention is added as a dry ingredient to a spice blend, which may optionally include monosodium glutamate, and blended thoroughly. Spice blend is dispersed into a portion of tomato paste, blended, and that blended paste is further blended into the remaining paste. The paste is then diluted with water to make spicy tomato juice or Bloody Mary mix, which may optionally be processed at high temperature for a short time.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

We claim:

1. A flavor modified comestible or medicinal composition comprising:
a) at least one comestible product, or one or more precursors thereof, and
b) at least a savory flavor modulating amount or a sweet flavor modulating amount of one or more non-naturally occurring tastant compounds having the Formula: 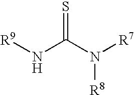
wherein:
i) R⁹ and R⁷ are independently selected from organic radicals comprising from three to sixteen carbon atoms and optionally 1 to 10 heteroatoms independently selected from oxygen, nitrogen, sulfur, fluorine, chlorine, or phosphorus; and
ii) R⁸ is hydrogen or an organic radical comprising from three to sixteen carbon atoms, and optionally 1 to 10 heteroatoms independently selected from oxygen, nitrogen, sulfur, fluorine, chlorine, or phosphorus; and
iii) wherein the tastant compound has a molecular weight of 500 grams per mole or less;
or a comestibly acceptable salt thereof.

2. The comestible or medicinal composition of claim 1 wherein the tastant compound has an EC₅₀ for the hT1R1/hT1R3 umami receptor of less than about 30 μM.

3. The comestible or medicinal composition of claim 1 wherein the tastant compound has an EC₅₀ for binding an hT1R2/hT1R3 sweet receptor of less than about 30 μM.

4. The comestible or medicinal composition of claim 1 wherein R⁷, R⁸, and/or R⁹ each independently comprise 0, 1, 2, 3, 4, or 5 heteroatoms independently selected from oxygen, nitrogen, sulfur, fluorine, or chlorine.

5. The comestible or medicinal composition of claim 1 wherein R⁸ is hydrogen.

6. The comestible or medicinal composition of claim 5 wherein the organic radicals are independently selected from arylalkenyl, heteroarylalkenyl, arylalkyl, heteroarylalkyl, alkyl, alkoxy-alkyl, alkenyl, cycloalkyl, cycloalkenyl, aryl and heteroaryl groups, each of which may be optionally substituted with 1, 2, or 3 substituent groups independently selected from the group consisting of hydroxyl, NH₂, SH, SO₃H, PO(OH)₂, NO₂, halogen, and a C₁-C₈ organic radical.

7. The comestible or medicinal composition of claim 6 wherein the substituent groups are independently selected from hydroxyl, NH₂, SH, halogen, C₁-C₄ alkyl, C₁-C₄ haloalkyl, C₁-C₄ haloalkoxy, C₁-C₄ alkoxyl, C₁-C₄ alkoxy-alkyl, C₁-C₄ hydroxy-alkyl, OH, NH₂, NHR⁶, NR⁶₂, CN, CO₂H, CO₂R⁶, CHO, COR⁶, SH, SR⁶, S(O)R⁶, S(O)₂R⁶, and halogen, wherein R⁶ is C₁-C₄ alkyl.

8. The comestible or medicinal composition of claim 6 wherein the substituent groups are independently selected from hydroxy, fluoro, chloro, NH₂, NHCH₃, N(CH₃)₂, COOCH₃, SCH₃, S(O)CH₃, S(O)₂CH₃, SEt, methyl, ethyl, isopropyl, n-propyl, n-butyl, 1-methyl-propyl, isobutyl, t-butyl, vinyl, trifluoromethyl, methoxy, ethoxy, isopropoxy, and trifluoromethoxy groups.

9. The comestible or medicinal composition of claim 5 wherein R⁹ has the structure: 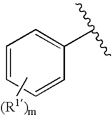
wherein m is 0, 1, 2, or 3, and each R^{1′} is independently selected from the group consisting of hydroxyl, NH₂, SH, SO₃H, PO(OH)₂, NO₂, halogen, and a C₁-C₈ organic radical.

10. The comestible or medicinal composition of claim 9 wherein each R^{1′} is independently selected from the group consisting of hydroxyl, NH₂, SH, halogen, C₁-C₄ alkyl, C₁-C₄ haloalkyl, C₁-C₄ haloalkoxy, C₁-C₄ alkoxyl, C₁-C₄ alkoxy-alkyl, C₁-C₄ hydroxy-alkyl, OH, NH₂, NHR⁶, NR⁶₂, CN, CO₂H, CO₂R⁶, CHO, COR⁶, SH, SR⁶, S(O)R⁶, S(O)₂R⁶, and halogen, wherein R⁶ is C₁-C₄ alkyl.

11. The comestible or medicinal composition of claim 5 wherein R⁹ has the structure: 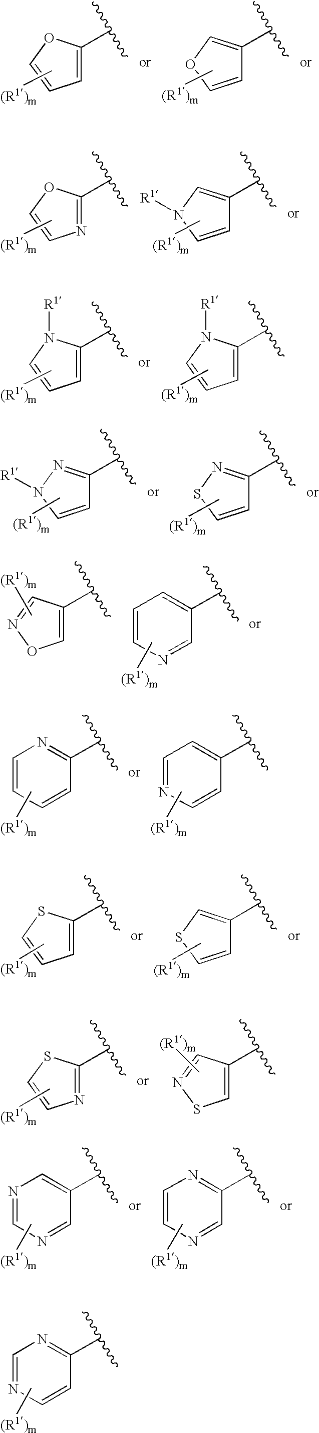
wherein m is 0, 1, 2, or 3, and each R^{1′} is independently selected from of hydroxyl, NH₂, SH, SO₃H, PO(OH)₂, NO₂, halogen, and a C₁-C₈ organic radical.

12. The comestible or medicinal composition of claim 5 wherein R⁷ is a 5 or 6 membered aryl or heteroaryl ring, optionally substituted with 1, 2, 3 or 4 substituent groups independently selected from the group consisting of hydroxyl, NH₂, SH, SO₃H, PO(OH)₂, NO₂, halogen, and a C₁-C₈ organic radical.

13. The comestible or medicinal composition of claim 5 wherein R⁷ is an alkylene substituted heteroaryl ring radical having the structure: 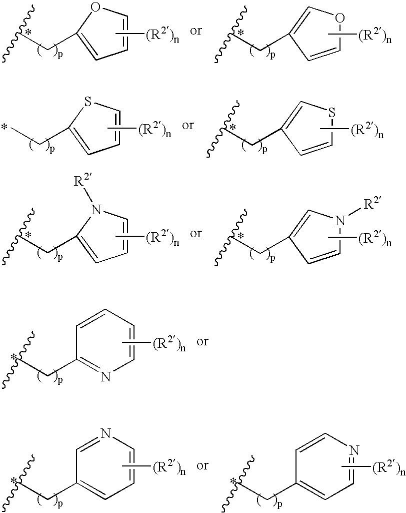
wherein p is 1 or 2; n is 0, 1, or 2, and each R² is independently selected from the group consisting of hydroxyl, NH₂, SH, SO₃H, PO(OH)₂, NO₂, halogen, and a C₁-C₈ organic radical.

14. The comestible or medicinal composition of claim 9 wherein R⁷ is an alkylene substituted heteroaryl ring radical having the structure: 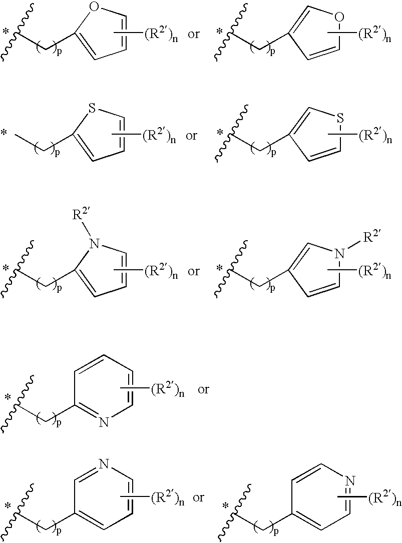
wherein p is 1 or 2; n is 0, 1, or 2, and each R^{2′} is independently selected from the group consisting of hydroxyl, hydroxyl, NH₂, SH, SO₃H, PO(OH)₂, NO₂, halogen, and a C₁-C₈ organic radical.

15. The comestible or medicinal composition of claim 14 wherein the organic radicals are independently selected from the group consisting of hydroxyl, NH₂, SH, halogen, C₁-C₄ alkyl, C₁-C₄ haloalkyl, C₁-C₄ haloalkoxy, C₁-C₄ alkoxyl, C₁-C₄ alkoxy-alkyl, C₁-C₄ hydroxy-alkyl, OH, NH₂, NHR⁶, NR⁶₂, CN, CO₂H, CO₂R⁶, CHO, COR⁶, SH, SR⁶, S(O)R⁶, S(O)₂R⁶, and halogen, wherein R⁶ is C₁-C₄ alkyl.

16. The comestible or medicinal composition of claim 14 wherein the organic radicals are independently selected from the group consisting of hydroxy, fluoro, chloro, NH₂, NHCH₃, N(CH₃)₂, COOCH₃, SCH₃, S(O)CH₃, S(O)₂CH₃, SEt, methyl, ethyl, isopropyl, n-propyl, n-butyl, 1-methyl-propyl, isobutyl, t-butyl, vinyl, trifluoromethyl, methoxy, ethoxy, isopropoxy, and trifluoromethoxy groups.

17. The comestible or medicinal composition of claim 5 wherein R⁷ is an alkylene substituted heteroaryl ring radical having the structure: 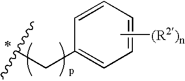
wherein p is 1 or 2; n is 0, 1, or 2, and each R^{2′} is independently selected from the group consisting of hydroxyl, NH₂, SH, SO₃H, PO(OH)₂, NO₂, halogen, and a C₁-C₈ organic radical.

18. The comestible or medicinal composition of claim 9 wherein R⁷ is a 5 or 6 membered aryl or heteroaryl ring, optionally substituted with 1, 2, 3 or 4 substituent groups independently selected from the group consisting of hydroxyl, NH₂, SH, halogen, or a C₁-C₄ organic radical.

19. The comestible or medicinal composition of claim 5 wherein R⁷ is a phenyl ring optionally substituted with 1, 2, 3 or 4 substituent groups independently selected from the group consisting of hydroxyl, NH₂, SH, SO₃H, PO(OH)₂, NO₂, halogen, and a C₁-C₈ organic radical.

20. The comestible or medicinal composition of any one of claims 1, 2, 3, 5, 9, or 13, wherein the one or more non-naturally occurring tastant compounds are present in the modified comestible composition at a concentration from about 0.01 ppm to about 30 ppm.

21. A method for modulating the sweet or savory taste of a comestible or medicinal composition comprising:
a) providing at least one comestible product, or one or more precursors thereof, and
b) combining the comestible product or one or more precursors thereof with at least a savory flavor modulating amount or a sweet flavor modulating amount of the one or more non-naturally occurring tastant compounds of any one of claims 1, 2, 3, 5, 9, or 13, or a mixture thereof, or a comestibly acceptable salt thereof, so as to form the flavor modified comestible or medicinal composition.

22. A flavor modified comestible or medicinal composition comprising:
a) at least one comestible product, or one or more precursors thereof, and
b) at least a savory flavor modulating amount or a sweet flavor modulating amount of one or more non-naturally occurring tastant compounds having the Formula: 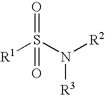
wherein:
i) R¹ and R² are independently selected from organic radicals comprising from three to sixteen carbon atoms and optionally 1 to 10 heteroatoms independently selected from oxygen, nitrogen, sulfur, fluorine, chlorine, or phosphorus; and
ii) R³ is hydrogen or an organic radical comprising from three to sixteen carbon atoms, and optionally 1 to 10 heteroatoms independently selected from oxygen, nitrogen, sulfur, fluorine, chlorine, or phosphorus; and
iii) wherein the tastant compound has a molecular weight of 500 grams per mole or less;
or a comestibly acceptable salt thereof.

23. The comestible or medicinal composition of claim 22 wherein the tastant compound has an EC₅₀ for the hT1R1/hT1R3 umami receptor of less than about 30 μM.

24. The comestible or medicinal composition of claim 22 wherein the tastant compound has an EC₅₀ for binding an hT1R2/hT1R3 sweet receptor of less than about 30 μM.

25. The comestible or medicinal composition of claim 22 wherein R⁷, R⁸, and/or R⁹ each independently comprise 0, 1, 2, 3, 4, or 5 heteroatoms independently selected from oxygen, nitrogen, sulfur, fluorine, or chlorine.

26. The comestible or medicinal composition of claim 22 wherein R³ is hydrogen.

27. The comestible or medicinal composition of claim 26 wherein the organic radicals are independently selected from arylalkenyl, heteroarylalkenyl, arylalkyl, heteroarylalkyl, alkyl, alkoxy-alkyl, alkenyl, cycloalkyl, cycloalkenyl, aryl and heteroaryl groups, each of which may be optionally substituted with 1, 2, or 3 substituent groups independently selected from the group consisting of hydroxyl, NH₂, SH, SO₃H, PO(OH)₂, NO₂, halogen, and a C₁-C₈ organic radical.

28. The comestible or medicinal composition of claim 27 wherein the substituent groups are independently selected from hydroxyl, NH₂, SH, halogen, C₁-C₄ alkyl, C₁-C₄ haloalkyl, C₁-C₄ haloalkoxy, C₁-C₄ alkoxyl, C₁-C₄ alkoxy-alkyl, C₁-C₄ hydroxy-alkyl, OH, NH₂, NHR⁶, NR⁶₂, CN, CO₂H, CO₂R⁶, CHO, COR⁶, SH, SR⁶, S(O)R⁶, S(O)₂R⁶, and halogen, wherein R⁶ is C₁-C₄ alkyl.

29. The comestible or medicinal composition of claim 27 wherein the substituent groups are independently selected from hydroxy, fluoro, chloro, NH₂, NHCH₃, N(CH₃)₂, COOCH₃, SCH₃, S(O)CH₃, S(O)₂CH₃, SEt, methyl, ethyl, isopropyl, n-propyl, n-butyl, 1-methyl-propyl, isobutyl, t-butyl, vinyl, trifluoromethyl, methoxy, ethoxy, isopropoxy, and trifluoromethoxy groups.

30. The comestible or medicinal composition of claim 22 wherein R¹ has the structure: 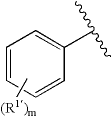
wherein m is 0, 1, 2, or 3, and each R^{1′} is independently selected from the group consisting of hydroxyl, NH₂, SH, SO₃H, PO(OH)₂, NO₂, halogen, and a C₁-C₈ organic radical.

31. The comestible or medicinal composition of claim 30 wherein each R^{1′} is independently selected from the group consisting of hydroxyl, NH₂, SH, halogen, C₁-C₄ alkyl, C₁-C₄ haloalkyl, C₁-C₄ haloalkoxy, C₁-C₄ alkoxyl, C₁-C₄ alkoxy-alkyl, C₁-C₄ hydroxy-alkyl, OH, NH₂, NHR⁶, NR⁶₂, CN, CO₂H, CO₂R⁶, CHO, COR⁶, SH, SR⁶, S(O)R⁶, S(O)₂R⁶, and halogen, wherein R⁶ is C₁-C₄ alkyl.

32. The comestible or medicinal composition of claim 22 wherein R¹ has the structure: 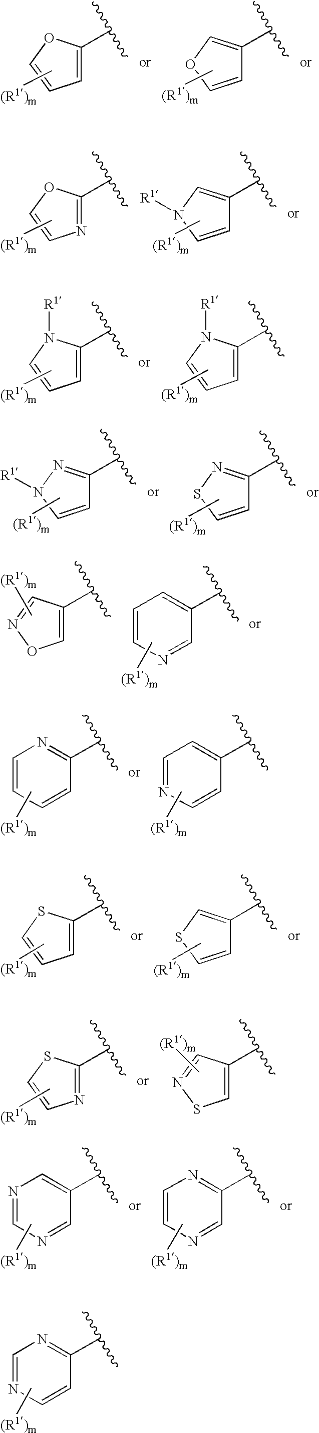
wherein m is 0, 1, 2, or 3, and each R^{1′} is independently selected from of hydroxyl, NH₂, SH, SO₃H, PO(OH)₂, NO₂, halogen, and a C₁-C₈ organic radical.

33. The comestible or medicinal composition of claim 22 wherein R² is a 5 or 6 membered aryl or heteroaryl ring, optionally substituted with 1, 2, 3 or 4 substituent groups independently selected from the group consisting of hydroxyl, NH₂, SH, SO₃H, PO(OH)₂, NO₂, halogen, and a C₁-C₈ organic radical.

34. The comestible or medicinal composition of claim 26 wherein R² is an alkylene substituted heteroaryl ring radical having the structure: 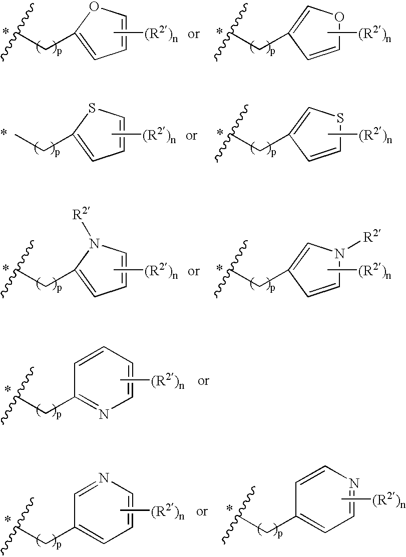
wherein p is 1 or 2; n is 0, 1, or 2, and each R^{2′} is independently selected from the group consisting of hydroxyl, NH₂, SH, SO₃H, PO(OH)₂, NO₂, halogen, and a C₁-C₈ organic radical.

35. The comestible or medicinal composition of claim 30 wherein R² is an alkylene substituted heteroaryl ring radical having the structure: 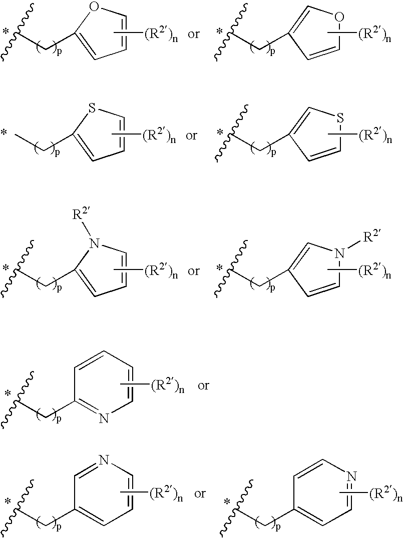
wherein p is 1 or 2; n is 0, 1, or 2, and each R^{2′} is independently selected from the group consisting hydroxyl, NH₂, SH, SO₃H, PO(OH)₂, NO₂, halogen, and a C₁-C₈ organic radical.

36. The comestible or medicinal composition of claim 35 wherein the organic radicals are independently selected from the group consisting of hydroxyl, NH₂, SH, halogen, C₁-C₄ alkyl, C₁-C₄ haloalkyl, C₁-C₄ haloalkoxy, C₁-C₄ alkoxyl, C₁-C₄ alkoxy-alkyl, C₁-C₄ hydroxy-alkyl, OH, NH₂, NHR⁶, NR⁶₂, CN, CO₂H, CO₂R⁶, CHO, COR⁶, SH, SR⁶, S(O)R⁶, S(O)₂R⁶, and halogen, wherein R⁶ is C₁-C₄ alkyl.

37. The comestible or medicinal composition of claim 35 wherein the organic radicals are independently selected from the group consisting of hydroxy, fluoro, chloro, NH₂, NHCH₃, N(CH₃)₂, COOCH₃, SCH₃, S(O)CH₃, S(O)₂CH₃, SEt, methyl, ethyl, isopropyl, n-propyl, n-butyl, 1-methyl-propyl, isobutyl, t-butyl, vinyl, trifluoromethyl, methoxy, ethoxy, isopropoxy, and trifluoromethoxy groups.

38. The comestible or medicinal composition of claim 30 wherein R² is an alkylene substituted heteroaryl ring radical having the structure: 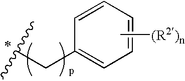
wherein p is 1 or 2; n is 0, 1, or 2, and each R^{2′} is independently selected from the group consisting of hydroxyl, NH₂, SH, SO₃H, PO(OH)₂, NO₂, halogen, and a C₁-C₈ organic radical.

39. The comestible or medicinal composition of claim 26 wherein R² is a 5 or 6 membered aryl or heteroaryl ring, optionally substituted with 1, 2, 3 or 4 substituent groups independently selected from the group consisting of hydroxyl, NH₂, SH, SO₃H, PO(OH)₂, NO₂, halogen, and a C₁-C₈ organic radical.

40. The comestible or medicinal composition of claim 26 wherein R² is a phenyl ring optionally substituted with 1, 2, 3 or 4 substituent groups independently selected from the group consisting of hydroxyl, NH₂, SH, SO₃H, PO(OH)₂, NO₂, halogen, and a C₁-C₈ organic radical.

41. The comestible or medicinal composition of any one of claims 22, 23, 24, 26, 30, 32, or 34, wherein the one or more non-naturally occurring tastant compounds are present in the modified comestible composition at a concentration of from about 0.01 ppm to about 30 ppm.

42. A method for modulating the sweet or savory taste of a comestible or medicinal composition comprising:
a) providing at least one comestible product, or one or more precursors thereof, and
b) combining the comestible product or one or more precursors thereof with at least a savory flavor modulating amount or a sweet flavor modulating amount of the one or more non-naturally occurring tastant compounds of any one of claims 22, 23, 24, 26, 30, 32, or 34, or a mixture thereof, or a comestibly acceptable salt thereof, so as to form the flavor modified comestible or medicinal composition.

43. A method for modulating the sweet or savory taste of a comestible or medicinal product comprising:
a) providing at least one comestible product, or one or more precursors thereof, and
b) combining the comestible product or one or more precursors thereof with at least a savory flavor modulating amount or a sweet flavor modulating amount of one or more non-naturally occurring tastant compounds, or a mixture thereof, or a comestibly acceptable salt thereof, so as to form a modified comestible or medicinal product;
wherein the one or more tastant compounds have Formulas (Ia-k): 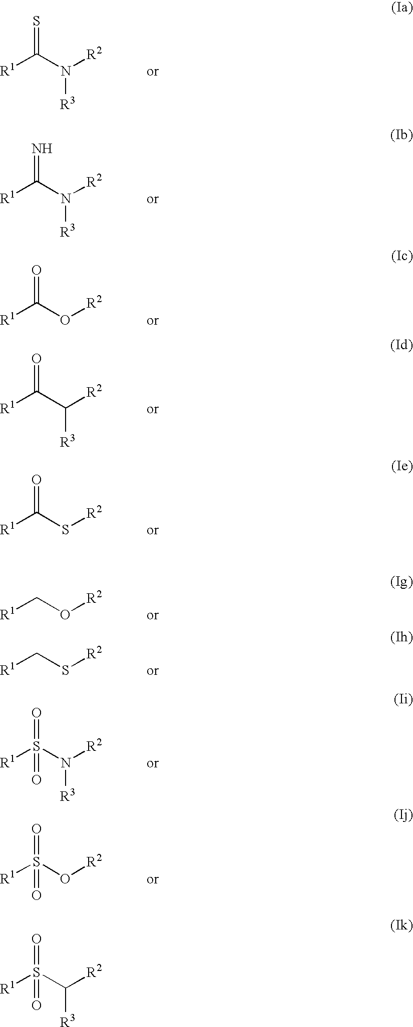
wherein:
i) R¹ is an organic residue having at least three carbon atoms and optionally one to ten heteroatoms independently selected from oxygen, nitrogen, sulfur, halogens, or phosphorus; and
ii) R² an organic residue having at least three carbon atoms and optionally one to ten heteroatoms independently selected from oxygen, nitrogen, sulfur, halogens, or phosphorus;
iii) R³ is hydrogen or an organic residue having at least three carbon atoms and optionally one to ten heteroatoms independently selected from oxygen, nitrogen, sulfur, halogens, or phosphorus; and
wherein the tastant compound has between 10 and 30 carbon atoms and a molecular weight of 500 grams per mole or less;
and wherein the compounds are not erythritol, isomalt, lactitol, mannitol, sorbitol, xylitol, a known natural terpenoid, flavinoid, or protein sweetener, aspartame, saccharin, acesufame-K, a cyclamate, sucralose, alitame, erythritol, or a compound comprising a guanidine residue of the following structure

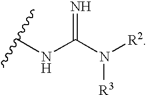

44. The method of claim 43 wherein the tastant compound has the structure: 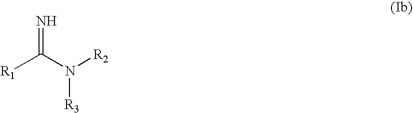
and the tastant compound does not comprise a guanidine residue of the following structure:

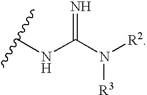

45. The method of claim 43 wherein the tastant compound has the structure:

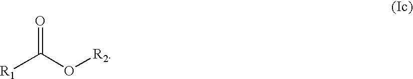

46. The method of claim 43 wherein the tastant compound has the structure:

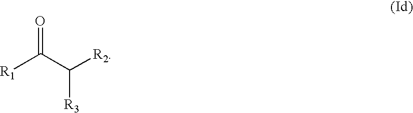

47. The method of claim 43 wherein the tastant compound has the structure:

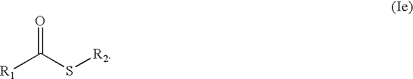

48. The method claim 43 wherein the tastant compound has the structure:

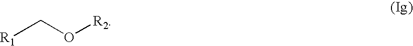

49. The method of claim 43 wherein the tastant compound has the structure:

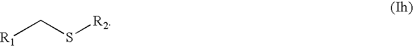

50. The method of claim 43 wherein the tastant compound has the structure:

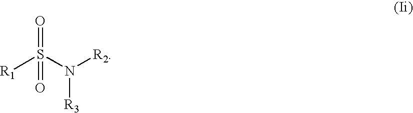

51. The method of claim 43 wherein the tastant compound has the structure:

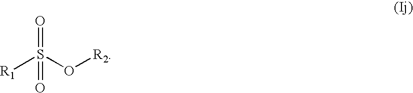

52. The method of claim 43 wherein the tastant compound has the structure:

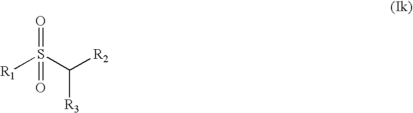

53. The method of claim 43 wherein the tastant compound has an EC₅₀ for the hT1R1/hT1R3 umami receptor of less than about 30 μM.

54. The method of claim 43 wherein the tastant compound has an EC₅₀ for binding an hT1R2/hT1R3 sweet receptor of less than about 30 μM.

55. The method of claim 43 wherein the tastant compound is present modified comestible or medicinal product at a concentration from about 0.01 ppm to about 30 ppm.

56. The method of claim 43 wherein R¹ and R² have between 3 and 16 carbon atoms, and if R³ is not hydrogen, R³ has between 3 and 16 carbon atoms.

57. The method of claim 43 wherein R¹ and R² have between 3 and 16 carbon atoms and 0, 1, 2, 3, 4, or 5 heteroatoms selected from oxygen, nitrogen, sulfur, fluorine, chlorine, or bromine, and if R³ is not hydrogen, R³ has between 3 and 16 carbon atoms and 0, 1, 2, 3, 4, or 5 heteroatoms selected from oxygen, nitrogen, sulfur, fluorine, chlorine, or bromine.

58. The method of claim 43 wherein R³ is hydrogen.

59. The method of claim 43 wherein R¹ and R², and if R³ is not hydrogen then R³, are independently selected from the group consisting of an arylalkenyl, heteroarylalkenyl, arylalkyl, heteroarylalkyl, alkyl, alkoxy-alkyl, alkenyl, cycloalkyl, cycloalkenyl, aryl, heteroaryl, —R⁴OH, —R⁴OR⁵—R⁴CN, —R⁴CO₂H, —R⁴CO₂R⁵, —R⁴COR⁵, —R⁴SR⁵, R⁴S(O)R⁵ and —R⁴SO₂R⁵, and optionally substituted derivatives thereof comprising 1, 2, 3, or 4 carbonyl, amino groups, hydroxyl, or halogen groups: and wherein R⁴ and R⁵ are C₁-C₆ hydrocarbon residues.

60. The method of claim 43 wherein R¹, R², and if R³ is not hydrogen then R³, are independently selected from the group consisting of an arylalkenyl, heteroarylalkenyl, arylalkyl, heteroarylalkyl, alkyl, alkoxy-alkyl, alkenyl, cycloalkyl, cycloalkenyl, heterocycle, aryl, and heteroaryl groups, and optionally substituted derivatives thereof comprising 1, 2, 3, or 4 sustituent groups, independently selected from hydrogen, hydroxy, fluoro, chloro, NH₂, NHCH₃, N(CH₃)₂, CO₂CH₃, SEt, SCH₃, S(O)CH₃, S(O)₂CH₃, methyl, ethyl, isopropyl, vinyl, trifluoromethyl, methoxy, ethoxy, isopropoxy, and trifluoromethoxy groups.

61. The method of claim 43 wherein R¹ is an aryl or heteroaryl group optionally substituted with 0, 1, 2, or 3, sustituents independently selected from of hydroxyl, NH₂, NO², SH, SO₃H, PO(OH)₂, NO₂, halogen, and a C₁-C₄ organic radical.

62. The method of claim 43 wherein R² has the structure: 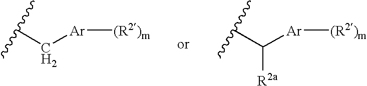
wherein Ar is a phenyl, pyridyl, furanyl, thiofuranyl, or pyrrole ring, m is 0, 1, 2, or 3, each R^{2′} is independently selected from hydrogen, hydroxy, fluoro, chloro, NH₂, NHCH₃, N(CH₃)₂, CO₂CH₃, SEt, SCH₃, methyl, ethyl, isopropyl, vinyl, trifluoromethyl, methoxy, ethoxy, isopropoxy, and trifluoromethoxy and R^{2a} is selected from the group consisting of an alkyl, alkoxy-alkyl, alkenyl, cycloalkenyl, cycloalkyl, —R⁴OH, —R⁴OR⁵—R⁴CN, —R⁴CO₂H, —R⁴CO₂R⁵, —R⁴COR⁵, —R⁴SR⁵, and —R⁴SO₂R⁵ comprising 1 to 12 carbon atoms.

63. The method of claim 43 wherein R² is an alkylene substituted heteroaryl ring radical having the structure: 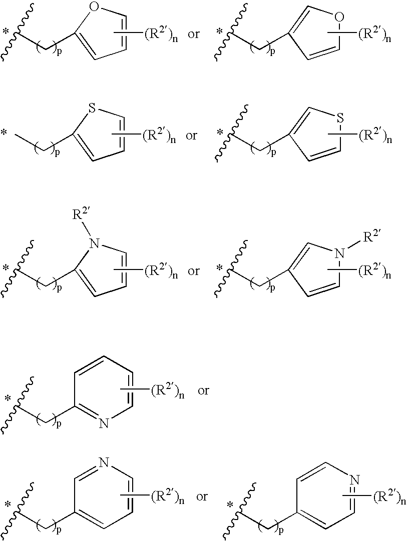
wherein p is 1 or 2; n is 0, 1, or 2, and each R^{2′} is independently selected from the group consisting of hydrogen, hydroxyl, NH₂, SH, halogen, or a C₁-C₄ organic radical.

64. The method of claim 63 wherein each R^{2′} is independently selected from the group consisting of hydroxy, fluoro, chloro, NH₂, NHCH₃, N(CH₃)₂, CO₂CH₃, SCH₃, SEt, methyl, ethyl, isopropyl, vinyl, trifluoromethyl, methoxy, ethoxy, isopropoxy, and trifluoromethoxy groups.

65. The method of claim 43 wherein R² is a 5 or 6 membered aryl or heteroaryl ring, optionally substituted with 1, 2, 3 or 4 substituent groups selected from the group consisting of hydroxyl, NH₂, SH, halogen, or a C₁-C₄ organic radical.

66. The method of claim 43 wherein R² is a phenyl, pyridyl, furanyl, thiofuranyl, or pyrrolyl ring optionally substituted with one or two substituents independently selected from hydroxy, fluoro, chloro, NH₂, NHCH₃, N(CH₃)₂, CO₂CH₃, SCH₃, SEt, methyl, ethyl, isopropyl, vinyl, trifluoromethyl, methoxy, ethoxy, isopropoxy, and trifluoromethoxy.

67. The method of claim 43 wherein R² is a cycloalkyl or cycloalkenyl ring comprising 5 to 12 ring carbon atoms that can be optionally substituted with 1, 2, 3, or 4 independently selected from hydrogen, hydroxy, fluoro, chloro, NH₂, NHCH₃, N(CH₃)₂, CO₂CH₃, SEt, SCH₃, methyl, ethyl, isopropyl, vinyl, trifluoromethyl, methoxy, ethoxy, isopropoxy, and trifluoromethoxy groups.

68. The method of claim 43 wherein R¹ has the structure: 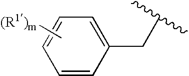
wherein m is 0, 1, 2, or 3, and each R^{1′} is independently selected from the group consisting of hydroxyl, NH₂, SH, halogen, or a C₁-C₄ organic radical.

69. The method of claim 43 wherein R¹ is an aryl or heteroaryl ring optionally substituted with 1, 2, 3, or 4 substituent groups independently selected from the group consisting of hydroxyl, NH₂, SH, halogen, or a C₁-C₄ organic radical.

70. The method of claim 43 wherein R¹ has the structure: 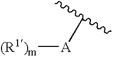
wherein A is a 5 or 6 membered aryl or heteroaryl ring, m is 0, 1, 2, 3 or 4, and each R^{1′} is independently selected from the group consisting of hydroxyl, NH₂, SH, halogen, and a C₁-C₄ organic radical.

71. The method of claim 43 wherein R¹ has the structure: 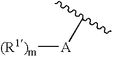
wherein A is a 5 or 6 membered aryl or heteroaryl ring, m is 0, 1, 2, 3 or 4, and each R^{1′} is independently selected from the group consisting of hydroxyl, NH₂, SH, halogen, C₁-C₈ alkyl, C₁-C₈ haloalkyl, C₁-C₈ haloalkoxy, C₁-C₈ alkoxyl, C₁-C₈ alkoxy-alkyl, C₁-C₈ hydroxy-alkyl, OH, NH₂, NHR⁶, NR⁶₂, CN, CO₂H, CO₂R⁶, CHO, COR⁶, SH, SR⁶, S(O)R⁶, S(O)₂R⁶, and halogen, wherein R⁶ is C₁-C₄ alkyl.

72. The method of claim 71 wherein each R^{1′} is independently selected from the group consisting of hydroxy, fluoro, chloro, NH₂, NHCH₃, N(CH₃)₂, COOCH₃, SCH₃, S(O)CH₃, S(O)₂CH₃, SEt, methyl, ethyl, isopropyl, n-propyl, n-butyl, 1-methyl-propyl, isobutyl, t-butyl, vinyl, trifluoromethyl, methoxy, ethoxy, isopropoxy, and trifluoromethoxy groups.

73. The method of claim 71 wherein m is 1, 2, or 3.

74. The method of claim 43 wherein R¹ has the structure:

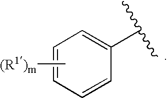

75. The method of claim 74 wherein each R^{1′} is independently selected from hydroxy, fluoro, chloro, NH₂, NHCH₃, N(CH₃)₂, COOCH₃, SCH₃, S(O)CH₃, S(O)₂CH₃, SEt, methyl, ethyl, isopropyl, n-propyl, n-butyl, 1-methyl-propyl, isobutyl, t-butyl, vinyl, trifluoromethyl, methoxy, ethoxy, isopropoxy, and trifluoromethoxy groups.

76. The method of claim 43 wherein A is a monocyclic heteroaryl ring.

77. The method of claim 43 wherein R¹ has one of the following structures:

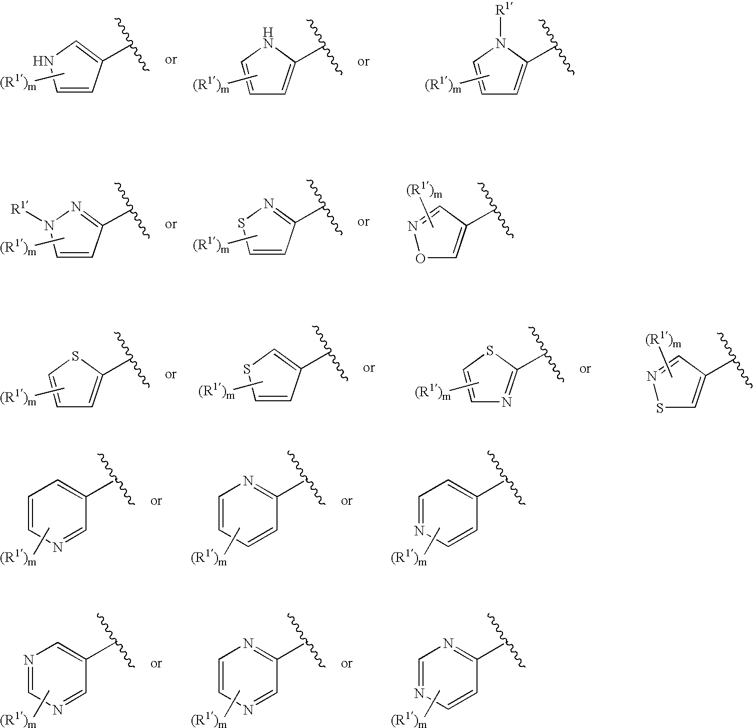

78. The method of claim 77 wherein m is 0, 1, 2, or 3, and each R^{1′} is independently selected from hydroxy, fluoro, chloro, NH₂, NHCH₃, N(CH₃)₂, COOCH₃, SCH₃, S(O)CH₃, S(O)₂CH₃, SEt, methyl, ethyl, isopropyl, n-propyl, n-butyl, 1-methyl-propyl, isobutyl, t-butyl, vinyl, trifluoromethyl, methoxy, ethoxy, isopropoxy, and trifluoromethoxy groups, or a monocyclic aryl or heteroaryl group.

79. The method of claim 43 wherein the log¹⁰ of the partition coefficient of the tastant compound between n-octanol and water is less than 5.5.

80. The method of claim 43 wherein the modified comestible or medicinal product is a food for animal consumption.

81. The method of claim 43 wherein the modified comestible or medicinal product is a food for human consumption.

82. The method of claim 43 wherein the modified comestible or medicinal product is selected from the group consisting confectioneries, bakery products, ice creams, dairy products, sweet or savory snacks, snack bars, meal replacement products, ready meals, soups, pastas, noodles, canned foods, frozen foods, dried foods, chilled foods, oils and fats, baby foods, and spreads.

83. The method of claim 43 wherein the modified comestible or medicinal product comprises one or more meats, poultry, fish, vegetables, grains, or fruits.

84. The method of claim 43 wherein the modified comestible or medicinal product is a frozen food, an uncooked food, or a fully or partially cooked food.

85. The method of claim 43 wherein the modified comestible or medicinal product is a soup, a dehydrated or concentrated soup, or a dry soup.

86. The method of claim 43 wherein the modified comestible or medicinal product is a snack food.

87. The method of claim 43 wherein the modified comestible or medicinal product is a cooking aid product, a meal solution product, a meal enhancement product, a seasoning, or a seasoning blend.

88. The method of claim 43 wherein the modified comestible or medicinal product is a cake, cookie, pie, candy, chewing gum, gelatin, ice cream, sorbet, pudding, jam, jelly, salad dressing, condiment, cereal, canned fruit, or fruit sauce.

89. The method of claim 43 wherein the modified comestible or medicinal product is a beverage, a beverage mix, or a beverage concentrate.

90. The method of claim 43 wherein the modified comestible or medicinal product is a soda, or juice.

91. The method of claim 43 wherein the modified comestible or medicinal product is an alcoholic beverage.

92. The method of claim 43 wherein the modified comestible or medicinal product is a pharmaceutical composition for oral administration.

93. The method of claim 43 wherein the modified comestible or medicinal product is an oral hygiene product.

94. The method of claim 43 wherein the tastant compound is present in the modified comestible or medicinal product at a concentration of at least about 0.01 ppm.

95. The method of claim 43 wherein the tastant compound is present in the modified comestible or medicinal product in a concentration from about 0.001 ppm to about 100 ppm.

96. The method of claim 43 wherein the tastant compound is present in the modified comestible or medicinal product at a concentration from about 0.05 ppm to about 30 ppm.

97. The method of claim 43 wherein the tastant compound is present in the modified comestible or medicinal product in a concentration from about 0.1 ppm to about 5 ppm.

98. The method of claim 43 wherein a water solution comprising about 30 ppm of the tastant compound has a savory taste as judged by the majority of a panel of at least eight human taste testers.

99. The method of claim 43 wherein a water solution comprising about 30 ppm of the tastant compound and 12 mM monosodium glutamate has an increased savory taste as compared to a control water solution comprising 12 mM monosodium glutamate, as determined by the majority of a panel of at least eight human taste testers.

100. The method of claim 43 wherein the tastant compound is a savory agonist for an hT1R1/hT1R3 umami receptor expressed in an HEK293-Gα15 cell line.

101. The method of claim 43 wherein the tastant compound has an EC₅₀ for the hT1R1/hT1R3 umami receptor expressed in an HEK293-Gα15 cell line of less than about 2 μM.

102. The method of claim 43 wherein the modified comestible or medicinal product has an increased savory taste as compared to the comestible or medicinal product prepared without the tastant compound, as judged by a majority of a panel of at least eight human taste testers.

103. The method of claim 43 wherein the modified comestible or medicinal product has a sweeter taste than a control comestible or medicinal product that does not comprise the tastant compound, as judged by the majority of a panel of at least eight human taste testers.

104. The method of claim 43 wherein a water solution comprising a sweet tasting amount of a known sweetener selected from the group consisting of sucrose, fructose, glucose, erythritol, isomalt, lactitol, mannitol, sorbitol, xylitol, a known natural terpenoid, flavonoid, or protein sweetener, aspartame, saccharin, acesulfame-K, cyclamate, sucralose, and alitame, or a mixture thereof, and about 30 ppm of the tastant compound has a sweeter taste than a control water solution comprising only the sweet tasting amount of the known sweetener, as judged by the majority of a panel of at least eight human taste testers.

105. The method of claim 43 wherein a water solution comprising about 30 ppm of the tastant compound and about 6 grams/100 milliliters of sucrose has a sweeter taste than a control water solution comprising 6% grams/100 milliliters of sucrose, as judged by the majority of a panel of at least eight human taste testers.

106. The method of claim 43 wherein a water solution comprising about 30 ppm of the tastant compound and 6% grams/100 milliliters of a 50:50 mixture of sucrose and fructose has a sweeter taste than a control water solution comprising about 6% grams/100 milliliters of a 50:50 mixture of sucrose and fructose, as judged by the majority of a panel of at least eight human taste testers.

107. The method of claim 43 wherein the tastant compound modulates the binding of a sweetener selected from the group consisting of sucrose, fructose, glucose, erythritol, isomalt, lactitol, mannitol, sorbitol, xylitol, a known natural terpenoid, flavinoid, or protein sweetener, aspartame, saccharin, acesufame-K, a cyclamate, sucralose, alitame or erythritol to an hT1R2/hT1R3 receptor expressed in an HEK293-Gα15 cell line.

108. The method of claim 43 wherein the tastant compound has an EC₅₀ for binding an hT1R2/hT1R3 receptor expressed in an HEK293-Gα15 cell line of less than about 10 μM.

109. The method of claim 43 wherein the tastant compound has an EC₅₀ for binding an hT1R2/hT1R3 receptor expressed in an HEK293-Gα15 cell line of less than about 2 μM.

110. The method of claim 43 wherein the tastant compound is comestibly acceptable.

111. The method of claim 43 wherein the tastant compound, when combined with rat chow and fed to Crl:CD(SD)IGS BR rats at a concentration of about 100 milligrams/Kilogram Body weight/day for 90 days causes no adverse toxic effects on the rats.

112. The modified comestible or medicinal product produced by claim 43.

113. A method for modulating the sweet or savory taste of a comestible product comprising:
a) providing at least one comestible product, or one or more precursors thereof, and
b) combining the comestible product or one or more precursors thereof with at least a savory flavor modulating amount or a sweet flavor modulating amount of one or more non-naturally occurring tastant compounds, or a mixture thereof, or a comestibly acceptable salt thereof, so as to form a modified comestible product;
wherein the tastant compounds have the structures (IIa-k): 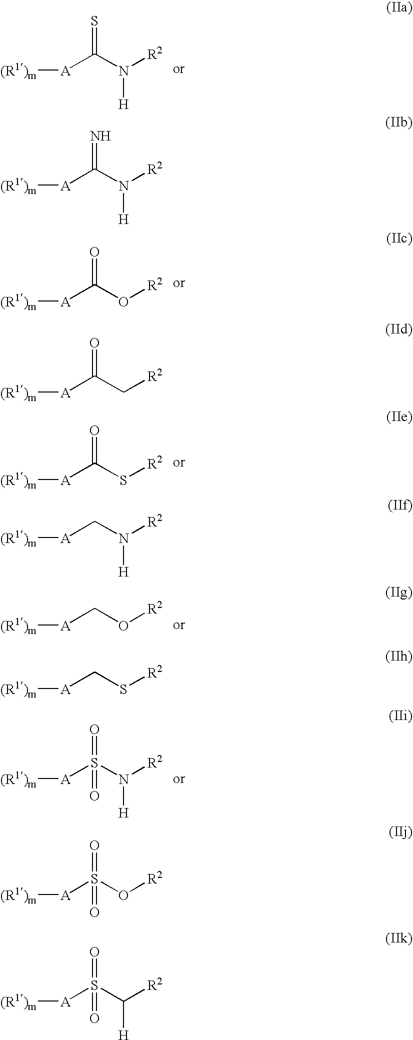
wherein
i) A is a 5 or 6 membered aryl or heteroaryl ring, m is 0, 1, 2, 3 or 4, and each R^{1′} is independently selected from the group consisting of hydroxyl, NH₂, SH, halogen, and a C₁-C₄ organic radical, and
ii) R² an organic residue having three to 16 carbon atoms and optionally one to ten heteroatoms independently selected from oxygen, nitrogen, sulfur, halogens, or phosphorus;
or a comestibly acceptable salt thereof.

114. The product produced by the method of claim 113.

115. A method for modulating the sweet or savory taste of a comestible product comprising:
a) providing at least one comestible product, or one or more precursors thereof, and
b) combining the comestible product or one or more precursors thereof with at least a savory flavor modulating amount or a sweet flavor modulating amount of one or more non-naturally occurring tastant compounds, or a mixture thereof, or a comestibly acceptable salt thereof, so as to form a modified comestible product;
wherein the tastant compounds have the structures: 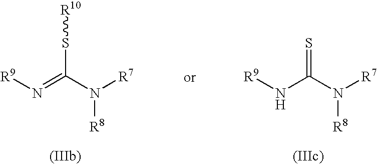
and wherein
R⁹ is a C₃-C₁₆ organic radical; and
i) R⁷ is a C₃-C₁₆ organic residue and R⁸ is hydrogen; or
ii) R⁷ and R⁸ together with the nitrogen atom bound thereto form a heterocyclic ring radical having one of the structures: 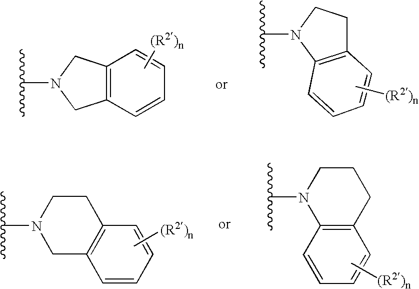
wherein n is 0, 1, 2, or 3, and each R^{2′} is independently selected from the group consisting of hydroxyl, NH₂, SH, halogen, or a C₁-C₄ organic radical;
and R¹⁰ is hydrogen or a C₁-C₄ organic radical.

116. The modified comestible product produced by the method of claim 115.

117. A method for modulating the sweet or savory taste of a comestible or medicinal product comprising:
a) providing at least one comestible product, or one or more precursors thereof, and
b) combining the comestible product or one or more precursors thereof with at least a savory flavor modulating amount or a sweet flavor modulating amount of one or more non-naturally occurring tastant compounds, or a mixture thereof, or a comestibly acceptable salt thereof, so as to form a modified comestible product;
wherein the one or more tastant compounds have Formula (If): 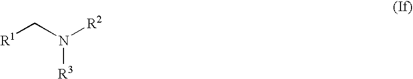
wherein:
i) R¹ is an organic residue having at least three carbon atoms and optionally one to ten heteroatoms independently selected from oxygen, nitrogen, sulfur, halogens, or phosphorus; and
ii) R² an organic residue having at least three carbon atoms and optionally one to ten heteroatoms independently selected from oxygen, nitrogen, sulfur, halogens, or phosphorus;
iii) R³ is hydrogen or an organic residue having at least three carbon atoms and optionally one to ten heteroatoms independently selected from oxygen, nitrogen, sulfur, halogens, or phosphorus; and
wherein the tastant compound has between 10 and 30 carbon atoms and a molecular weight of 500 grams per mole or less;
and wherein the compounds are not derivatives of isovanilin having the structure: 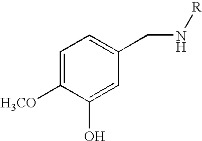
wherein R is an organic residue.

118. The modified comestible product produced by the method of claim 117.
